(19) United States
(12) Patent Application Publication
(10) Pub. No.: US 2022/0336138 A1
(43) Pub. Date: Oct. 20, 2022

(54) MAGNETIC DEVICE AND POWER CONVERSION MODULE

(71) Applicant: Delta Electronics, Inc., Taoyuan City (TW)

(72) Inventors: Yahong Xiong, Taoyuan City (TW); Xiaodong Chen, Taoyuan City (TW); Kuojun Fan, Taoyuan City (TW); Pengfei Liu, Taoyuan City (TW); Wei Liu, Taoyuan City (TW); Shengli Lu, Taoyuan City (TW)

(21) Appl. No.: 17/716,999

(22) Filed: Apr. 8, 2022

(30) Foreign Application Priority Data
Apr. 20, 2021 (CN) 202110424933.3
Jun. 8, 2021 (CN) 202110638879.2
Oct. 18, 2021 (CN) 202111211754.8

(51) Int. Cl. H01F 27/26; H01F 27/30; H01F 27/06; H01F 27/02; H02M 3/00

(52) U.S. Cl. CPC H01F 27/263; H01F 27/306; H01F 27/06; H01F 27/02; H02M 3/003; H01F 2027/065

(57) ABSTRACT

A power conversion module is disclosed. The power conversion module includes a circuit board, an adapter board, a first component and a second component. The second surface of the circuit board includes a concave region. The circuit board has four sidewalls. The first surface of the adapter board is attached to the second surface of the circuit board. The first surface of the adapter board includes a component disposing region, and the component disposing region is corresponding to the concave region. The first component is disposed in the concave region. A height of the first component is less than or equal to a depth of the concave region. The second component is disposed in the component disposing region and accommodated in the corresponding one of the concave region. A height of the second component is less than or equal to the depth of the concave region.

### CROSS-REFERENCE TO RELATED APPLICATION

This application claims priority to China Patent Application No. 202110424933.3, filed on Apr. 20, 2021. This application also claims priority to China Patent Application No. 202110638879.2, filed on Jun. 8, 2021. This application also claims priority to China Patent Application No. 202111211754.8, filed on Oct. 18, 2021. The entire contents of the above-mentioned patent applications are incorporated herein by reference for all purposes.

### FIELD OF THE INVENTION

The present disclosure relates to a magnetic device and a power conversion module, and more particularly to a small and slim magnetic device and a power conversion module.

### BACKGROUND OF THE INVENTION

Please refer to FIGS. 1A and 1B. FIG. 1A schematically illustrates the structure of a conventional electronic device. FIG. 1B schematically illustrates the structure of a power conversion module of the electronic device as shown in FIG. 1A. As shown in FIGS. 1A and 1B, the electronic device 1 has a horizontal power-providing structure. The electronic device 1 includes a central processing unit (CPU) 11, a power conversion module 12, a system board 13 and an output capacitor 14. The power conversion module 12 is used for converting an input voltage into a regulated voltage and providing the regulated voltage to the central processing unit 11. The power conversion module 12 and the central processing unit 11 are disposed on a first surface of the system board 13. The output capacitor 14 is disposed on a second surface of the system board 13. The first surface and the second surface of the system board 13 are opposed to each other. The output capacitor 14 is located beside the input terminal of the central processing unit 11.

The power conversion module 12 further includes a circuit board 15 and a magnetic device 16. The magnetic device 16 is disposed on the circuit board 15. Moreover, a switch element is disposed in a vacant space between the circuit board 15 and the magnetic device 16. The circuit board 15 is disposed on the first surface of the system board 13. The heat from the power conversion module 12 can be transferred to the system board 13 through the circuit board 15. Moreover, the heat is dissipated away through a heat dissipation mechanism (not shown) of the system board 13.

Recently, the required current for the central processing unit 11 is gradually increased. In addition, the trend of designing the electronic device is toward miniaturization. Since the central processing unit 11 and the power conversion module 12 are located at the same side of the system board 13, the path of the electric trace for connecting the central processing unit 11 and the power conversion module 12 is relatively long. Since the parasitic resistance on the electric trace is large and the conduction loss is too large, the efficiency of providing electric power from the power conversion module 12 to the central processing unit 11 is low.

For reducing the volume of the electronic device and increasing the efficiency of providing electric power from the power conversion module 12 to the central processing unit 11, another electronic device was disclosed. FIG. 2 schematically illustrates the structure of another conventional electronic device. The electronic device 1′ of FIG. 2 has a vertical power-providing structure. The power conversion module 12 is disposed on the second surface of the system board 13. That is, the power conversion module 12 and the central processing unit 11 are respectively disposed on opposite surfaces of the system board 13. Consequently, the volume of the electronic device 1′ is effectively reduced. Moreover, the path of the electric trace for connecting the central processing unit 11 and the power conversion module 12 is reduced. Since the parasitic resistance on the electric trace is decreased and the conduction loss is reduced, the power conversion efficiency of the power conversion module 12 is enhanced.

Although the power conversion efficiency of the power conversion module 12 of the electronic device 1′ as shown in FIG. 2 is enhanced, there are still some drawbacks. For example, in comparison with the electronic device 1 of FIGS. 1A and 1B, the installation positions of some output capacitors 14 are occupied by the power conversion module 12 of the electronic device 1′. Consequently, the number of output capacitors to be disposed on the electronic device 1′ is largely reduced. When the loading of the central processing unit 11 is dynamically switched to a large extent, the fluctuation range of the output voltage of the power conversion module 12 becomes greater. Under this circumstance, the central processing unit 11 cannot work normally. In addition, the power conversion module 12 is equipped with switching assemblies (not shown) to generate control signals. The magnetic device 16 in the power conversion module 12 is controlled according to the control signals. Conventionally, each switching assembly of the power conversion module 12 generates a group of control signals to control the magnetic device 16 in the power conversion module 12, wherein the phase difference between every two adjacent ones of these control signals is identical. Consequently, the AC components of the power conversion module 12 are too large. Since the power conversion module 12 needs to be equipped with a great number of output capacitors 14 to achieve the expected input voltage and the expected output voltage, the cost and the volume of the power conversion module 12 increase.

Therefore, there is a need of providing an improved magnetic device and a power conversion module in sequence to overcome the drawbacks of the conventional technologies.

### SUMMARY OF THE INVENTION

The present disclosure provides a small and cost-effective magnetic device and a power conversion module.

In accordance with an aspect of the present disclosure, a magnetic device is provided. The magnetic device includes M middle legs, 2N lateral legs, 2N first windings and a second winding. The 2N lateral legs are arranged around the M middle legs, wherein M and N are integers greater than 1. The 2N first windings are wound around the 2N lateral legs, respectively. Each of the 2N first windings is wound around the corresponding lateral leg for at least one turn. The second winding is wound around the M middle legs and formed as a closed loop. The second winding is wound around each of the M middle legs for at least one turn.

In accordance with another aspect of the present disclosure, a power conversion module is provided. The power conversion module includes a circuit board, an adapter board, at least one first component and at least one second component. The circuit board has a first surface and a second surface opposed to each other. The second surface of the circuit board includes at least one concave region. The circuit board has a first sidewall, a second sidewall, a third sidewall and a fourth sidewall. The first sidewall, the second sidewall, the third sidewall and the fourth sidewall are disposed between the first surface and the second surface of the circuit board. The first sidewall and the second sidewall are opposed to each other, and the third sidewall and the fourth sidewall are opposed to each other and disposed between the first sidewall and the second sidewall. The adapter board has a first surface and a second surface opposed to each other. The first surface of the adapter board is attached to the second surface of the circuit board. The first surface of the adapter board includes at least one component disposing region having a conductive function, and the at least one component disposing region is corresponding to the at least one concave region. The at least one first component is disposed in the at least one concave region. A height of the at least one first component is less than or equal to a depth of the at least one concave region. The at least one second component is disposed in the at least one component disposing region and accommodated in the corresponding one of the at least one concave region. A height of the at least one second component is less than or equal to the depth of the at least one concave region.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1A schematically illustrates the structure of a conventional electronic device;

FIG. 1B schematically illustrates the structure of a power conversion module of the electronic device as shown in FIG. 1A;

FIG. 2 schematically illustrates the structure of another conventional electronic device;

FIG. 3A is a schematic structure view illustrating a power conversion module according to a first embodiment of the present disclosure;

FIG. 3B is a schematic exploded view illustrating the power conversion module as shown in FIG. 3A;

FIG. 4A is a schematic structure view illustrating the power conversion module as shown in FIG. 3A from another perspective;

FIG. 4B is a schematic exploded view illustrating the power conversion module as shown in FIG. 4A;

FIG. 5 is a schematic equivalent circuit of the power conversion module as shown in FIG. 3A;

FIG. 6 is a schematic timing waveform diagram illustrating the PWM control signals generated by the control circuit of the power conversion module as shown in FIG. 5;

FIG. 7 is a schematic structure view illustrating the magnetic device of the power conversion module as shown in FIG. 3A;

FIG. 8A is a schematic cross-sectional view illustrating the middle leg and the lateral legs of the magnetic device of the power conversion module as shown in FIG. 3A;

FIG. 8B is a schematic cross-sectional view illustrating a variant example of the middle leg and the lateral legs of the magnetic device of the power conversion module as shown in FIG. 3A;

FIG. 9 is a schematic side view illustrating the circuit board and the input capacitor of the power conversion module as shown in FIG. 4B;

FIG. 10 is a schematic timing waveform diagram illustrating the voltage waveforms of the second winding wound around the middle legs of the magnetic device as shown in FIG. 7;

FIG. 11 is a schematic structure view illustrating a power conversion module according to a second embodiment of the present disclosure;

FIG. 12 is a schematic structure view illustrating a magnetic device of a power conversion module according to a third embodiment of the present disclosure;

FIG. 13 is a schematic structure view illustrating a magnetic device of a power conversion module according to a fourth embodiment of the present disclosure;

FIG. 14 is a schematic structure view illustrating a magnetic device of a power conversion module according to a fifth embodiment of the present disclosure;

FIG. 15 is a schematic circuit diagram illustrating the electromagnetic integrated circuits and the control unit of the power conversion circuit as shown in FIG. 5;

FIG. 16A is a schematic structure view illustrating a power conversion module according to a sixth embodiment of the present disclosure;

FIG. 16B is a schematic exploded view illustrating the power conversion module as shown in FIG. 16A;

FIG. 17A is a schematic structure view illustrating the power conversion module as shown in FIG. 16A from another perspective;

FIG. 17B is a schematic exploded view illustrating the power conversion module as shown in FIG. 17A;

FIG. 18 is a schematic side view illustrating a power conversion module according to a seventh embodiment of the present disclosure;

FIG. 19 is a schematic side view illustrating a power conversion module according to an eighth embodiment of the present disclosure;

FIG. 20 is a schematic side view illustrating a power conversion module according to a ninth embodiment of the present disclosure, in which the pressure from the system board and the spring are received by the adapter conductors;

FIG. 21 is a schematic side view illustrating the power conversion module as shown in FIG. 20, in which the pressure from the system board and the spring are received by the copper blocks;

FIG. 22 is a schematic exploded view illustrating a power conversion module according to a tenth embodiment of the present disclosure;

FIG. 23 is a schematic exploded view illustrating the power conversion module as shown in FIG. 22 from another perspective;

FIG. 24 is a schematic side view illustrating the power conversion module as shown in FIG. 22;

FIG. 25 is a schematic structure view illustrating the magnetic device of the power conversion module as shown in FIG. 22;

FIG. 26A is a schematic structure view illustrating a magnetic device of a power conversion module according to an eleventh embodiment of the present disclosure;

FIG. 26B is a schematic structure view illustrating a magnetic device of a power conversion module according to a twelfth embodiment of the present disclosure;

FIG. 27 is a schematic structure view illustrating the power conversion module including a first epoxy glue as shown in FIG. 22;

FIG. 28 is a schematic perspective view illustrating the disposing positions of a plurality of adapter conductors of the power conversion module as shown in FIG. 22;

FIG. 29A is a schematic structure view illustrating a magnetic device of a power conversion module according to a thirteenth embodiment of the present disclosure;

FIG. 29B is a schematic exploded view illustrating the power conversion module as shown in FIG. 29A;

FIG. 30A is a schematic structure view illustrating the power conversion module as shown in FIG. 29A from another perspective;

FIG. 30B is a schematic exploded view illustrating the power conversion module as shown in FIG. 30A;

FIG. 31 is a flow chart illustrating the process of manufacturing the power conversion module as shown in FIG. 29A;

FIG. 32 is a schematic side view illustrating the power conversion module as shown in FIG. 29A before the circuit board and the adapter board are soldered;

FIG. 33A is a schematic exploded view illustrating a power conversion module according to a fourteenth embodiment of the present disclosure;

FIG. 33B is a schematic exploded view illustrating the power conversion module as shown in FIG. 33A from another perspective;

FIG. 34 is a schematic structure view illustrating the magnetic device of the power conversion module as shown in FIG. 33A;

FIG. 35 is a schematic perspective view illustrating another exemplary disposing positions of a plurality of adapter conductors of the power conversion module as shown in FIG. 22;

FIG. 36A is a schematic structure view illustrating a power conversion module according to a fifteenth embodiment of the present disclosure;

FIG. 36B is a schematic exploded view illustrating the power conversion module as shown in FIG. 36A;

FIG. 37A is a schematic structure view illustrating the power conversion module as shown in FIG. 36A from another perspective;

FIG. 37B is a schematic exploded view illustrating the power conversion module as shown in FIG. 37A;

FIG. 38A is a schematic structure view illustrating a power conversion module according to a sixteenth embodiment of the present disclosure;

FIG. 38B is a schematic exploded view illustrating the power conversion module as shown in FIG. 38A;

FIG. 39A is a schematic structure view illustrating the power conversion module as shown in FIG. 38A from another perspective;

FIG. 39B is a schematic exploded view illustrating the power conversion module as shown in FIG. 39A;

FIG. 40A is a schematic structure view illustrating a power conversion module according to a seventeenth embodiment of the present disclosure;

FIG. 40B is a schematic exploded view illustrating the power conversion module as shown in FIG. 40A;

FIG. 41A is a schematic structure view illustrating the power conversion module as shown in FIG. 40A from another perspective; and

FIG. 41B is a schematic exploded view illustrating the power conversion module as shown in FIG. 41A.

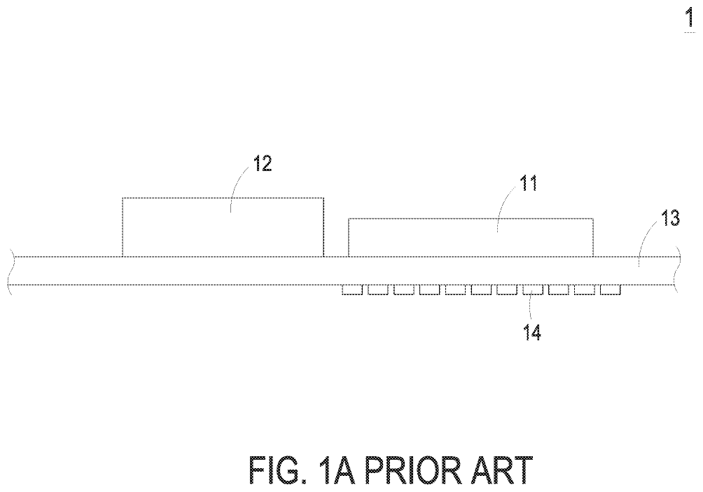

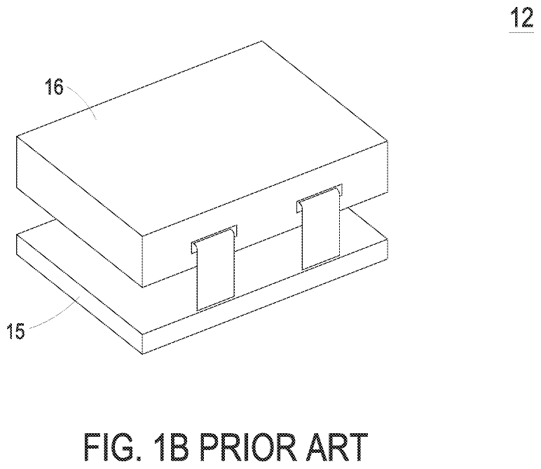

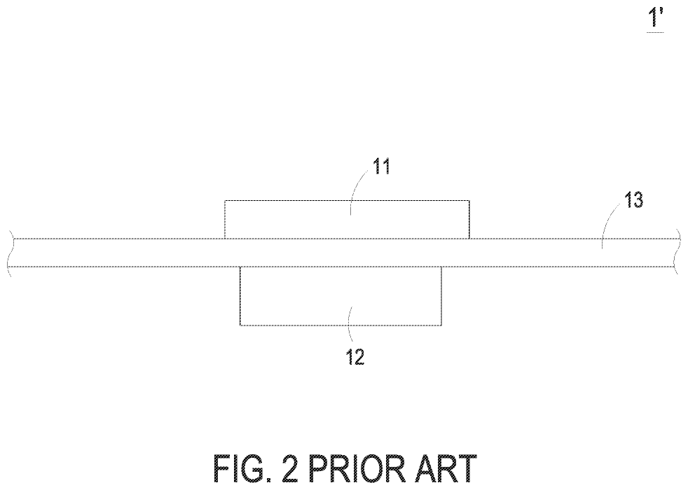

### DETAILED DESCRIPTION OF THE PREFERRED EMBODIMENT

The present disclosure will now be described more specifically with reference to the following embodiments. It is to be noted that the following descriptions of preferred embodiments of this invention are presented herein for purpose of illustration and description only. It is not intended to be exhaustive or to be limited to the precise form disclosed.

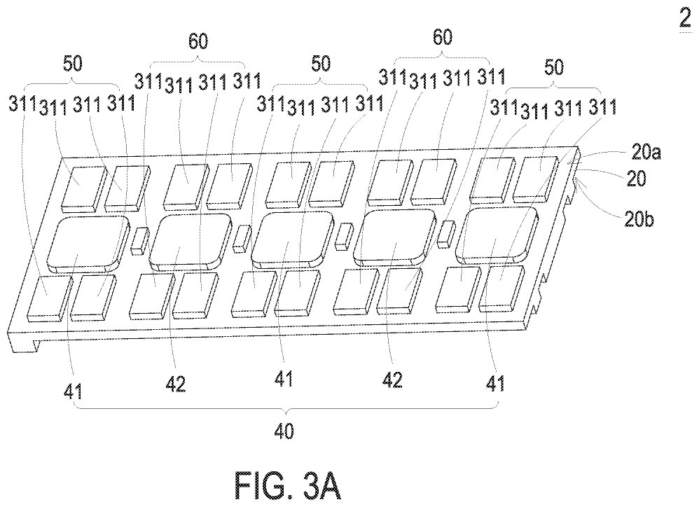

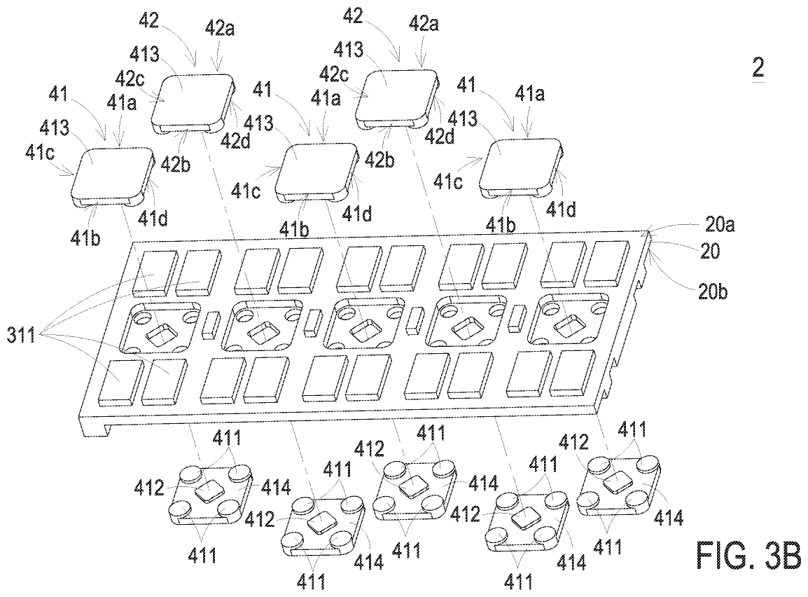

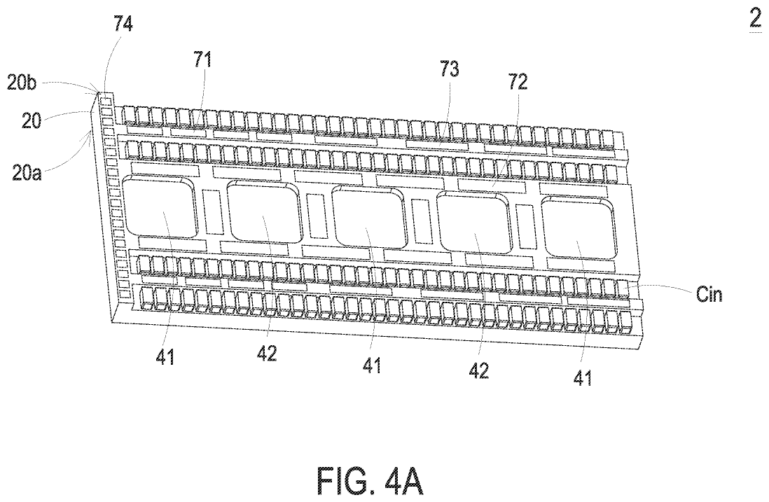

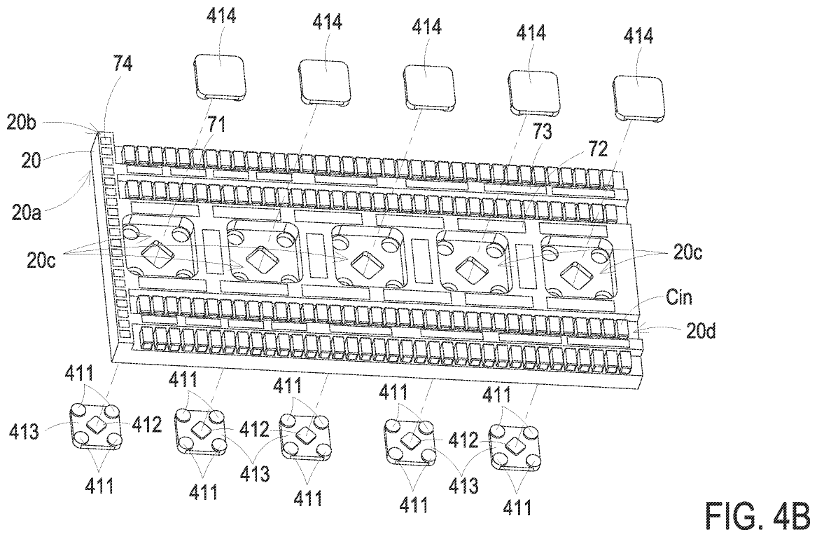

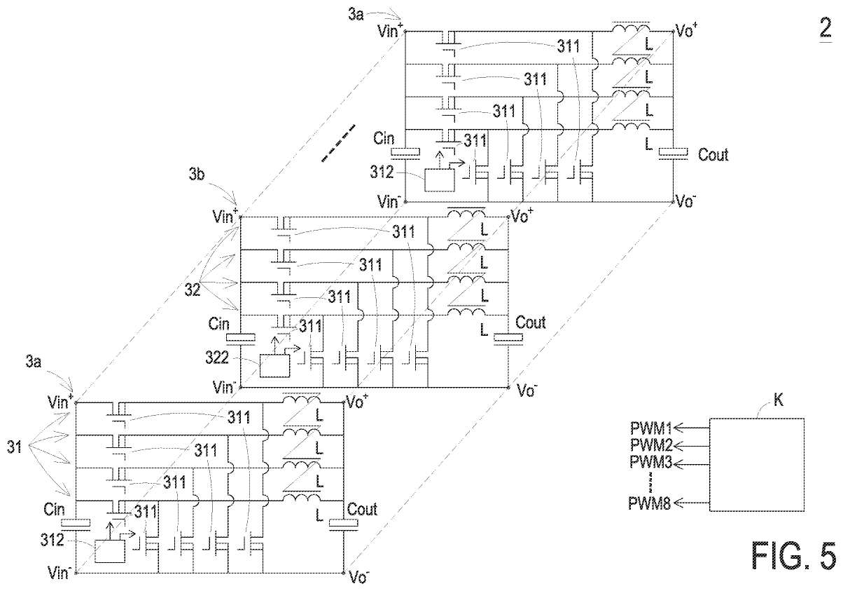

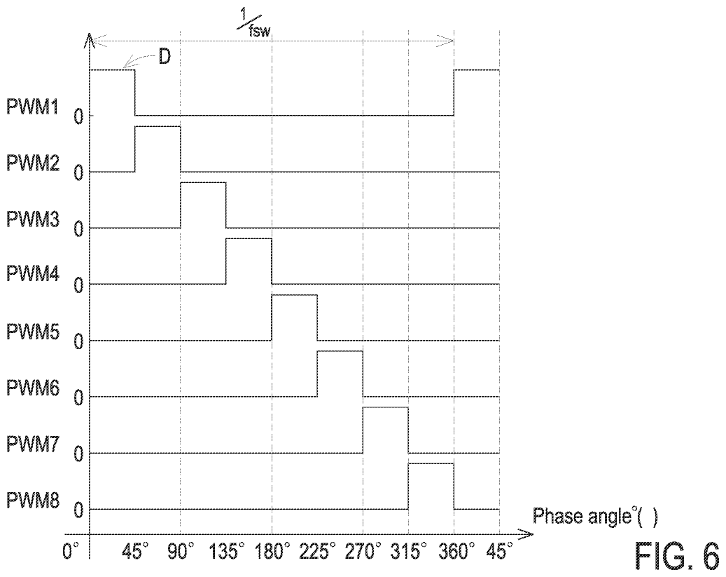

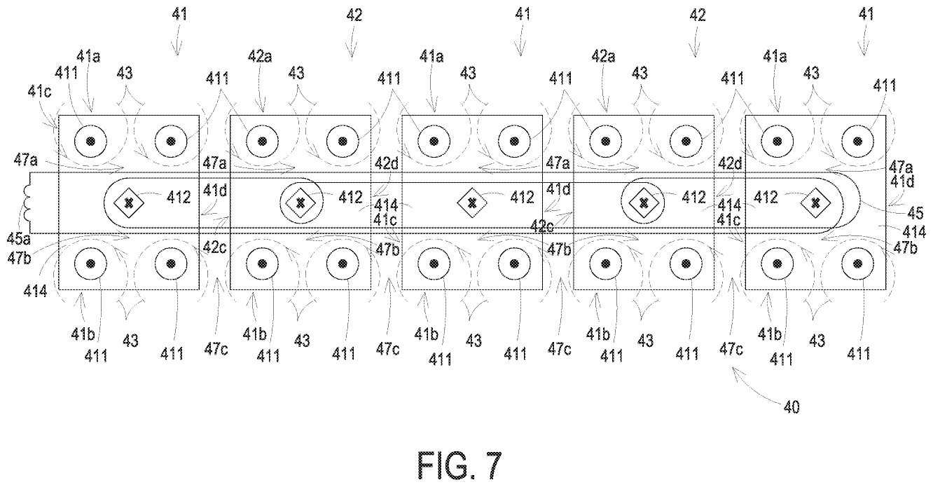

Please refer to FIGS. 3A, 3B, 4A, 4B, 5, 6 and 7. FIG. 3A is a schematic structure view illustrating a power conversion module according to a first embodiment of the present disclosure. FIG. 3B is a schematic exploded view illustrating the power conversion module as shown in FIG. 3A. FIG. 4A is a schematic structure view illustrating the power conversion module as shown in FIG. 3A from another perspective. FIG. 4B is a schematic exploded view illustrating the power conversion module as shown in FIG. 4A. FIG. 5 is a schematic equivalent circuit of the power conversion module as shown in FIG. 3A. FIG. 6 is a schematic timing waveform diagram illustrating the PWM control signals generated by the control circuit of the power conversion module as shown in FIG. 5. FIG. 7 is a schematic structure view illustrating the magnetic device of the power conversion module as shown in FIG. 3A.

The power conversion module 2 can be applied to an electronic device. In addition, the power conversion module 2 is mounted on a system board (not shown) of the electronic device by soldering. The power conversion module 2 includes a plurality of electromagnetic integrated circuits. For example, the power conversion module 2 includes three first electromagnetic integrated circuits 3a and two second electromagnetic integrated circuits 3b. The three first electromagnetic integrated circuits 3a and the two second electromagnetic integrated circuits 3b are arranged alternately. For succinctness, only two first electromagnetic integrated circuits 3a and one second electromagnetic integrated circuit 3b are shown in FIG. 5. The input terminals of the three first electromagnetic integrated circuits 3a and the input terminals of the two second electromagnetic integrated circuits 2a are connected in parallel to form the input terminal of the power conversion module 2 for receiving electric power from an external power source (not shown). The output terminals of the three first electromagnetic integrated circuits 3a and the output terminals of the two second electromagnetic integrated circuits 2a are connected in parallel to form the output terminal of the power conversion module 2 for outputting an output voltage.

For providing a large current to the central processing unit of the electronic device and effectively increasing the current output capability of the power conversion module 2, each first electromagnetic integrated circuit 3a is a four-phase buck converter. As shown in FIG. 5, the first electromagnetic integrated circuit 3a includes four first power conversion circuits 31, at least one input capacitor Cin, an output capacitor Cout and a driver 312. The input terminals of the four first power conversion circuits 31 are connected in parallel. The output terminals of the four first power conversion circuits 31 are connected in parallel. Each of the four first power conversion circuits 31 includes a switch unit 311 and an inductor L.

Each switch unit 311 of the first power conversion circuit 31 is a half-bridge arm, which includes an upper switch and a lower switch. The node between the upper switch and the lower switch is connected with a first terminal of the corresponding inductor L. Each first power conversion circuit 31 can be regarded as one phase circuit. In other words, the four first power conversion circuits 31 include a first phase circuit, a second phase circuit, a third phase circuit and a fourth phase circuit. The input capacitor Cin and the respective first terminals of the first phase circuit, the second phase circuit, the third phase circuit, the fourth phase circuit are connected in parallel and then connected with the positive input terminal Vin+ and the negative input terminal Vin− of the first electromagnetic integrated circuit 3a. The output capacitor Cout and the respective second terminals of the first phase circuit, the second phase circuit, the third phase circuit and the fourth phase circuit are connected in parallel and then connected with the positive output terminal Vo+ and the negative output terminal Vo− of the first electromagnetic integrated circuit 3a. The negative input terminal Vin− and the negative output terminal Vo− are directly connected with each other. The first terminal of the output capacitor Cout is connected with the positive output terminal Vo+. The second terminal of the output capacitor Cout is connected with the negative output terminal Vo−. The first terminal of the input capacitor Cin is connected with the positive input terminal Vin+. The second terminal of the input capacitor Cin is connected with the negative input terminal Vin−. The driver 312 of the first electromagnetic integrated circuit 3a is connected with the switch units 311 to drive the switch units 311. In some embodiments, the driver 312 and the switch units 311 are integrated into a semiconductor chip, a semiconductor package structure, a carrier board or a PCB board.

Similarly, each second electromagnetic integrated circuit 3b is a four-phase buck converter. As shown in FIG. 5, the second electromagnetic integrated circuit 3b includes four second power conversion circuits 32, at least one input capacitor Cin, at least one output capacitor Cout and a driver 322. The input terminals of the four second power conversion circuits 32 are connected in parallel. The output terminals of the four second power conversion circuits 32 are connected in parallel. Each of the four second power conversion circuits 32 includes a switch unit 311 and an inductor L.

Each switch unit 311 of the second power conversion circuit 32 is a half-bridge arm, which includes an upper switch and a lower switch. The node between the upper switch and the lower switch is connected with the corresponding inductor L. Each second power conversion circuit 32 can be regarded as one phase circuit. In other words, the four second power conversion circuits 32 include a first phase circuit, a second phase circuit, a third phase circuit and a fourth phase circuit. The input capacitor Cin and the respective first terminals of the first phase circuit, the second phase circuit, the third phase circuit and the fourth phase circuit are connected in parallel and connected with the positive input terminal Vin+ and the negative input terminal Vin− of the second electromagnetic integrated circuit 3b. The output capacitor Cout and the second respective terminals of the first phase circuit, the second phase circuit, the third phase circuit and the fourth phase circuit are connected in parallel and connected with the positive output terminal Vo+ and the negative output terminal Vo− of the second electromagnetic integrated circuit 3b. The negative input terminal Vin− and the negative output terminal Vo− are directly connected with each other. The first terminal of the output capacitor Cout is connected with the positive output terminal Vo+. The second terminal of the output capacitor Cout is connected with the negative output terminal Vo−. The first terminal of the input capacitor Cin is connected with the positive input terminal Vin+. The second terminal of the input capacitor Cin is connected with the negative input terminal Vin−. The driver 322 of the second electromagnetic integrated circuit 3b is connected with the switch units 311 to drive the switch units 311. In some embodiments, the driver 322 and the switch units 311 are integrated into a semiconductor chip, a semiconductor package structure, a carrier board or a PCB board.

Please refer to FIGS. 5 and 6. The power conversion module 2 further includes a control unit K. The control unit K is electrically connected with the drivers 312 of the first electromagnetic integrated circuits 3a and the drivers 322 of the second electromagnetic integrated circuits 3b. By sampling the output voltage of the power conversion module 2 and the currents of all phase circuits, the control unit K generates eight PWM control signals PWM1, PWM2, PWM3, PWM4, PWM5, PWM6, PWM7 and PWM8. As shown in FIG. 6, the phase difference between every two adjacent PWM control signals of the eight PWM control signals PWM1˜PWM8 is 45 degrees. The switching frequency of each PWM control signal is fsw. The pulse period of each PWM control signal is 1/fsw. The duty cycle of each PWM control signal is D. The first phase circuit, the second phase circuit, the third phase circuit and the fourth phase circuit of the first electromagnetic integrated circuit 3a are respectively controlled according to the PWM control signals PWM1, PWM3, PWM5 and PWM7. That is, the phase difference between every two adjacent PWM control signals of the PWM control signals PWM1, PWM3, PWM5 and PWM7 is 90 degrees. The first phase circuit, the second phase circuit, the third phase circuit and the fourth phase circuit of the second electromagnetic integrated circuit 3b are respectively controlled according to the PWM control signals PWM2, PWM4, PWM6 and PWM8. That is, the phase difference between every two adjacent PWM control signals of the PWM control signals PWM2, PWM4, PWM6 and PWM8 is 90 degrees.

As mentioned above, the control unit K of the power conversion module 2 generates the eight PWM control signals PWM1, PWM2, PWM3, PWM4, PWM5, PWM6, PWM7 and PWM8. In addition, the phase difference between every two adjacent PWM control signals of the eight PWM control signals PWM1˜PWM8 is 45 degrees. The first phase circuit, the second phase circuit, the third phase circuit and the fourth phase circuit of the first electromagnetic integrated circuit 3a are respectively controlled according to the PWM control signals PWM1, PWM3, PWM5 and PWM7. The first phase circuit, the second phase circuit, the third phase circuit and the fourth phase circuit of the second electromagnetic integrated circuit 3b are respectively controlled according to the PWM control signals PWM2, PWM4, PWM6 and PWM8. That is, the two adjacent electromagnetic integrated circuits 3a and 3b are controlled according to eight PWM control signals. In comparison with the technology of using four PWM control signals (with 90-degree phase difference between every two adjacent PWM control signals) to control the single electromagnetic integrated circuit, the number of phases of the PWM switching signal in this embodiment is doubled, the AC current components of the input capacitor Cin and the output capacitor Cout of the power conversion module 2 at the 8× frequency are increased and the AC current components of the input capacitor Cin and the output capacitor Cout of the power conversion module 2 at the 4× frequency are largely decreased. Since the overall AC current component of the power conversion module 2 is largely decreased, the expected input voltage and the expected output voltage can be maintained while reducing the number of the at least one input capacitor Cin and the number of the at least one output capacitor Cout.

The structure of the power conversion module 2 will be described as follows. Please refer to FIGS. 3A, 3B, 4A and 4B again. The power conversion module 2 includes a circuit board 20, a magnetic device 40, at least one first switch assembly 50 and at least one second switch assembly 60. The circuit board 20 has a first surface 20a and a second surface 20b, which are opposed to each other. The power conversion module 2 is disposed on the system board through the second surface 20b of the circuit board 20. The magnetic device 40 is disposed on the first surface 20a and the second surface 20b of the circuit board 20. In an embodiment, the magnetic device 40 includes 2N lateral legs 411, M middle legs 412, 2N first winding 43 and a second winding 45, N and M are integers greater than 1. Moreover, N lateral legs of the 2N lateral legs 411 are located on a first side of the M middle legs 412, and the other N lateral legs 411 of the 2N lateral legs 411 are located on a second side of the M middle legs 412. For example, the magnetic device 40 in this embodiment includes twenty lateral legs 411, five middle legs 412, twenty first windings 43 and one second winding 45. That is, N is equal to 10, and M is equal to 5. Moreover, every four lateral legs 411 and one corresponding middle leg 412 are collaboratively defined as a magnetic element. In other words, the power conversion module 2 in this embodiment includes five magnetic elements. The five magnetic elements include three first magnetic elements 41 and two second magnetic elements 42. The three first magnetic elements 41 and the two second magnetic elements 42 are arranged alternately. The four lateral legs 411 of each first magnetic element 41 are arranged around the corresponding middle leg 412. Similarly, the four lateral legs 411 of each second magnetic element 42 are arranged around the corresponding middle leg 412.

The 2N first windings 43 are disposed within the circuit board 20. As shown in FIG. 7, each first winding 43 is wound around the corresponding lateral leg 411. The turn number of each first winding 43 wound around the corresponding lateral leg 411 is at least one. In this embodiment, the fourth lateral legs 411 of the first magnetic element 41 and the four first windings 43 wound around these lateral legs 411 are collaboratively formed as the four inductors L of the first power conversion circuit 31 of the first electromagnetic integrated circuit 3a as shown in FIG. 5. Similarly, the fourth lateral legs 411 of the second magnetic element 42 and the four first windings 43 wound around these lateral legs 411 are collaboratively formed as the four inductors L of the second power conversion circuit 32 of the second electromagnetic integrated circuit 3b as shown in FIG. 5. In this embodiment, the corresponding first winding 43 are respectively wound around the four lateral legs 411 of the first magnetic element 41. Consequently, the four inductors L of the first power conversion circuit 31 of the first electromagnetic integrated circuit 3a are coupled with each other. Similarly, the corresponding first winding 43 are respectively wound around the four lateral legs 411 of the second magnetic element 42. Consequently, the four inductors L of the second power conversion circuit 32 of the second electromagnetic integrated circuit 3b are coupled with each other.

The second winding 45 is disposed within the circuit board 20. As shown in FIG. 7, the second winding 45 is wound around the five middle legs 412 to form a closed loop. Moreover, the second winding 45 is wound around each of the five middle legs 412 for at least one turn. That is, the number of turns of the second winding 45 on each middle legs 412 is at least one turn. The method of winding the second winding 45 will be described as follows.

In this embodiment, the power conversion module 2 includes three first switch assemblies 50 and two second switch assemblies 60. Moreover, each first switch assembly 50, the corresponding first magnetic element 41, the four first windings 43 wound around the corresponding lateral leg 411 and a part of the second windings 45 wound around the corresponding middle leg 412 are collaboratively formed as the first electromagnetic integrated circuit 3a as shown in FIG. 5. The first switch assembly 50 includes four switch units 311. The four switch units 311 are disposed on the first surface 20a of the circuit board 20 and respectively connected with the corresponding first windings 43 of the corresponding first electromagnetic integrated circuit 3a. Moreover, the four switch units 311 are arranged around the first magnetic element 41 of the corresponding first electromagnetic integrated circuit 3a. Similarly, each second switch assembly 60, the corresponding second magnetic element 42, the four first windings 43 wound around the corresponding lateral leg 411 and a part of the second windings 45 wound around the corresponding middle leg 412 are collaboratively formed as the second electromagnetic integrated circuit 3b as shown in FIG. 5. The second switch assembly 60 includes four switch units 311. The four switch units 311 are disposed on the first surface 20a of the circuit board 20 and respectively connected with the corresponding first windings 43 of the corresponding second electromagnetic integrated circuit 3b. Moreover, the four switch units 311 are arranged around the second magnetic element 42 of the corresponding second electromagnetic integrated circuit 3b.

In this embodiment, two switch units 311 of each first switch assembly 50 and two switch units 311 of each second switch assembly 60 are arranged along a first row to form a first switch row, and these switch units 311 in the first row are disposed on a first side of the first surface 20a of the circuit board 20. Moreover, other two switch units 311 of each first switch assembly 50 and other two switch units 311 of each second switch assembly 60 are arranged along a second row to form a second switch row, and these switch units 311 in the second row are disposed on a second side of the first surface 20a of the circuit board 20. The total number of the switch units 311 in the first row and the switch units 311 in the second row is equal to 2N (i.e., 20). Two switch units 311 of each first switch assembly 50 in the first row are disposed on the first side of the middle leg 412 of the corresponding first magnetic element 41, and two switch units 311 of each first switch assembly 50 in the second row are disposed on the second side of the middle leg 412 of the corresponding first magnetic element 41. Two switch units 311 of each second switch assembly 60 in the first row are disposed on the first side of the middle leg 412 of the corresponding second magnetic element 42, and other two switch units 311 of each second switch assembly 60 in the second row are disposed on the second side of the middle leg 412 of the corresponding second magnetic element 42.

As mentioned above, the first winding 43 is wound around a corresponding one of the 2N lateral legs 411, and the second winding 45 is wound around all of the M middle legs 412 to form a closed loop. When the load driven by the electronic device with the power conversion module 2 is subjected to the dynamic conversion and switched from the heavy load condition to the light load condition, the output voltage from the power conversion module 2 possibly overshoots. For solving the overshoot problem, the response of the control unit K of the power conversion module 2 allows the duty cycles of all PWM control signals to be zero. The lower switch of each switch unit 311 is turned on, and thus the inductor L which is defined by the first winding 43 and the corresponding lateral leg 413 withstands the output voltage. Moreover, a high voltage is coupled by the second winding 45 and applied to the wiring structure of the second winding 45. Consequently, the current flowing through the second winding 45 is largely increased, and the current flowing through the first winding 43 is largely increased. Consequently, the overshoot of the output voltage is largely suppressed. In other words, the overshoot of the output voltage during the dynamic conversion of the load can be effectively reduced.

From the above descriptions, the power conversion module 2 can reduce the fluctuation range of the output voltage without increasing the number of the output capacitors. Consequently, the cost and the volume of the power conversion module are reduced.

In an embodiment, the magnetic device 40 further includes W magnetic cover pairs, wherein W is an integer greater than 1. For example, in the embodiment as shown in FIGS. 3B and 4B, the magnetic device 40 includes five magnetic cover pairs (i.e., W=5). Each magnetic cover pair include a first magnetic cover 413 and a second magnetic cover 414. The first magnetic cover 413 and the second magnetic cover 414 are disposed on the first surface 20a and the second surface 20b of the circuit board 20, respectively. Each middle leg 412 and the four corresponding lateral legs 411 are arranged between the corresponding first magnetic cover 413 and the corresponding second magnetic cover 414. In addition, each middle leg 412 and the four corresponding lateral legs 411 are penetrated through the circuit board 20.

As shown in FIGS. 3B and 4B, portions of the four lateral legs 411 of each magnet element are located at the ends of the two intersecting diagonal lines of the second magnetic cover 414 (i.e., four corners of the corresponding second magnetic cover 414), and the other portions of the four lateral legs 411 of each magnet element are located at the ends of two intersecting diagonal lines of the first magnetic cover 413 (i.e., four corners of the corresponding first magnetic cover 413). In addition, the middle leg 412 of each magnet element is located at a middle region of the corresponding four lateral legs 411. That is, the middle leg 412 of each magnet element is located at the intersection of the two intersecting diagonal lines. It is noted that the shapes of the first magnetic cover 413 and the second magnetic cover 414 is not limited to quadrilateral and may be varied according to the practical requirements. In addition, the positions of the four lateral legs 411 and the middle leg 412 may be varied according to the practical requirements.

The four first windings 43 are wound around the corresponding lateral legs 411. The directions of the currents flowing through the four first windings 43 are identical. For example, as shown in FIG. 7, the currents flow through the four first windings 43 in the counterclockwise direction. In other words, the directions of the DC magnetic fluxes on the four lateral legs 411 are identical. For example, the directions of the DC magnetic fluxes on the four lateral legs 411 are the upward directions through the paper as shown in FIG. 7. Moreover, the direction of the DC magnetic flux on the middle leg 412 is opposite to the directions of the DC magnetic fluxes on the four lateral legs 411. For example, the directions of the DC magnetic fluxes on the middle legs 412 are the downward directions through the paper as shown in FIG. 7. Consequently, four closed magnetic loops are defined by the middle leg 412 and the four lateral legs 411. That is, one closed magnetic loop is defined by the middle leg 412 and the corresponding lateral leg 411. Moreover, the DC magnetic fluxes on the four lateral legs 411 are superposed on the middle leg 412 to form the DC magnetic flux on the middle leg 412. The directions of the currents flowing through the four first windings 43 are not restricted as long as the direction of the DC magnetic flux on the middle leg 412 is opposite to the directions of the DC magnetic fluxes on the four lateral legs 411. For example, in another embodiment, the currents flow through the four first windings 43 in the clockwise direction. The directions of the DC magnetic fluxes on the four lateral legs 411 are the downward directions through the paper, and the directions of the DC magnetic fluxes on the middle legs 412 are the upward directions through the paper.

The phase difference between every two adjacent PWM control signals of the PWM control signals for controlling the four switch units 311 of the power conversion circuit of each electromagnetic integrated circuit is 90 degrees. In addition, the phase difference between every two adjacent voltage signals of the first winding 43 wound around the first lateral legs 411 and connected with the four switch units 311 is also 90 degrees. Since the amplitudes of the AC magnetic flux generated by the first windings 43 around the four lateral legs 411 are superposed on the middle leg 412, the AC magnetic flux on the middle leg 412 is largely decreased.

In an embodiment, the cross section of each lateral leg 411 has the circular shape. Consequently, the winding path of each first winding 411 around the corresponding lateral leg 411 is shorter, and the winding width is larger. In this way, the inductance of the parasitic inductor on the first winding 43 is decreased. On contrast, the cross section of the middle leg 412 has a square shape. Consequently, the winding path of the second winding 45 around the middle leg 412 is shorter, and the winding width is larger. In this way, the inductance of the parasitic inductor on the second winding 45 is decreased.

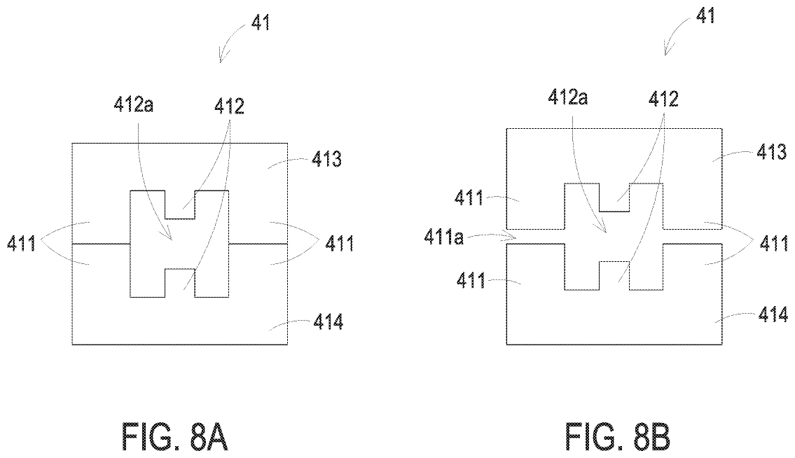

FIG. 8A is a schematic cross-sectional view illustrating the middle leg and the lateral legs of the magnetic device of the power conversion module as shown in FIG. 3A. As shown in FIG. 8A, the middle leg 412 has a first air gap 412a. Due to the first air gap 412a, the DC magnetic density of the four closed magnetic loops defined by the middle leg 412 and the four lateral legs 411 will be decreased and the saturation between the four closed magnetic loops can be avoided. Consequently, the AC magnetic flux on the lateral leg 411 is larger, and the magnetic resistance of the lateral leg 411 is smaller. In addition, the AC magnetic flux on the middle leg 412 is smaller, and the magnetic resistance of the middle leg 412 is larger. For example, the magnetic resistance of the middle leg 412 is two times the magnetic resistance of the lateral leg 411. Consequently, the equivalent steady-state inductance of the four first windings 43 around the four lateral legs 411 is largely increased. As mentioned above, when the load driven by the electronic device with the power conversion module 2 is subjected to the dynamic conversion and switched from the heavy load condition to the light load condition, the output voltage from the power conversion module 2 possibly overshoots. For solving the overshoot problem, the response of the control unit K of the power conversion module 2 allows the duty cycles of all PWM control signals to be zero. Consequently, the four inductors L defined by the four first windings 43 and the corresponding lateral legs 413 withstand the output voltage. Under this circumstance, the AC magnetic fluxes on the four lateral legs 411 are in same phase and superposed on the middle leg 412. The AC magnetic flux on the middle leg 412 is largely increased, and the AC currents flowing through the four first windings 43 are largely increased. In addition, the equivalent dynamic inductance of each first winding 43 is smaller.

In an embodiment, the middle leg 412 and the lateral legs 411 are made of the same material, e.g., ferrite. As known, ferrite has high magnetic permeability. In case that the middle leg 412 and the lateral legs 411 are made of ferrite, the first air gap 412a of the middle leg 412 may be longer than or equal to the length of the lateral leg 411. In another embodiment, the middle leg 412 and the lateral legs 411 are made of different materials. For example, the middle leg 412 is made of iron powder, and the lateral legs 411 are made of ferrite. Generally, the iron powder has low magnetic permeability. In case that the middle leg 412 is made of iron powder, the middle leg 412 is not equipped with the air gap. Consequently, the permitted saturation magnetic density is largely increased, and the size of the middle leg 412 is further reduced.

It is noted that numerous modifications and alterations may be made while retaining the teachings of the invention. In a variant example, each lateral leg 411 has a second air gap 411a. The second air gap 411a is shorter than or equal to the first air gap 412a.

Please refer to FIG. 4B again. At least one first concave region 20c is formed by recessed in the second surface 20b of the circuit board 20. For example, five first concave regions 20c are formed in the second surface 20b of the circuit board 20. Each first concave region 20c has a first depth. Each second magnetic cover 414 is aligned with the corresponding first concave region 20c. The thickness of the second magnetic cover 414 is smaller than or equal to the first depth of the corresponding first concave region 20c. In addition, a plurality of second concave regions 20d are formed by recessed in the second surface 20b of the circuit board 20. Some second concave regions 20d are located on a first side of the first concave region 20c. The other second concave regions 20d are located on a second side of the first concave region 20c. Each second concave region 20d has a second depth. The plurality of input capacitors Cin of the power conversion module 2 are disposed within the corresponding second concave regions 20d, respectively. The thickness of each input capacitor Cin is smaller than or equal to the second depth of the corresponding second concave region 20d.

As mentioned above, the top surface of the magnetic device 40 and the top surface of the input capacitor Cin are at the level lower than the second surface of 20b of the circuit board 20. Consequently, while the power conversion module 2 is disposed on the system board through the second surface of 20b of the circuit board 20, the hindrance of the magnetic device 40 and the input capacitors Cin can be avoided. In this way, the convenience of installing the power conversion module 2 on the system board is enhanced.

Please refer to FIGS. 4A and 4B again. The power conversion module 2 includes a plurality of positive input terminal connection parts 71, a plurality of positive output terminal connection parts 72, a plurality of negative output terminal connection parts 73 and a plurality of signal connection parts 74. The plurality of positive input terminal connection parts 71, the plurality of positive output terminal connection parts 72, the plurality of negative output terminal connection parts 73 and the plurality of signal connection parts 74 are disposed on the second surface 20b of the circuit board 20 according to a surface mount technology. The plurality of positive input terminal connection parts 71 are used as the positive input terminal Vin+ of the power conversion module 2. The plurality of positive output terminal connection parts 72 are used as the positive output terminal Vo+ of the power conversion module 2. The plurality of negative output terminal connection parts 73 are used as the negative output terminal Vo− of the power conversion module 2. The plurality of signal connection parts 74 are used as the signal terminal of the power conversion module 2. For example, the plurality of signal connection parts 74 are used as the receiving terminals of the PWM control signals, the receiving terminals of the output current detection signals or the receiving terminals of the temperature detection signals. Since it is not necessary to weld copper blocks for electric connection, the power conversion module 2 has the simplified structure and the good flatness. Consequently, the applications of the power conversion module 2 are expanded. It is noted that the installation positions of the positive input terminal connection parts 71, the positive output terminal connection parts 72, the negative output terminal connection parts 73 and the signal connection parts 74 are not restricted and may be varied according to the practical requirements.

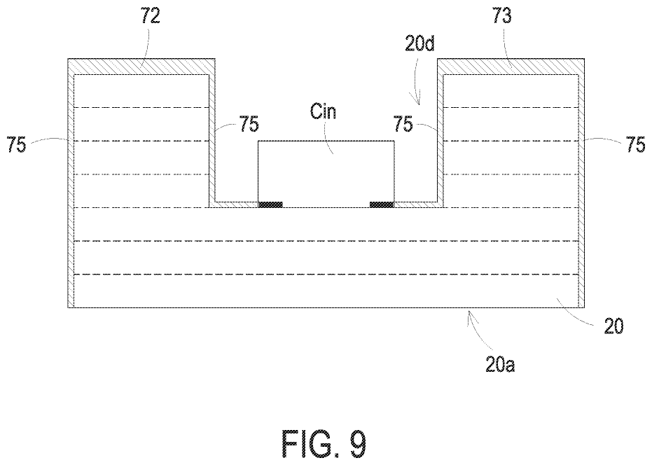

FIG. 9 is a schematic side view illustrating the circuit board and the input capacitor of the power conversion module as shown in FIG. 4B. As shown in FIG. 9, the second concave region 20d is arranged between the positive output terminal connection parts 72 and the negative output terminal connection parts 73. In addition, a lateral electroplated part 75 is formed on a lateral wall of the second concave region 20d. The lateral electroplated part 75 is connected with the positive output terminal connection parts 72 and the negative output terminal connection parts 73. Consequently, the positive output terminal connection parts 72 and the negative output terminal connection parts 73 can be electrically connected with the copper foil within the circuit board 20 or pads of other components within the second concave region 20d through the lateral electroplated part 75. In sequence words, the electric connection between the connection parts and the circuit board 20 can be achieved without the need of occupying the horizontal wiring space of the circuit board 20. Consequently, the size of the circuit board 20 is reduced.

Moreover, the arrangement of the lateral electroplated part 75 can reduce the parasitic impedance in the connection path of the power conversion module 2 and reduce the conduction loss of the connection path. In an embodiment, a portion of the lateral electroplated part 75 and a portion of the positive output terminal connection parts 72 are protruded over the circuit board 20 and formed as a finger-type conductive part. Similarly, a portion of the lateral electroplated part 75 and a portion of the negative output terminal connection parts 73 are protruded over the circuit board 20 and formed as a finger-type conductive part. The finger-type conductive part is similar to the protruding copper conductive part. Due to the surface mount soldering of the finger-type conductive parts, the lateral electroplated part 75 can form sidewall creeping tin, which has lower requirements on the flatness of soldering surface and higher reliability of solder joints. Consequently, the power conversion module 2 can be welded on the system board in a more reliable manner.

Similarly, the second concave region 20d may be arranged between the positive input terminal connection parts 71 and the positive output terminal connection parts 72, or located on the signal connection parts 74, or located on the positive input terminal connection parts 71. In sequence words, a portion of the lateral electroplated part 75 and a portion of the positive input terminal connection parts 71 may be protruded over the circuit board 20 and formed as a finger-type conductive part, and a portion of the lateral electroplated part 75 and a portion of the signal connection parts 74 may be protruded over the circuit board 20 and formed as a finger-type conductive part.

Please refer to FIG. 3B again. The first magnetic element 41 includes a first side 41a, a second side 41b, a third side 41c and a fourth side 41d. The first side 41a and the second side 41b of the first magnetic element 41 are opposed to each other. The third side 41c and the fourth side 41d of the first magnetic element 41 are opposed to each other. Moreover, the third side 41c and the fourth side 41d are arranged between the first side 41a and the second side 41b. The plurality of lateral legs 411 of the first magnetic element 41 includes a first lateral leg 411, a second lateral leg 411, a third lateral leg 411 and a fourth lateral leg 411. The first lateral leg 411 of the first magnetic element 41 is adjacent to the first side 41a and the third side 41c of the first magnetic element 41. The second lateral leg 411 of the first magnetic element 41 is adjacent to the first side 41a and the fourth side 41d of the first magnetic element 41. The third lateral leg 411 of the first magnetic element 41 is 1 adjacent to the second side 41b and the third side 41c of the first magnetic element 41. The fourth lateral leg 411 of the first magnetic element 41 is adjacent to the second side 41b and the fourth side 41d of the first magnetic element 41. The plurality of switch units 311 of the first switch assembly 50 includes a first switch unit 311, a second switch unit 311, a third switch unit 311 and a fourth switch unit 311. The first switch unit 311 of the first switch assembly 50 is adjacent to the first side 41a of the first magnetic element 41 and the first lateral leg 411 of the first magnetic element 41. The second switch unit 311 of the first switch assembly 50 is adjacent to the first side 41a of the first magnetic element 41 and the second lateral leg 411 of the first magnetic element 41. The third switch unit 311 of the first switch assembly 50 is adjacent to the second side 41b of the first magnetic element 41 and the third lateral leg 411 of the first magnetic element 41. The fourth switch unit 311 of the first switch assembly 50 is adjacent to the second side 41b of the first magnetic element 41 and the fourth lateral leg 411 of the first magnetic element 41.

The second magnetic element 42 includes a first side 42a, a second side 42b, a third side 42c and a fourth side 42d. The first side 42a and the second side 42b of the second magnetic element 42 are opposed to each other. The third side 42c and the fourth side 42d of the second magnetic element 42 are opposed to each other. In addition, the third side 42c and the fourth side 42d are arranged between the first side 42a and the second side 42b. The plurality of lateral legs 411 of the second magnetic element 42 includes a first lateral leg 411, a second lateral leg 411, a third lateral leg 411 and a fourth lateral leg 411. The first lateral leg 411 of the second magnetic element 42 is adjacent to the first side 42a and the third side 42c of the second magnetic element 42. The second lateral leg 411 of the second magnetic element 42 is adjacent to the first side 42a and the fourth side 42d of the second magnetic element 42. The third lateral leg 411 of the second magnetic element 42 is adjacent to the second side 42b and the third side 42c of the second magnetic element 42. The fourth lateral leg 411 of the second magnetic element 42 is adjacent to the second side 42b and the fourth side 42d of the second magnetic element 42. The plurality of switch units 311 of the second switch assembly 60 includes a first switch unit 311, a second switch unit 311, a third switch unit 311 and a fourth switch unit 311. The first switch unit 311 of the second switch assembly 60 is adjacent to the first side 42a of the second magnetic element 42 and the first lateral leg 411 of the second magnetic element 42. The second switch unit 311 of the second switch assembly 60 is adjacent to the first side 42a of the second magnetic element 42 and the second lateral leg 411 of the second magnetic element 42. The third switch unit 311 of the second switch assembly 60 is adjacent to the second side 42b of the second magnetic element 42 and the third lateral leg 411 of the second magnetic element 42. The fourth switch unit 311 of the second switch assembly 60 is adjacent to the second side 42b of the second magnetic element 42 and the fourth lateral leg 411 of the second magnetic element 42.

Please refer to FIGS. 3B, 5 and 6 again. The first switch unit 311 of the first switch assembly 50 is controlled according to the first PWM control signal PWM1. The first lateral leg 411 of the first magnetic element 41 is adjacent to the first switch unit 311 of the first switch assembly 50. The voltage signal of the first winding 43 wound around the first lateral leg 411 of the first magnetic element 41 and the first PWM control signal PWM1 are in the same phase. The second switch unit 311 of the first switch assembly 50 is controlled according to the fifth PWM control signal PWM5. The second lateral leg 411 of the first magnetic element 41 is adjacent to the second switch unit 311 of the first switch assembly 50. The voltage signal of the first winding 43 wound around the second lateral leg 411 of the first magnetic element 41 and the fifth PWM control signal PWM5 are in the same phase. The third switch unit 311 of the first switch assembly 50 is controlled according to the third PWM control signal PWM3. The third lateral leg 411 of the first magnetic element 41 is adjacent to the third switch unit 311 of the first switch assembly 50. The voltage signal of the first winding 43 wound around the third lateral leg 411 of the first magnetic element 41 and the third PWM control signal PWM3 are in the same phase. The fourth switch unit 311 of the first switch assembly 50 is controlled according to the seventh PWM control signal PWM7. The fourth lateral leg 411 of the first magnetic element 41 is adjacent to the fourth switch unit 311 of the first switch assembly 50. The voltage signal of the first winding 43 wound around the fourth lateral leg 411 of the first magnetic element 41 and the seventh PWM control signal PWM7 are in the same phase.

In an embodiment, the phase different between the voltage signal of the first winding wound around the lateral legs on the first side of the middle leg and the voltage signal of the first winding wound around the lateral legs on the second side of the middle leg is equal to a first angle. The first angle is a function of N and W. For example, the first angle is 360/(2N/W)+/−15 degrees. Preferably, the first angle is 360/(2N/W) degrees. Moreover, the phase different between the voltage signals of the first windings wound around every two adjacent lateral legs on the first side of the middle leg is equal to a second angle, and the phase different between the voltage signals of the first windings wound around every two adjacent lateral legs on the second side of the middle leg is equal to the second angle. The second angle is a function of N and W. For example, the first angle is 360/(2N/W)+/−15 degrees. Preferably, the second angle is 360/(N/W) degrees.

Please refer to FIG. 6. The phase difference between the PWM control signals for controlling the first switch unit 311 and the second switch unit 311 of each switch assembly is 180 degrees. In each magnetic element, the phase difference between the voltage signal of the first winding 43 wound around the first lateral leg 411 and the voltage signal of the first winding 43 wound around the second lateral leg 411 is 180 degrees. The phase difference between the PWM control signals for controlling the first switch unit 311 and the third switch unit 311 of each switch assembly is 90 degrees. In each magnetic element, the phase difference between the voltage signal of the first winding 43 wound around the first lateral leg 411 and the voltage signal of the first winding 43 wound around the third lateral leg 411 is 90 degrees. The phase difference between the PWM control signals for controlling the third switch unit 311 and the fourth switch unit 311 of each switch assembly is 180 degrees. In each magnetic element, the phase difference between the voltage signal of the first winding 43 wound around the third lateral leg 411 and the voltage signal of the first winding 43 wound around the fourth lateral leg 411 is 180 degrees.

A first phase distribution method will be described as follows. Please refer to FIG. 6. The phase difference between the first PWM control signal PWM1 for controlling the first switch unit 311 of the first switch assembly 50 and the fifth PWM control signal PWM5 for controlling the second switch unit 311 of the first switch assembly 50 is 180 degrees. In addition, the phase difference between the voltage signal of the first winding 43 wound around the first lateral leg 411 of the first magnetic element 41 and the voltage signal of the first winding 43 wound around the second lateral leg 411 of the first magnetic element 41 is 180 degrees. The phase difference between the first PWM control signal PWM1 for controlling the first switch unit 311 of the first switch assembly 50 and the third PWM control signal PWM3 for controlling the third switch unit 311 of the first switch assembly 50 is 90 degrees. In addition, the phase difference between the voltage signal of the first winding 43 wound around the first lateral leg 411 of the first magnetic element 41 and the voltage signal of the first winding 43 wound around the third lateral leg 411 of the first magnetic element 41 is 90 degrees. The phase difference between the third PWM control signal PWM3 for controlling the third switch unit 311 of the first switch assembly 50 and the seventh PWM control signal PWM7 for controlling the fourth switch unit 311 of the first switch assembly 50 is 180 degrees. In addition, the phase difference between the voltage signal of the first winding 43 wound around the third lateral leg 411 of the first magnetic element 41 and the voltage signal of the first winding 43 wound around the fourth lateral leg 411 of the first magnetic element 41 is 180 degrees.

Please refer to FIGS. 3B and 6 again. The first switch unit 311 of the second switch assembly 60 is controlled according to the second PWM control signal PWM2. The first lateral leg 411 of the second magnetic element 42 is adjacent to the first switch unit 311 of the second switch assembly 60. The voltage signal of the first winding 43 wound around the first lateral leg 411 of the second magnetic element 42 and the second PWM control signal PWM2 are in the same phase. The second switch unit 311 of the second switch assembly 60 is controlled according to the sixth PWM control signal PWM6. The second lateral leg 411 of the second magnetic element 42 is adjacent to the second switch unit 311 of the second switch assembly 60. The voltage signal of the first winding 43 wound around the second lateral leg 411 of the second magnetic element 42 and the sixth PWM control signal PWM6 are in the same phase. The third switch unit 311 of the second switch assembly 60 is controlled according to the fourth PWM control signal PWM4. The third lateral leg 411 of the second magnetic element 42 is adjacent to the third switch unit 311 of the second switch assembly 60. The voltage signal of the first winding 43 wound around the third lateral leg 411 of the second magnetic element 42 and the fourth PWM control signal PWM4 are in the same phase. The fourth switch unit 311 of the second switch assembly 60 is controlled according to the eighth PWM control signal PWM8. The fourth lateral leg 411 of the second magnetic element 42 is adjacent to the fourth switch unit 311 of the second switch assembly 60. The voltage signal of the first winding 43 wound around the fourth lateral leg 411 of the second magnetic element 42 and the eighth PWM control signal PWM8 are in the same phase.

Please refer to FIG. 6 again. The phase difference between the second PWM control signal PWM2 for controlling the first switch unit 311 of the second switch assembly 60 and the sixth PWM control signal PWM6 for controlling the second switch unit 311 of the second switch assembly 60 is 180 degrees. In addition, the phase difference between the voltage signal of the first winding 43 wound around the first lateral leg 411 of the second magnetic element 42 and the voltage signal of the first winding 43 wound around the second lateral leg 411 of the second magnetic element 42 is 180 degrees. The phase difference between the second PWM control signal PWM2 for controlling the first switch unit 311 of the second switch assembly 60 and the fourth PWM control signal PWM4 for controlling the third switch unit 311 of the second switch assembly 60 is 90 degrees. In addition, the phase difference between the voltage signal of the first winding 43 wound around the first lateral leg 411 of the second magnetic element 42 and the voltage signal of the first winding 43 wound around the third lateral leg 411 of the second magnetic element 42 is 90 degrees. The phase difference between the fourth PWM control signal PWM4 for controlling the third switch unit 311 of the second switch assembly 60 and the eighth PWM control signal PWM8 for controlling the fourth switch unit 311 of the second switch assembly 60 is 180 degrees. In addition, the phase difference between the voltage signal of the first winding 43 wound around the third lateral leg 411 of the second magnetic element 42 and the voltage signal of the first winding 43 wound around the fourth lateral leg 411 of the second magnetic element 42 is 180 degrees.

Since the phase differences between the PWM control signals for controlling the corresponding switch unit 311 are specially designed, the frequency of the AC current flowing through the input capacitor Cin adjacent to the switching unit is doubled. That is, the frequency of the AC current flowing through the input capacitor Cin is two times the switching frequency of the PWM control signal, and the amplitude of the AC current is decreased. Consequently, the conduction loss of the input capacitor Cin is largely reduced, and the efficiency of the power conversion module 2 is enhanced.

In an embodiment, the difference between a total phase of the voltage signals of the first windings wound around the four lateral legs of each magnetic element and a total phase of the voltage signals of the first windings wound around the four lateral legs of the adjacent magnetic element is 180 degrees. Please refer to FIG. 6 again, the phase of the voltage signal of the first winding 43 wound around the first lateral leg 411 of the first magnetic element 41 is 0 degree. The phase of the voltage signal of the first winding 43 wound around the second lateral leg 411 of the first magnetic element 41 is 180 degrees. The phase of the voltage signal of the first winding 43 wound around the third lateral leg 411 of the first magnetic element 41 is 90 degrees. The phase of the voltage signal of the first winding 43 wound around the fourth lateral leg 411 of the first magnetic element 411 is 270 degrees. In other words, the total phase of these voltage signals is 540 degrees (i.e., 0+180+90+270=540). The phase of the voltage signal of the first winding 43 wound around the first lateral leg 411 of the second magnetic element 42 is 45 degrees. The phase of the voltage signal of the first winding 43 wound around the second lateral leg 411 of the second magnetic element 42 is 225 degrees. The phase of the voltage signal of the first winding 43 wound around the third lateral leg 411 of the second magnetic element 42 is 135 degrees. The phase of the voltage signal of the first winding 43 wound around the fourth lateral leg 411 of the second magnetic element 42 is 315 degrees. In other words, the total phase of these voltage signals is 720 degrees (i.e., 45+225+135+315=720). In other words, the difference between a total phase of the voltage signals of the first windings 43 wound around the four lateral legs 411 of the first magnetic element 41 and a total phase of the voltage signals of the first windings 43 wound around the four lateral legs 411 of the adjacent magnetic element is 180 degrees.

Due to the difference between the total phase of the first magnetic element and the total phase of the second magnetic element, the AC current component of the input capacitor Cin at the 4× frequency of the PWM control signal is largely increased, and the AC current component of the input capacitor Cin at the 2× frequency of the PWM control signal is largely decreased. Since the overall AC current component of each input capacitor Cin is largely decreased, the conduction loss of each input capacitor Cin is decreased.

The phases of the voltage signals of the first windings wound around the corresponding lateral legs of the magnetic elements and the phases of the PWM control signals for controlling the corresponding switch units are not restricted. A second phase distribution method will be described as follows. In some embodiments, the power conversion module 2 also includes five magnetic elements. The five magnetic elements include a first magnetic element 41, a second magnetic element 42, a third magnetic element 41, a fourth magnetic element 42 and a fifth magnetic element 41, which are arranged in sequence. The structures of the first magnetic element 41, the third magnetic element 41 and the fifth magnetic element 41 are identical. The structures of the second magnetic element 42 and the fourth magnetic element 42 are identical.

In some embodiments, the voltage signal of the first winding 43 wound around the first lateral leg 411 of the first magnetic element 41 and the first PWM control signal PWM1 are in the same phase. In addition, the control signal for controlling the corresponding first switch unit 311 is also the first PWM control signal PWM1. The voltage signal of the first winding 43 wound around the second lateral leg 411 of the first magnetic element 41 and the fifth PWM control signal PWM5 are in the same phase. In addition, the control signal for controlling the corresponding second switch unit 311 is also the fifth PWM control signal PWM5. The voltage signal of the first winding 43 wound around the third lateral leg 411 of the first magnetic element 41 and the third PWM control signal PWM3 are in the same phase. In addition, the control signal for controlling the corresponding third switch unit 311 is also the third PWM control signal PWM3. The voltage signal of the first winding 43 wound around the fourth lateral leg 411 of the first magnetic element 41 and the seventh PWM control signal PWM7 are in the same phase. In addition, the control signal for controlling the corresponding fourth switch unit 311 is also the seventh PWM control signal PWM7.

The voltage signal of the first winding 43 wound around the first lateral leg 411 of the second magnetic element 42 and the first PWM control signal PWM1 are in the same phase. In addition, the control signal for controlling the corresponding first switch unit 311 is also the first PWM control signal PWM1. The voltage signal of the first winding 43 wound around the second lateral leg 411 of the second magnetic element 42 and the fifth PWM control signal PWM5 are in the same phase. In addition, the control signal for controlling the corresponding second switch unit 311 is also the fifth PWM control signal PWM5. The voltage signal of the first winding 43 wound around the third lateral leg 411 of the second magnetic element 42 and the third PWM control signal PWM3 are in the same phase. In addition, the control signal for controlling the corresponding third switch unit 311 is also the third PWM control signal PWM3. The voltage signal of the first winding 43 wound around the fourth lateral leg 411 of the second magnetic element 42 and the seventh PWM control signal PWM7 are in the same phase. In addition, the control signal for controlling the corresponding fourth switch unit 311 is also the seventh PWM control signal PWM7.

The voltage signal of the first winding 43 wound around the first lateral leg 411 of the third magnetic element 41 and the second PWM control signal PWM2 are in the same phase. In addition, the control signal for controlling the corresponding first switch unit 311 is also the second PWM control signal PWM2. The voltage signal of the first winding 43 wound around the second lateral leg 411 of the third magnetic element 41 and the sixth PWM control signal PWM6 are in the same phase. In addition, the control signal for controlling the corresponding second switch unit 311 is also the sixth PWM control signal PWM6. The voltage signal of the first winding 43 wound around the third lateral leg 411 of the third magnetic element 41 and the fourth PWM control signal PWM4 are in the same phase. In addition, the control signal for controlling the corresponding third switch unit 311 is also the fourth PWM control signal PWM4. The voltage signal of the first winding 43 wound around the fourth lateral leg 411 of the third magnetic element 41 and the eighth PWM control signal PWM8 are in the same phase. In addition, the control signal for controlling the corresponding fourth switch unit 311 is also the eighth PWM control signal PWM8.

The voltage signal of the first winding 43 wound around the first lateral leg 411 of the fourth magnetic element 42 and the second PWM control signal PWM2 are in the same phase. In addition, the control signal for controlling the corresponding first switch unit 311 is also the second PWM control signal PWM2. The voltage signal of the first winding 43 wound around the second lateral leg 411 of the fourth magnetic element 42 and the sixth PWM control signal PWM6 are in the same phase. In addition, the control signal for controlling the corresponding second switch unit 311 is also the sixth PWM control signal PWM6. The voltage signal of the first winding 43 wound around the third lateral leg 411 of the fourth magnetic element 42 and the fourth PWM control signal PWM4 are in the same phase. In addition, the control signal for controlling the corresponding third switch unit 311 is also the fourth PWM control signal PWM4. The voltage signal of the first winding 43 wound around the fourth lateral leg 411 of the fourth magnetic element 42 and the eighth PWM control signal PWM8 are in the same phase. In addition, the control signal for controlling the corresponding fourth switch unit 311 is also the eighth PWM control signal PWM8.

The voltage signal of the first winding 43 wound around the first lateral leg 411 of the fifth magnetic element 41 and the first PWM control signal PWM1 are in the same phase. In addition, the control signal for controlling the corresponding first switch unit 311 is also the first PWM control signal PWM1. The voltage signal of the first winding 43 wound around the second lateral leg 411 of the fifth magnetic element 41 and the fifth PWM control signal PWM5 are in the same phase. In addition, the control signal for controlling the corresponding second switch unit 311 is also the fifth PWM control signal PWM5. The voltage signal of the first winding 43 wound around the third lateral leg 411 of the fifth magnetic element 41 and the third PWM control signal PWM3 are in the same phase. In addition, the control signal for controlling the corresponding third switch unit 311 is also the fifth PWM control signal PWM3. The voltage signal of the first winding 43 wound around the fourth lateral leg 411 of the fifth magnetic element 41 and the seventh PWM control signal PWM7 are in the same phase. In addition, the control signal for controlling the corresponding fourth switch unit 311 is also the seventh PWM control signal PWM7.

In this embodiment, the difference between a total phase of the voltage signals of the first windings wound around the four lateral legs of each magnetic element and a total phase of the voltage signals of the first windings wound around the four lateral legs of the adjacent magnetic element is 0 degree or 180 degrees. The calculation method is similar to that of the above embodiment, and not redundantly described herein.

It is noted that the phase of the voltage signal of the first winding wound around each lateral leg and the phase of the corresponding PWM control signal may be varied according to the practical requirements. For brevity, the first phase distribution method will be taken as the example to describe the features of the present disclosure.

Please refer to FIG. 7 again. A first channel 47a is formed between the first and second lateral legs 411 and the middle leg 412 of the first magnetic element 41. A second channel 47b is formed between the third and fourth lateral legs 411 and the middle leg 412 of the first magnetic element 41. A third channel 47c is formed between the middle leg 412 of the first magnetic element 41 and the middle leg 412 of the second magnetic element 42. A first channel 47a is between the first and second lateral legs 411 and the middle leg 412 of the second magnetic element 42. A second channel 47b is formed between the third and fourth lateral legs 411 and the middle leg 412 of the second magnetic element 42. A third channel 47c is formed between the middle leg 412 of the second magnetic element 42 and the middle leg 412 of the third magnetic element 41. A first channel 47a is formed between the first and second lateral legs 411 and the middle leg 412 of the third magnetic element 41. A second channel 47b is formed between the third and fourth lateral legs 411 and the middle leg 412 of the third magnetic element 41. A third channel 47c is formed between the middle leg 412 of the third magnetic element 41 and the middle leg 412 of the fourth magnetic element 42. A first channel 47a is formed between the first and second lateral legs 411 and the middle leg 412 of the fourth magnetic element 42. A second channel 47b is formed between the third and fourth lateral legs 411 and the middle leg 412 of the fourth magnetic element 42. A third channel 47c is formed between the middle leg 412 of the fourth magnetic element 42 and the middle leg 412 of the fifth magnetic element 41. A first channel 47a is formed between the first and second lateral legs 411 and the middle leg 412 of the fifth magnetic element 41. A second channel 47b is formed between the third and fourth lateral legs 411 and the middle leg 412 of the fifth magnetic element 41.

Please refer to FIG. 7 again. For winding the second winding 45, the second winding 45 is firstly fed into the first channel 47a of the first magnetic element 41. That is, the first channel 47a of the first magnetic element 41 is the feed point of the second winding 45. Then, the second winding 45 is transported to the fourth side 41d of the fifth magnetic element 41 through the first channel 47a of the first magnetic element 41, the first channel 47a of the second magnetic element 42, the first channel 47a of the third magnetic element 41, the first channel 47a of the fourth magnetic element 42 and the first channel 47a of the fifth magnetic element 41 sequentially. Then, the second winding 45 is transported to the third side 41c of the first magnetic element 41 through the second channel 47b of the fifth magnetic element 41, the second channel 47b of the fourth magnetic element 42, the second channel 47b of the third magnetic element 41, the second channel 47b of the second magnetic element 42 and the second channel 47b of the first magnetic element 41 sequentially. Then, the second winding 45 is transported to the fourth side 41d of the fifth magnetic element 41 through the first channel 47a of the first magnetic element 41, the first channel 47a of the second magnetic element 42, the third channel 47c between the second magnetic element 42 and the third magnetic element 41, the second channel 47b of the second magnetic element 42, the third channel 47c between the first magnetic element 41 and the second magnetic element 42, the first channel 47a of the second magnetic element 42, the first channel 47a of the third magnetic element 41, the first channel 47a of the fourth magnetic element 42, the third channel 47c between the fourth magnetic element 42 and the fifth magnetic element 41, the second channel 47b of the fourth magnetic element 42, the third channel 47c between the third magnetic element 41 and the fourth magnetic element 42, the first channel 47a of the fourth magnetic element 42 and the first channel 47a of the fifth magnetic element 41 sequentially. Then, the second winding 45 is transported to the third side 41c of the first magnetic element 41 through the second channel 47b of the fifth magnetic element 41, the second channel 47b of the fourth magnetic element 42, the second channel 47b of the third magnetic element 41, the second channel 47b of the second magnetic element 42 and the second channel 47b of the first magnetic element 41. In this way, the second winding 45 is wound around the middle leg 412 of the first magnetic element 41, the middle leg 412 of the second magnetic element 42, the middle leg 412 of the third magnetic element 41, the middle leg 412 of the fourth magnetic element 42 and the middle leg 412 of the fifth magnetic element 41 in a serial connection manner.

It is noted that the feed point of the second winding 45 is not restricted to the first channel 47a of the first magnetic element 41. That is, the feed point of the second winding 45 may be varied according to the practical requirements. In an embodiment, the second winding 45 is wound around the middle leg 412 of the first magnetic element 41 for two turns, the second winding 45 is wound around the middle leg 412 of the second magnetic element 42 for three turns, the second winding 45 is wound around the middle leg 412 of the third magnetic element 41 for two turns, the second winding 45 is wound around the middle leg 412 of the fourth magnetic element 42 for three turns, and the second winding 45 is wound around the middle leg 412 of the fifth magnetic element 41 for two turns. That is, the turn number of the second winding 45 wound around the middle leg 412 of the second magnetic element 42 (or the fourth magnetic element 42) is 1.5 times the turn number of the second winding 45 wound around the middle leg 412 of the first magnetic element 41 (or the third magnetic element 41 or the fifth magnetic element 41). In an embodiment, at least portions of the second winding 45 are wound around the middle legs of the magnetic device 40c in a serial connection manner.

Please refer to FIG. 7 again. For withstanding a large output voltage, the second winding 45 is further electrically connected with an external inductor 45a (or a parasitic inductor on the wiring structure). The voltage coupled by the second winding 45 can be allocated to the external inductor 45a (or the parasitic inductor). Consequently, a closed loop is formed by the second winding 45 and the external inductor 45a (or the parasitic inductor) collaboratively.

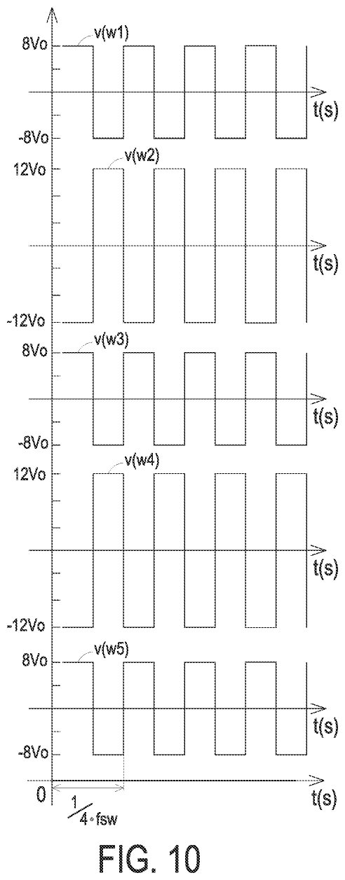

FIG. 10 is a schematic timing waveform diagram illustrating the voltage waveforms of the second winding wound around the middle legs of the magnetic device as shown in FIG. 7. Please refer to FIGS. 6, 7 and 10. In FIG. 10, V(w1) is the voltage waveform of the second winding 45 wound around the middle leg 412 of the first magnetic element 41, V(w2) is the voltage waveform of the second winding 45 wound around the middle leg 412 of the second magnetic element 42, V(w3) is the voltage waveform of the second winding 45 wound around the middle leg 412 of the third magnetic element 41, V(w4) is the voltage waveform of the second winding 45 wound around the middle leg 412 of the fourth magnetic element 42, and V(w5) is the voltage waveform of the second winding 45 wound around the middle leg 412 of the fifth magnetic element 41.

As shown in FIG. 10, the voltage waveform V(w1), the voltage waveform V(w3) and the voltage waveform V(w5) are same to each other. As shown in FIGS. 6 and 10, the switching frequency of the voltage signal of the second winding wound around each middle leg of the magnetic element is four times the frequency of the first PWM control signal PWM1. That is, the switching cycle is equal to 1/(4fsw). Consequently, in case that the duty cycle of the first PWM control signal PWM1 is 12.5%, the duty cycle of the voltage signal in each of the voltage waveform V(w1), the voltage waveform V(w3) and the voltage waveform V(w5) is 50%. In addition, the amplitude of the positive voltage signal in each of the voltage waveform V(w1), the voltage waveform V(w3) and the voltage waveform V(w5) is eight times the output voltage (i.e., 8Vo), and the amplitude of the negative voltage signal in each of the voltage waveform V(w1), the voltage waveform V(w3) and the voltage waveform V(w5) is minus eight times the output voltage (i.e., −8Vo).

As mentioned above, the turn number of the second winding 45 wound around the middle leg 412 of the second magnetic element 42 (or the fourth magnetic element 42) is 1.5 times the turn number of the second winding 45 wound around the middle leg 412 of the first magnetic element 41 (or the third magnetic element 41 or the fifth magnetic element 41). Consequently, the voltage of the second winding 45 coupled to the middle leg 412 of the second magnetic element 42 (or the fourth magnetic element 42) is 1.5 times the voltage of the second winding 45 coupled to the middle leg 412 of the first magnetic element 41 (or the third magnetic element 41 or the fifth magnetic element 41). Moreover, as shown in FIG. 10, the voltage waveform V(w2) and the voltage waveform V(w4) are same to each other. In addition, the phase difference between the voltage waveform V(w2) (or the voltage waveform V(w4)) and the voltage waveform V(w1) is 180 degrees. In case that the duty cycle of the first PWM control signal PWM1 is 12.5%, the amplitude of the positive voltage signal in each of the voltage waveform V(w2) and the voltage waveform V(w4) is twelve times the output voltage (i.e., 12Vo), and the amplitude of the negative voltage signal in each of the voltage waveform V(w2) and the voltage waveform V(w4) is minus twelve times the output voltage (i.e., −12Vo).

As mentioned above, the voltage of the second winding 45 coupled to the middle leg 412 of the second magnetic element 42 (or the fourth magnetic element 42) is 1.5 times the voltage of the second winding 45 coupled to the middle leg 412 of the first magnetic element 41 (or the third magnetic element 41 or the fifth magnetic element 41). Moreover, the second magnetic element 42 and the fourth magnetic element 42 are controlled according to a group of PWM control signals. That is, the second magnetic element 42 and the fourth magnetic element 42 are controlled according to the PWM control signals PWM2, PWM4, PWM6 and PWM8. Moreover, the first magnetic element 41, the third magnetic element 41 and the fifth magnetic element 41 are controlled according to another group of PWM control signals. That is, the first magnetic element 41, the third magnetic element 41 and the fifth magnetic element 41 are controlled according to the PWM control signals PWM1, PWM3, PWM5 and PWM7. In other words, the number of magnetic elements driven by the PWM control signals PWM1, PWM3, PWM5 and PWM7 is 1.5 times the number of magnetic elements driven by the PWM control signals PWM2, PWM4, PWM6 and PWM8. Consequently, the DC voltage amplitude and the AC voltage amplitude in the total voltage of the second winding 45 wound around all middle legs of the five magnetic elements is very small (or nearly zero). Since the voltage of the second winding 45 is applied to the external inductor 45a and the magnitude of the AC current flowing through the external inductor 45a is very low (or nearly zero), the magnitude of the inductor AC current of the overall power conversion module 2 is relatively low. Consequently, the efficiency of each power conversion circuit in the steady state is not adversely affected.

As mentioned above, when the load driven by the electronic device with the power conversion module 2 is subjected to the dynamic conversion and switched from the heavy load condition to the light load condition, the output voltage from the power conversion module 2 possibly overshoots. For solving the overshoot problem, the response of the control unit K of the power conversion module 2 allows the duty cycles of all PWM control signals to be zero. Consequently, the lower switch of each switch device is turned on and the four inductors L defined by the four first windings 43 and the corresponding lateral legs 413 withstand the output voltage. Moreover, 48 times output voltage coupled by the second winding 45 is applied to the external inductor 45a. Consequently, the magnitude of the current flowing through the external inductor 45a is largely increased, and the magnitude of the current flowing through the second winding 45 is largely decreased. Since the overshoot of the output voltage is largely suppressed, the overshoot of the output voltage during the dynamic conversion of the load can be effectively reduced. From the above descriptions, the power conversion module 2 can reduce the fluctuation range of the output voltage without increasing the number of the output capacitors. Consequently, the cost and the volume of the power conversion module 2 are reduced.

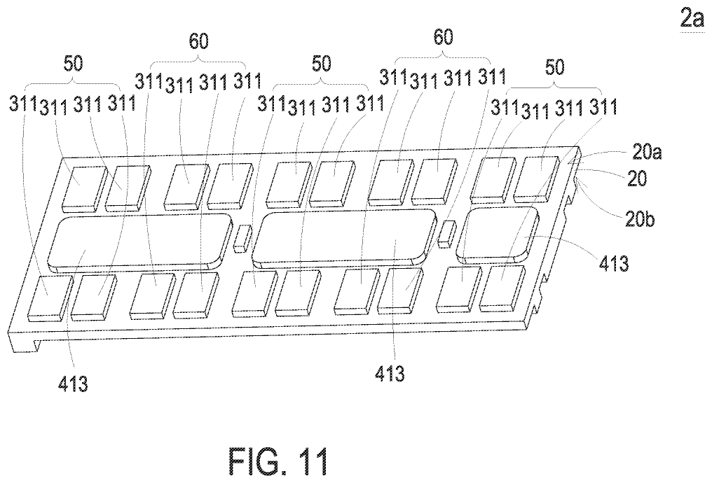

FIG. 11 is a structure perspective view illustrating a power conversion module according to a second embodiment of the present disclosure. In this embodiment, the magnetic device of the power conversion module 2a also includes five magnetic elements. However, the magnetic device is equipped with three magnetic cover pairs. The magnetic cover pairs as shown in FIG. 11 are referred to as a first magnetic cover pair, a second magnetic cover pair and a third magnetic cover pair from left to right. The first magnetic cover pair is shared by the first magnetic element and the second magnetic element. The second magnetic cover pair is shared by the third magnetic element and the fourth magnetic element. The third pair of the magnetic covers are aligned with the fifth magnetic element. Please refer to FIG. 11 again. The lateral legs 411 and the middle leg 412 of the first magnetic element 41 are arranged between the first magnetic cover 413 and the second magnetic cover 414 of the first magnetic cover pair. The lateral legs 411 and the middle leg 412 of the second magnetic element 42 are arranged between the first magnetic cover 413 and the second magnetic cover 414 of the first magnetic cover pair. The lateral legs 411 and the middle leg 412 of the third magnetic element 41 are arranged between the first magnetic cover 413 and the second magnetic cover 414 of the second magnetic cover pair. The lateral legs 411 and the middle leg 412 of the fourth magnetic element 42 are arranged between the first magnetic cover 413 and the second magnetic cover 414 of the second magnetic cover pair. The lateral legs 411 and the middle leg 412 of the fifth magnetic element 41 are arranged between the first magnetic cover 413 and the second magnetic cover 414 of the third magnetic cover pair.

In a variant example, the magnetic device is equipped with a single magnetic cover pair. The lateral legs and the middle legs of all magnetic elements are arranged between the first magnetic cover 413 and the second magnetic cover 414 of the single magnetic cover pair.

It is noted that the number of the magnetic cover pairs and the shapes of the magnetic covers are not restricted and may be varied according to the practical requirements.

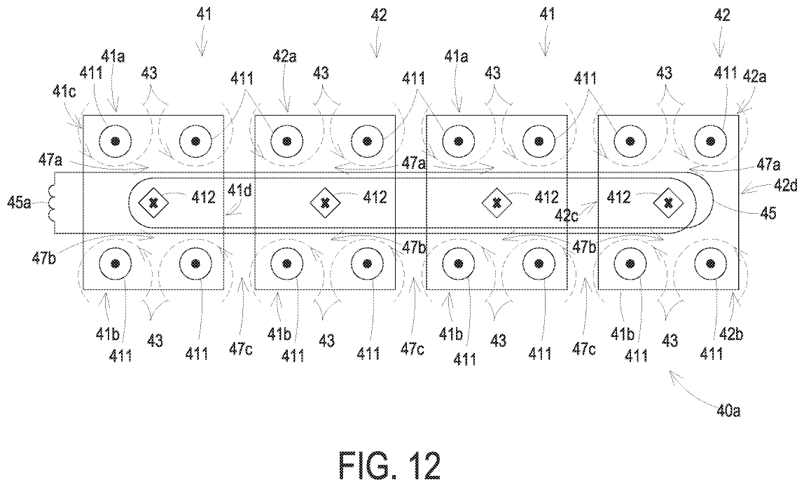

FIG. 12 is a schematic structure view illustrating a magnetic device of a power conversion module according to a third embodiment of the present disclosure. In this embodiment, the magnetic device 40a of the power conversion module includes four magnetic elements. The four magnetic elements include a first magnetic element 41, a second magnetic element 42, a third magnetic element 41 and a fourth magnetic element 42, which are arranged in sequence. The structures of the first magnetic element 41 and the third magnetic element 41 are identical. The structures of the second magnetic element 42 and the fourth magnetic element 42 are identical. The structures of the first magnetic element 41, the second magnetic element 42, the third magnetic element 41 and the fourth magnetic element 42 of the magnetic device 40a are similar to the structures of the first magnetic element 41, the second magnetic element 42, the third magnetic element 41 and the fourth magnetic element 42 of the magnetic device 40 as shown in FIG. 7, and are not redundantly described hereinafter.

Please refer to FIG. 12. For winding the second winding 45, the second winding 45 is firstly fed into the first channel 47a of the first magnetic element 41. Then, the second winding 45 is transported to the fourth side 42d of the fourth magnetic element 42 through the first channel 47a of the first magnetic element 41, the first channel 47a of the second magnetic element 42, the first channel 47a of the third magnetic element 41 and the first channel 47a of the fourth magnetic element 42 sequentially. Then, the second winding 45 is transported to the third side 41c of the first magnetic element 41 through the second channel 47b of the fourth magnetic element 42, the second channel 47b of the third magnetic element 41, the second channel 47b of the second magnetic element 42 and the second channel 47b of the first magnetic element 41 sequentially. Then, the second winding 45 is transported to the fourth side 42d of the fourth magnetic element 42 through the first channel 47a of the first magnetic element 41, the first channel 47a of the second magnetic element 42, the first channel 47a of the third magnetic element 41 and the first channel 47a of the fourth magnetic element 42 sequentially. Then, the second winding 45 is transported to the third side 41c of the first magnetic element 41 through the second channel 47b of the fourth magnetic element 42, the second channel 47b of the third magnetic element 41, the second channel 47b of the second magnetic element 42 and the second channel 47b of the first magnetic element 41 sequentially. In this way, the second winding 45 is wound around the middle leg 412 of the first magnetic element 41, the middle leg 412 of the second magnetic element 42, the middle leg 412 of the third magnetic element 41 and the middle leg 412 of the fourth magnetic element 42.

In an embodiment, the second winding 45 is wound around the middle leg 412 of the first magnetic element 41 for two turns, the second winding 45 is wound around the middle leg 412 of the second magnetic element 42 for two turns, the second winding 45 is wound around the middle leg 412 of the third magnetic element 41 for two turns, and the second winding 45 is wound around the middle leg 412 of the fourth magnetic element 42 for two turns. It is noted that the feed point of the second winding 45 is not restricted to the first channel 47a of the first magnetic element 41. That is, the feed point of the second winding 45 may be varied according to the practical requirements. The winding method of the second winding 45 in this embodiment may be identical to the winding method of the second winding 45 as shown in FIG. 7. Consequently, 32 times output voltage coupled by the second winding 45 is applied to the external inductor 45a. In other words, the power conversion module can reduce the fluctuation range of the output voltage without increasing the number of the output capacitors.

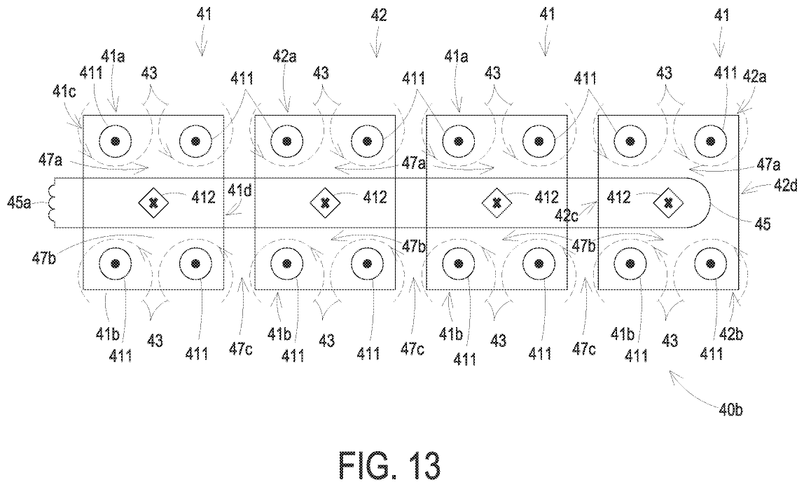

For increasing the utilization of the circuit board 20, the winding method of the second winding 45 can be further simplified. FIG. 13 is a schematic structure view illustrating a magnetic device of a power conversion module according to a fourth embodiment of the present disclosure. Please refer to FIG. 13. For winding the second winding 45 of the magnetic device 40b, the second winding 45 of the magnetic device 40b is firstly fed into the first channel 47a of the first magnetic element 41. Then, the second winding 45 is transported to the fourth side 42d of the fourth magnetic element 42 through the first channel 47a of the first magnetic element 41, the first channel 47a of the second magnetic element 42, the first channel 47a of the third magnetic element 41 and the first channel 47a of the fourth magnetic element 42 sequentially. Then, the second winding 45 is transported to the third side 41c of the first magnetic element 41 through the second channel 47b of the fourth magnetic element 42, the second channel 47b of the third magnetic element 41, the second channel 47b of the second magnetic element 42 and the second channel 47b of the first magnetic element 41 sequentially. In this way, the second winding 45 is wound around the middle leg 412 of the first magnetic element 41, the middle leg 412 of the second magnetic element 42, the middle leg 412 of the third magnetic element 41 and the middle leg 412 of the fourth magnetic element 42.

In an embodiment, the second winding 45 is wound around the middle leg 412 of the first magnetic element 41 for one turn, the second winding 45 is wound around the middle leg 412 of the second magnetic element 42 for one turn, the second winding 45 is wound around the middle leg 412 of the third magnetic element 41 for one turn, and the second winding 45 is wound around the middle leg 412 of the fourth magnetic element 42 for one turn. It is noted that the feed point of the second winding 45 is not restricted to the first channel 47a of the first magnetic element 41. That is, the feed point of the second winding 45 may be varied according to the practical requirements. The magnetic device 40b of this embodiment has lower power loss and higher efficiency. Moreover, since the magnitude of the voltage of the second winding 45 coupled to each middle leg is smaller, the demand on the inductance of the external inductor 45a is not very stringent. Consequently, the external inductor 45a can be replaced by the parasitic inductance with the lower inductance.

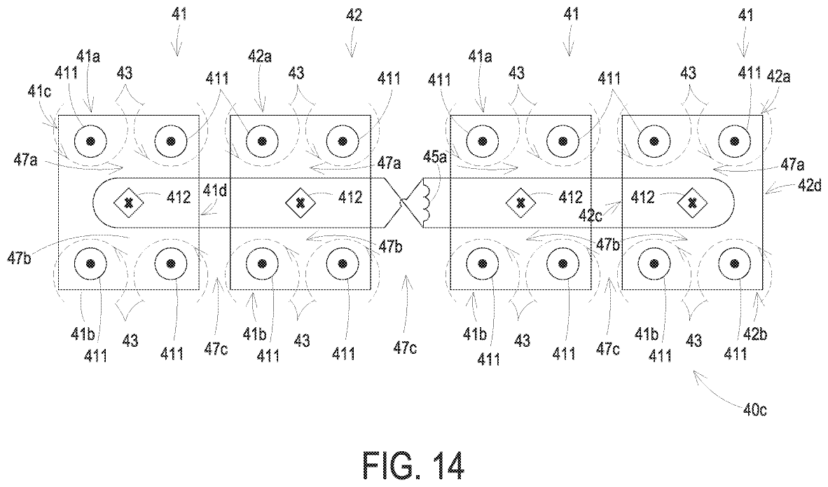

In some embodiments, the second winding 45 is wound around the middle legs of the magnetic device in a parallel connection manner. FIG. 14 is a schematic structure view illustrating a magnetic device of a power conversion module according to a fifth embodiment of the present disclosure. Please refer to FIG. 14. For winding the second winding 45 of the magnetic device 40c, the second winding 45 of the magnetic device 40c is firstly fed into the first channel 47a of the first magnetic element 41. Then, the second winding 45 is transported to the fourth side 42d of the fourth magnetic element 42 through the first channel 47a of the first magnetic element 41, the first channel 47a of the second magnetic element 42, the third channel 47c between the second magnetic element 42 and the third magnetic element 41, the second channel 47b of the third magnetic element 41 and the second channel 47b of the fourth magnetic element 42 sequentially. Then, the second winding 45 is transported to the third side 41c of the first magnetic element 41 through the first channel 47a of the fourth magnetic element 42, the first channel 47a of the third magnetic element 41, the third channel 47c between the second magnetic element 42 and the third magnetic element 41, the second channel 47b of the second magnetic element 42 and the second channel 47b of the first magnetic element 41 sequentially. In this way, the second winding 45 is wound around the middle leg 412 of the first magnetic element 41, the middle leg 412 of the second magnetic element 42, the middle leg 412 of the third magnetic element 41 and the middle leg 412 of the fourth magnetic element 42.

In an embodiment, the second winding 45 is wound around the middle leg 412 of the first magnetic element 41 for one turn, the second winding 45 is wound around the middle leg 412 of the second magnetic element 42 for one turn, the second winding 45 is wound around the middle leg 412 of the third magnetic element 41 for one turn, and the second winding 45 is wound around the middle leg 412 of the fourth magnetic element 42 for one turn. Moreover, the second winding 45 passes through the third channel 47c between the second magnetic element 42 and the third magnetic element 41 for two times, and there is an overlap region between the two segments of the second winding 45. The two terminals of the external inductor 45a are respectively connected to the two sides of the overlap region. In this way, the segment of the second winding 45 wound around the middle leg 412 of the first magnetic element 41 and the middle leg 412 of the second magnetic element 42 and the segment of the second winding 45 wound around the middle leg 412 of the third magnetic element 41 and the middle leg 412 of the fourth magnetic element 42 are connected in parallel. That is, at least portions of the second winding 45 are wound around the middle legs of the magnetic device in a parallel connection manner.

It is noted that numerous modifications and alterations may be made while retaining the teachings of the invention. For example, in another embodiment, the magnetic device of the power conversion module includes three magnetic elements. The three magnetic elements include a first magnetic element, a second magnetic element and a third magnetic element. The structures of the first magnetic element and the third magnetic element are identical. The second winding is wound around the middle leg of the first magnetic element for K turns, the second winding is wound around the middle leg of the second magnetic element for 2K turns, and the second winding is wound around the middle leg of the third magnetic element for K turns, wherein K is an integer greater than 1. The first windings wound around the four lateral legs of the first magnetic element are controlled according to the first PWM control signal PWM1, the third PWM control signal PWM3, the fifth PWM control signal PWM5 and the seventh control signal PWM7. The first windings wound around the four lateral legs of the second magnetic element are controlled according to the second PWM control signal PWM2, the fourth PWM control signal PWM4, the sixth PWM control signal PWM6 and the eighth PWM control signal PWM8. The first windings wound around the four lateral legs of the third magnetic element are controlled according to the first PWM control signal PWM1, the third PWM control signal PWM3, the fifth PWM control signal PWM5 and the seventh control signal PWM7. The installation positions and the controlling methods of the first magnetic element, the second magnetic element and the third magnetic element of this embodiment are similar to those of FIG. 7, and are not redundantly described hereinafter.

In another embodiment, the first windings wound around the four lateral legs of each first magnetic element and the first windings wound around the four lateral legs of each second magnetic element are controlled according to twelve different PWM control signals.

In another embodiment, the magnetic device of the power conversion module includes a first magnetic element and a second magnetic element. The first windings wound around the four lateral legs of the first magnetic element are controlled according to the first PWM control signal PWM1, the third PWM control signal PWM3, the fifth PWM control signal PWM5 and the seventh control signal PWM7. The first windings wound around the four lateral legs of the second magnetic element are controlled according to the second PWM control signal PWM2, the fourth PWM control signal PWM4, the sixth PWM control signal PWM6 and the eighth PWM control signal PWM8.

In another embodiment, all middle legs of the power conversion module are integrated as a single combined middle leg, all first magnetic covers of the power conversion module are integrated as a single combined first magnetic cover, and all second magnetic covers of the power conversion module are integrated as a single combined second magnetic cover. Consequently, the integration of the power conversion module is enhanced, the power density of the power conversion module is increased, and the assembling complexity of the power conversion module is reduced.

In another embodiment, the number of the first magnetic covers and the number of the second magnetic covers are not equal. Similarly, the purpose of the present disclosure can also be achieved.

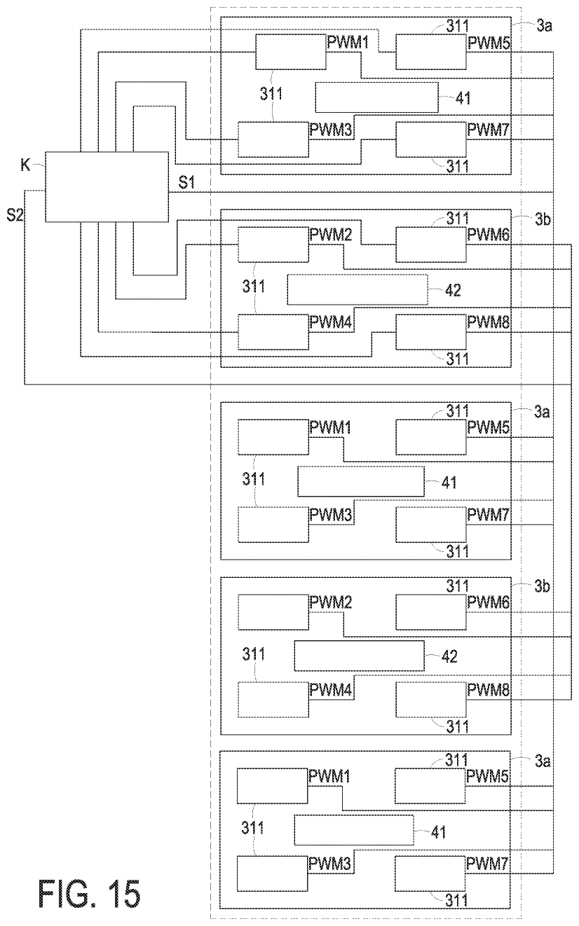

Please refer to FIGS. 3A, 5, 7 and 15. FIG. 15 is a schematic circuit diagram illustrating the electromagnetic integrated circuits and the control unit of the power conversion circuit as shown in FIG. 5. As shown in FIG. 15, the control unit K is electrically connected with the switch units 311 of each first electromagnetic integrated circuit 3a and the switch units 311 of each second electromagnetic integrated circuit 3b. The control unit K outputs a first control signal S1 to the driver circuit 312 of each first electromagnetic integrated circuit 3a as shown in FIG. 5. According to the first control signal S1, the driver circuit 312 outputs the first PWM control signal PWM1, the third PWM control signal PWM3, the fifth PWM control signal PWM 5 and the seventh PWM control signal PWM7 to control the operations of the switch units 311 of each first integrated circuit 3a. The control unit K further outputs a second control signal S2 to the driver circuit 322 of each second electromagnetic integrated circuit 3b as shown in FIG. 5. According to the second control signal S2, the driver circuit 322 outputs the second PWM control signal PWM2, the fourth PWM control signal PWM4, the sixth PWM control signal PWM6 and the eighth PWM control signal PWM8 to control the operations of the switch units 311 of each second integrate circuit 3b.

Moreover, the control unit K detects the currents flowing through the switch units 311 of at least one first electromagnetic integrated circuit 3a and detects the currents flowing through the switch units 311 of at least one second electromagnetic integrated circuit 3b. Under control of the control unit K, the magnitudes of the output currents from the four first windings 43 of the first electromagnetic integrated circuit 3a are equal to each other, and the magnitudes of the output currents from the four first windings 43 of the second electromagnetic integrated circuit 3b are equal to each other. Moreover, the magnitudes of the output currents from the four first windings 43 of the first electromagnetic integrated circuit 3a and the magnitudes of the output currents from the four first windings 43 of the second electromagnetic integrated circuit 3b are equal. Since the current error between the four lateral legs 411 of the first electromagnetic integrated circuit 3a is zero, there is no magnetic pressure between the four lateral legs 411 of the first electromagnetic integrated circuit 3a. Moreover, there is no magnetic saturation between the four lateral legs 411 of the first electromagnetic integrated circuit 3a, and the current error is also zero. Similarly, the current error between the four lateral legs 411 of the second electromagnetic integrated circuit 3b is zero, and there is no magnetic pressure between the four lateral legs 411 of the second electromagnetic integrated circuit 3b. Moreover, there is no magnetic saturation between the four lateral legs 411 of the second electromagnetic integrated circuit 3b, and the current error is also zero. In an embodiment, the parasitic resistance of the electric traces in the circuit board is specially designed. Consequently, the currents flowing through the first windings of the electromagnetic integrated circuit can be homogenized.

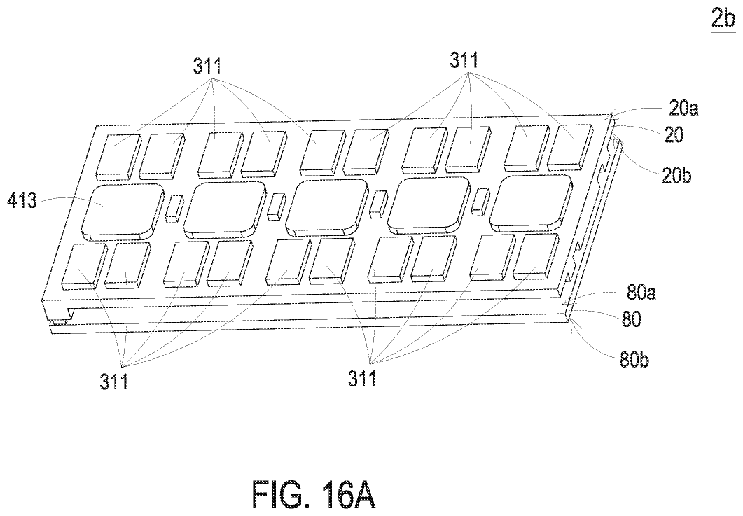

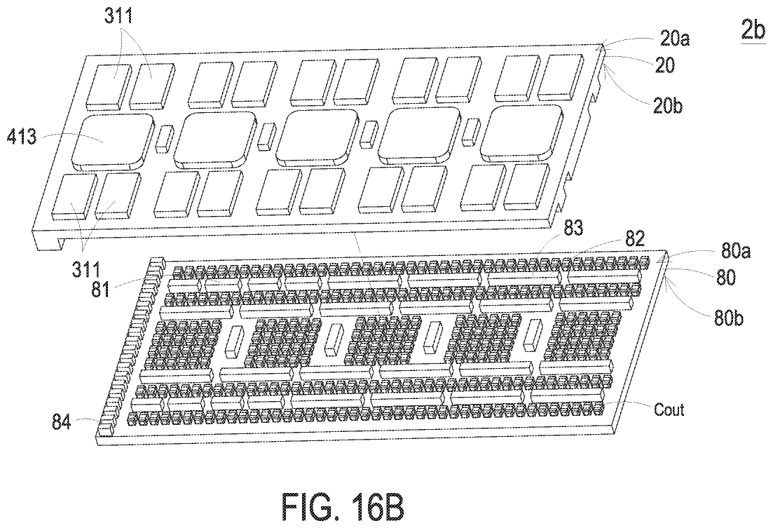

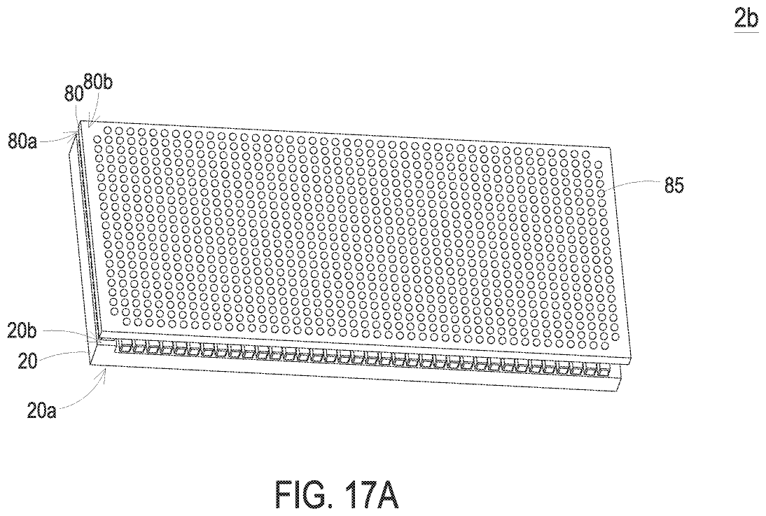

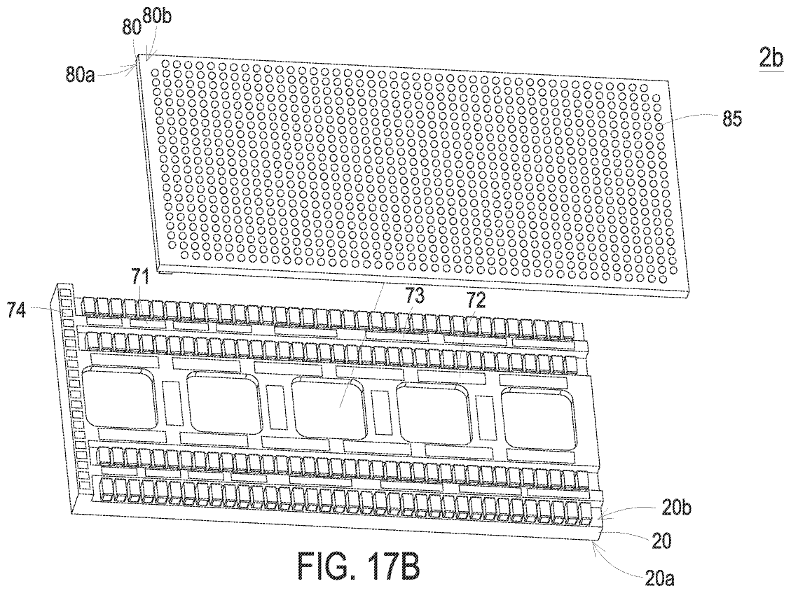

In some embodiments, the power conversion module includes a plurality of output capacitors. Due to the plurality of output capacitors, the dynamic performance of the power conversion module can be enhanced. Please refer to FIGS. 16A, 16B, 17A and 17B. FIG. 16A is a schematic structure view illustrating a power conversion module according to a sixth embodiment of the present disclosure. FIG. 16B is a schematic exploded view illustrating the power conversion module as shown in FIG. 16A. FIG. 17A is a schematic structure view illustrating the power conversion module as shown in FIG. 16A from another perspective. FIG. 17B is a schematic exploded view illustrating the power conversion module as shown in FIG. 17A. In this embodiment, the power conversion module 2b further includes an adapter board 80, a plurality of output capacitors Cout, a plurality of positive input terminal pins 81, a plurality of positive output terminal pins 82, a plurality of negative output terminal pins 83 and a plurality of signal pins 84.

The adapter board 80 has a first surface 80a and a second surface 80b, which are opposed to each other. The first surface 80a of the adapter board 80 is disposed on the second surface 20b of the circuit board 20. Moreover, a plurality of adapter conductors 85 are formed on the second surface 80b of the adapter board 80. The second surface 80b of the adapter board 80 is disposed on the system board through the plurality of adapter conductors 85. The plurality of adapter conductors 85 are penetrated through corresponding perforations of the system board and electrically connected with the central processing unit (not shown). In an embodiment, the plurality of adapter conductors 85 are pins of a ball grid array (BGA) package structure. The process of electrically connecting the power conversion module 2b connected with the central processing unit through the adapter conductors 85 of the adapter board 80 is very simple. Moreover, the arrangement of the adapter conductors 85 can reduce the parasitic impedance of the system board and reduce the conduction loss. Consequently, the efficiency of providing electric power from the power conversion module 2b to the central processing unit is enhanced.

As shown in FIG. 16B, the plurality of output capacitors Cout, the plurality of positive input terminal pins 81, the plurality of positive output terminal pins 82, the plurality of negative output terminal pins 83 and the plurality of signal pins 84 are disposed on the first surface 80a of the adapter board 80. It is noted that the installation positions of these components are not restricted and may be varied according to the practical requirements.

The plurality of positive input terminal pins 81 are aligned and connected with the plurality of positive input terminal connection parts 71. The plurality of positive output terminal pins 82 are aligned and connected with the plurality of positive output terminal connection parts 72. The plurality of negative output terminal pins 83 are aligned and connected with the plurality of negative output terminal connection parts 73. The plurality of signal pins 84 are aligned and connected with the plurality of signal connection parts 74.

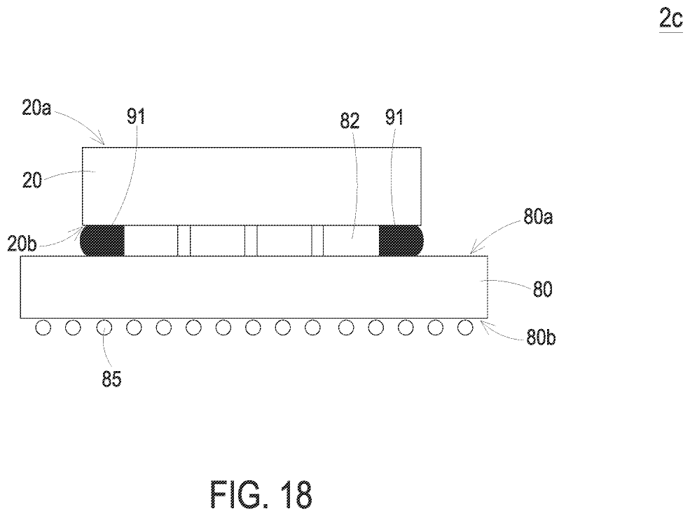

FIG. 18 is a schematic side view illustrating a power conversion module according to a seventh embodiment of the present disclosure. In comparison with the power conversion module 2b of FIG. 16A, the power conversion module 2c of this embodiment further includes at least two first epoxy glues 91. The first epoxy glues 91 are cured and arranged between the second surface 20b of the circuit board 20 and the first surface 80a of the adapter board 80. As shown in FIG. 18, the plurality of positive output terminal pins 82 are arranged between the second surface 20b of the circuit board 20 and the first surface 80a of the adapter board 80, and the two first epoxy glues 91 are contacted with the two positive output terminal pins 82 at the outer sides. In practice, the plurality of positive input terminal pins 81, the plurality of positive output terminal pins 82, the plurality of negative output terminal pins 83 and the plurality of signal pins 84 are arranged between the second surface 20b of the circuit board 20 and the first surface 80a of the adapter board 80, and the two first epoxy glues 91 are contacted with two of the positive input terminal pins 81, the plurality of positive output terminal pins 82, the plurality of negative output terminal pins 83 and the plurality of signal pins 84 at the outer sides. In some embodiments, the plurality of first epoxy glues 91 are contacted with corresponding positive input terminal pins 81, corresponding positive output terminal pins 82, corresponding negative output terminal pins 83 and corresponding signal pins 84 at the outer sides. The circuit board 20 and the adapter board 80 are connected with each other through the first epoxy glues 91. When the central processing unit on the system board is treated by using a reflow soldering process, the cured first epoxy glues 91 are softened. According to the viscosity of the softened first epoxy glues 91, solder joints between the pins and the circuit board 20 are generated, and solder joints between the pins and the adapter board 80 are also generated. Consequently, the pins are not detached from the circuit board 20 and the adapter board 80.

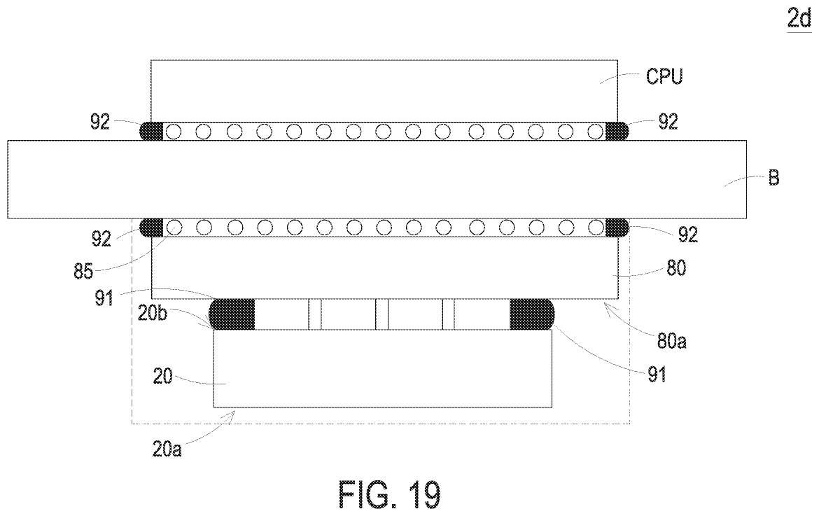

FIG. 19 is a schematic side view illustrating a power conversion module according to an eighth embodiment of the present disclosure. In comparison with the power conversion module 2c of FIG. 18, the power conversion module 2d of this embodiment further includes at least two second epoxy glues 92. The second epoxy glues 92 are cured and arranged between the second surface 80b of the adapter board 80 and the system board B. Moreover, the plurality of adapter conductors 85 are arranged between the two second epoxy glues 92. The adapter board 80 and the system board B are connected with each other through the second epoxy glues 92. When the central processing unit CPU on the system board B is treated by using a reflow soldering process, the cured second epoxy glues 92 are softened. According to the viscosity of the softened second epoxy glues 92, solder joints between the adapter conductors 85 and the adapter board 80 are generated, and solder joints between the adapter conductors 85 and the system board B are generated. Consequently, the adapter conductors 85 is not detached from the adapter board 80 and the system board B. In another embodiment, the second epoxy glues 92 are further arranged between the system board B and the central processing unit CPU. Consequently, the central processing unit CPU is not detached from the system board B.

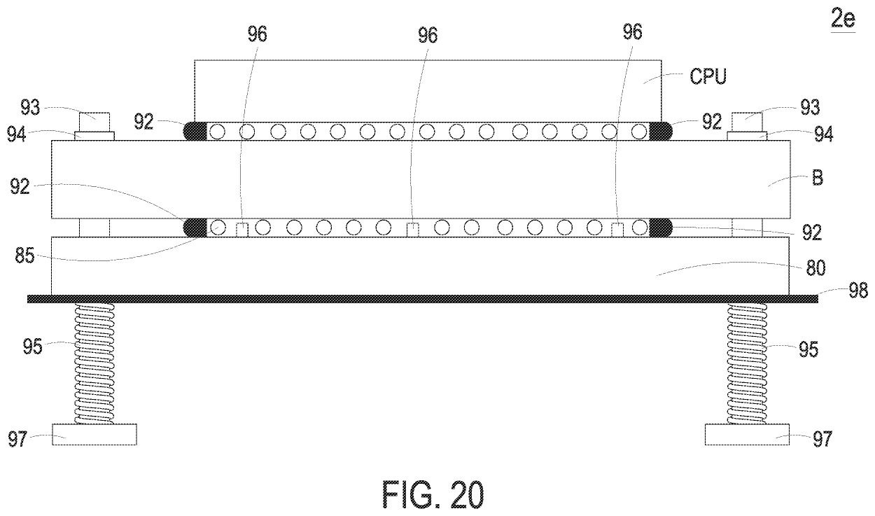

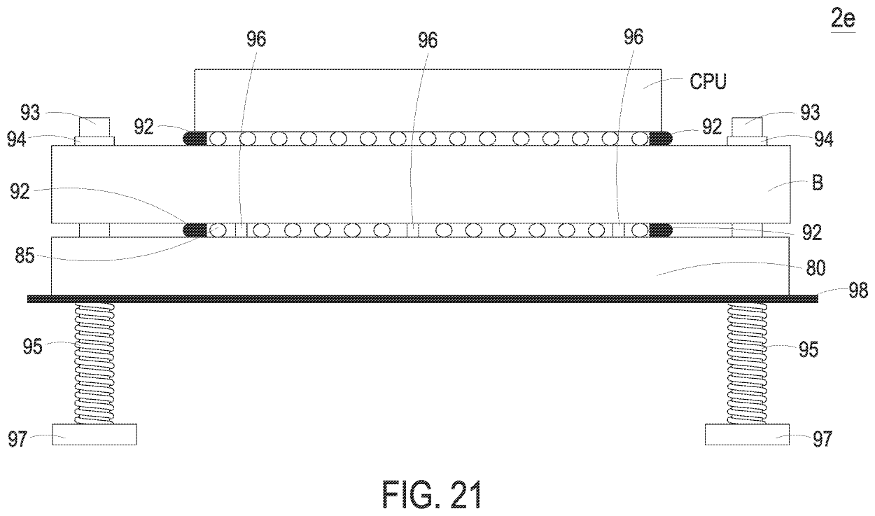

FIG. 20 is a schematic side view illustrating a power conversion module according to a ninth embodiment of the present disclosure, in which the pressure from the system board and the spring are received by the adapter conductors. FIG. 21 is a schematic side view illustrating the power conversion module as shown in FIG. 20, in which the pressure from the system board and the spring are received by the copper blocks. In comparison with the power conversion module 2d of FIG. 19, the power conversion module 2e of this embodiment further includes a screw rod 93, a nut 94, a spring 95, at least one copper block 96, a screw head 97 and a heat dissipation base 98. The adapter board and the circuit board are integrated as a board structure 80. The screw rod 93 is penetrated through the board structure 80 and the system board B. The nut 94 is arranged around an end of the screw rod 93 and contacted with the system board B in sequence to fix the screw rod 93 on the system board B. The spring 95 and the screw head 97 are located at the other end of the screw rod 93 to withstand the weight of the board structure 80 and the system board B. The heat dissipation base 98 is arranged between the spring 95 and the board structure 80 in sequence to remove the heat from the board structure 80. The at least one copper block 96 is arranged between the system board B and the board structure 80 and is located beside the adapter conductors 85. The hardness of the copper block 96 is higher than the hardness of the adapter conductor 85. In case that the pressure received by the system board B and the spring 95 is lower, the adapter conductor 85 can withstand the pressure. As shown in FIG. 20, the adapter conductors 85 are contacted with the system board B and the board structure 80 to withstand the pressure. In case that the pressure received by the system board B and the spring 95 is higher, the adapter conductor 85 cannot withstand the pressure. As shown in FIG. 21, the adapter conductors 85 withstands a portion of the pressure and undergoes the deformation, and the copper block 96 withstand a greater portion of the pressure. Consequently, the adapter conductors 85 will not be broken. In other words, the short-circuited problem or the open-circuited problem resulted from the adapter conductors 85 will be overcome.

In this embodiment, the board structure 80 can be replaced with the power conversion module 12, and the benefits shown in the above embodiments can also be achieved by arranging a copper block between the power conversion module and the system board.

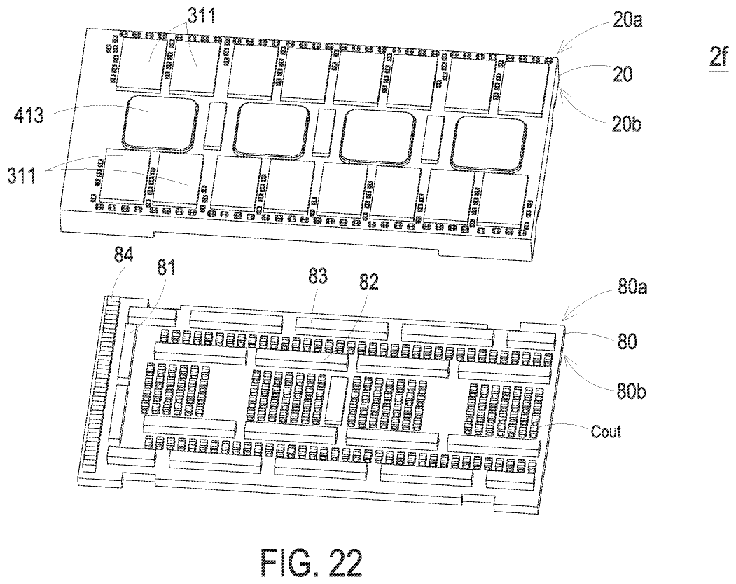

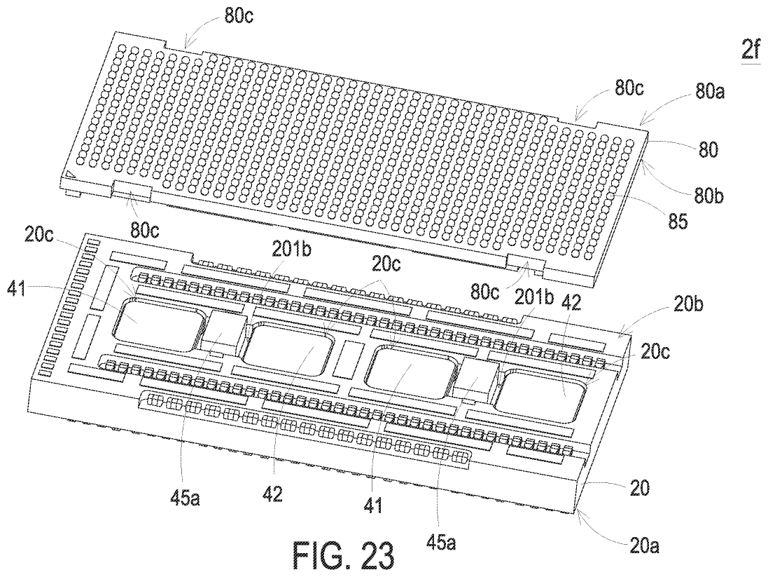

Please refer to FIGS. 22 and 23. FIG. 22 is a schematic exploded view illustrating a power conversion module according to a tenth embodiment of the present disclosure. FIG. 23 is a schematic exploded view illustrating the power conversion module as shown in FIG. 22 from another perspective. The power conversion module 2f of this embodiment is similar to the power conversion module 2b as shown in FIGS. 16A, 16B, 17A and 17B, and the same component numbers are used to denote similar components. In comparison with the power conversion module 2b as shown in FIGS. 16A, 16B, 17A and 17B including five magnetic elements, the power conversion module 2f of this embodiment includes four magnetic elements, for example the first magnetic element 41, the second magnetic element 42, the third magnetic element 41 and the fourth magnetic element 42 from left to right in FIG. 23. In addition, the power conversion module 2f of this embodiment further includes at least two external inductors 45a. For succinctness, the external inductor 45a on the left of FIG. 23 is referred to as the first external inductor 45a, and the external inductor 45a on the right of FIG. 23 is referred to as the second external inductor 45a. In this embodiment, the second surface 20b of the circuit board 20 of the power conversion module 2f includes a plurality of third concave regions 201b. Each of the plurality of the third concave regions 201b are concavely formed from the second surface 20b of the circuit board 20. Each of the plurality of third concave regions 201b is disposed between and in communication with two adjacent first concave regions 20c for accommodating the corresponding external inductor 45a. In this embodiment, the second surface 20b of the circuit board 20 includes four first concave regions 20a and two third concave regions 201b. The four first concave regions 20a are arranged in sequence and configured to accommodate the corresponding magnetic device 41, 42, respectively. Consequently, the first magnetic element 41, the second magnetic element 42, the third magnetic element 41 and the fourth magnetic element 42 are arranged in sequence. The two third concave regions 201b are configured to accommodate the corresponding external inductor 45a, respectively. One of the two third concave regions 201b is disposed between two adjacent first concave regions 20a of the four first concave regions 20a. The other of the two third concave regions 201b is disposed between the other two adjacent first concave regions 20a of the four first concave regions 20a. Consequently, the first external inductor 45a is disposed between the first magnetic element 41 and the second magnetic element 42, and the second external inductor 45a is disposed between the third magnetic element 41 and the fourth magnetic element 42.

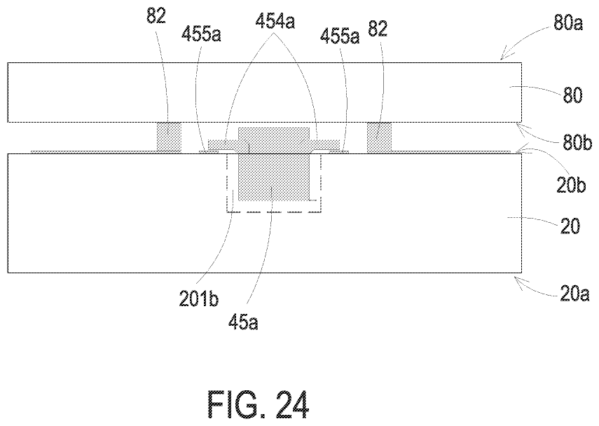

Please refer to FIGS. 22, 23 and 24. FIG. 24 is a schematic side view illustrating the power conversion module as shown in FIG. 22. In this embodiment, the first external inductor 45a and the second external inductor 45a have a plurality of solder pins 454a, respectively. The power conversion module 2f includes a plurality of solder pads 455a disposed on the second surface 20b of the circuit board 20 and located at two sides of the corresponding third concave region 201b for the external inductor 45a. Each solder pin 454a is connected with and located between the corresponding solder pad 455a and the corresponding external inductor 45a so that the external inductor 45a is soldered on the second surface 20b of the circuit board 20. As shown in FIG. 24, portion of the external inductor 45a is embedded in the third concave region 201b, and the other portion of the external inductor 45a is protruded from the second surface 20b of the circuit board 20. Since portion of the external inductor 45a is embedded in the circuit board 20, the overall height of the power conversion module 2f of this embodiment is lower and the power density of the power conversion module 2f is higher. In this embodiment, at the position of the adapter board 80 corresponding to the external inductor 45a, the output capacitor 45a is omitted, so that the external inductor 45a is not interfered with the output capacitors or pins on the adapter board 80 (e.g., the positive output terminal pin 82 or the negative output terminal pin 83). Therefore, on the premise of including the external inductor 45a, the power conversion module 2f of this embodiment not only improves the dynamic response speed thereof, but also improves the integration and power density thereof. In another embodiment, the inductor body of the external inductor 45a is embedded in the third concave region 201b, and the height of the external inductor 45a protruding from the second surface 20b of the circuit board 20 is zero.

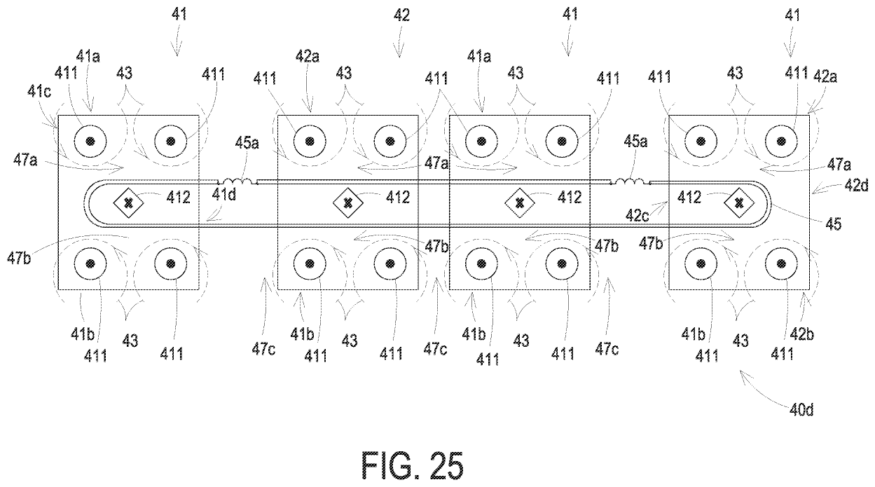

Please refer to FIGS. 22, 23 and 25. FIG. 25 is a schematic structure view illustrating the magnetic device of the power conversion module as shown in FIG. 22. The first magnetic element 41, the second magnetic element 42, the third magnetic element 41 and the fourth magnetic element 42 are arranged in sequence from left to right. The first magnetic element 41, the second magnetic element 42, the third magnetic element 41 and the fourth magnetic element 42 of the magnetic device 40d of this embodiment are similar to the first magnetic element 41, the second magnetic element 42, the third magnetic element 41 and the fourth magnetic element 42 of the magnetic device 40a as shown in FIG. 12, and are not redundantly described hereinafter.

In comparison with the magnetic device 40a as shown in FIG. 12 including single external inductor 45a, the magnetic device 40d of this embodiment includes two external inductors 45a, i.e., the first external inductor 45a and the second external inductor 45a. The volume of each external inductor 45a of the magnetic device 40d of this embodiment is less than the volume of the external inductor 45a of the magnetic device 40a as shown in FIG. 12. Consequently, the two external inductors 45a with smaller volumes can be dispersed and integrated inside the magnetic device 40d. For example, the two external inductors 45a with smaller volumes are arranged in the idle position of the magnetic device 40d with smaller volumes and no other components, so that the power conversion module 2f can be miniaturized and ultra-thin. In this embodiment, as shown in FIG. 25, the second winding 45 is wound around the middle legs of the magnetic device by means of two-strand windings connected in parallel or two-layer planar windings connected in parallel. For winding the second winding 45 of the magnetic device 40d, the second winding 45 of the magnetic device 40d is firstly fed into the first channel 47a of the first magnetic element 41. Then, the second winding 45 is transported to the fourth side 42d of the fourth magnetic element 42 through the first channel 47a of the first magnetic element 41, the first external inductor 45a (forming as portion of the second winding 45), the first channel 47a of the second magnetic element 42, the first channel 47a of the third magnetic element 41, the second external inductor 45a (forming as portion of the second winding 45), the first channel 47a of the fourth magnetic element 42 sequentially. Then, the second winding 45 is transported to the third side 41c of the first magnetic element 41 through the second channel 47b of the fourth magnetic element 42, the second channel 47b of the third magnetic element 41, the second channel 47b of the second magnetic element 42, the second channel 47b of the first magnetic element 41 sequentially. In this way, the second winding 45 is wound around the middle leg 412 of the first magnetic element 41, the middle leg 412 of the second magnetic element 42, the middle leg 412 of the third magnetic element 41 and the middle leg 412 of the fourth magnetic element 42.

In an embodiment, the second winding 45 is wound around the middle leg 412 of the first magnetic element 41 for one turn, the second winding 45 is wound around the middle leg 412 of the second magnetic element 42 for one turn, the second winding 45 is wound around the middle leg 412 of the third magnetic element 41 for one turn, and the second winding 45 is wound around the middle leg 412 of the fourth magnetic element 42 for one turn. Certainly, the above-mentioned winding method can also be used to continue winding multiple turns. The second winding 45 is not limited to the first channel 47a of the first magnetic element 41 as the feeding point and can be fed at different feeding point to perform the above winding operation. From the above descriptions, the voltage coupled from the second winding 45 can be distributed to the first external inductor 45a and the second external inductor 45a, and the second winding 45, the first external inductor 45a and the second external inductor 45a form a closed loop. In some other embodiments, the second winding 45 includes a single-layer PCB winding or a single-strand wire. Alternatively, the second winding 45 includes a multi-layer PCB with windings connected in parallel or multi-strand wires connected in parallel.

The voltage waveforms of the second winding 45 of this embodiment are similar to the voltage waveforms of the second winding 45 as shown in FIG. 10. The switching frequency of the voltage signal of the second winding wound around each middle leg of the magnetic element is eight times the frequency of the first PWM control signal PWM1. That is, the switching cycle is equal to 1/(8fsw). Consequently, in case that the duty cycle of the first PWM control signal PWM1 is 12.5%, the duty cycle of the voltage signal in the voltage waveforms of the second winding 45 wound around the middle leg 412 of each magnetic element is 100%, respectively. Since the voltage of the second winding 45 is applied to the first external inductor 45a and the second external inductor 45a and the AC currents flowing through the first external inductor 45a and the second external inductor 45a are very low (or nearly zero), the AC currents of the inductors of the overall power conversion module 2f are relatively low. Consequently, the efficiency of each power conversion circuit in the steady state is not adversely affected.

As mentioned above, when the load driven by the electronic device with the power conversion module 2f is subjected to the dynamic conversion and switched from the heavy load condition to the light load condition, the output voltage from the power conversion module 2f possibly overshoots. For solving the overshoot problem, the response of the control unit K of the power conversion module 2f allows the duty cycles of all PWM control signals to be zero. The lower switch of each switch unit is turned on. Consequently, the four inductors L defined by the four first windings 43 and the corresponding lateral legs withstand the output voltage. Moreover, 16 times output voltage coupled by the second winding 45 is applied to the first external inductor 45a and the second external inductor 45a. Consequently, the currents flowing through the first external inductor 45a and the second external inductor 45a are largely increased, and the current flowing through the second winding 45 is largely decreased. Since the overshoot of the output voltage is largely suppressed, the overshoot of the output voltage during the dynamic conversion of the load can be effectively reduced. From the above descriptions, the power conversion module 2f can reduce the fluctuation range of the output voltage without increase the number of the output capacitors. Consequently, the cost and the volume of the power conversion module 2f are reduced.

Certainly, the number of the magnetic elements of the power conversion module 2f of this embodiment is not limited to four, but can also be five as shown in FIG. 7, or even any positive integer. The functions of the magnetic elements are similar and not redundantly described hereinafter.

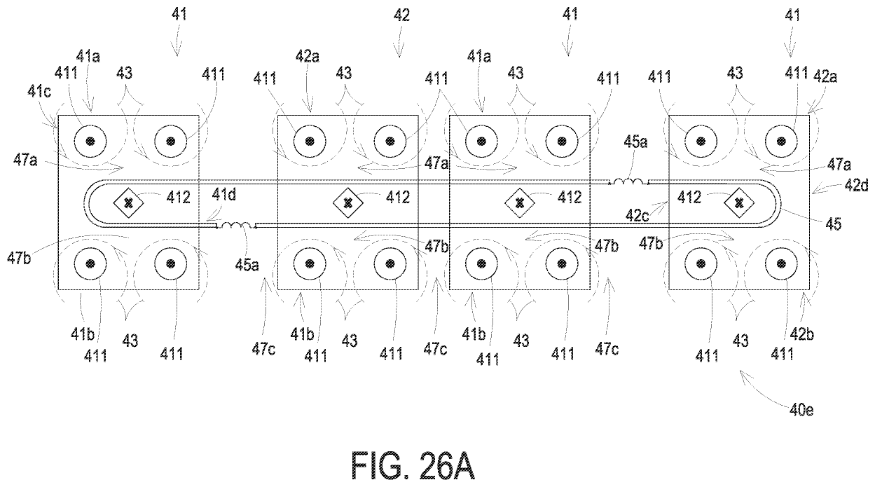

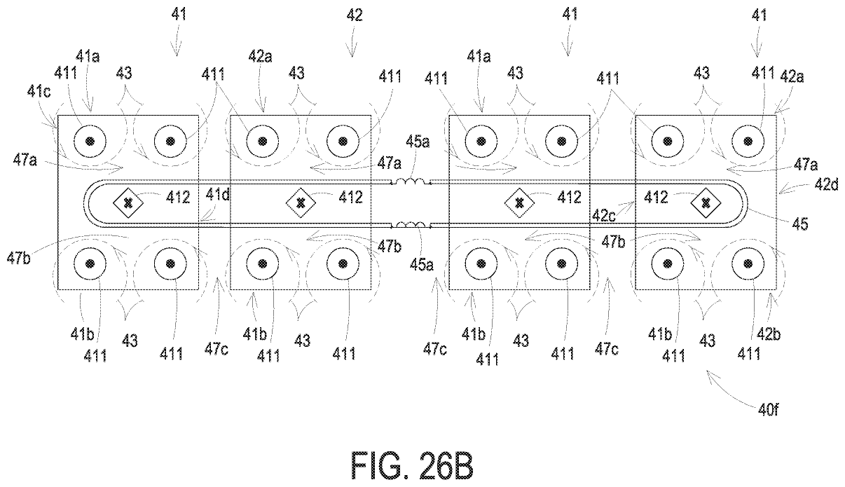

In some embodiments, the disposing positions of the first external inductor 45a and the second inductor 45a are not limited to the disposing positions as shown in FIG. 25. FIG. 26A is a schematic structure view illustrating a magnetic device of a power conversion module according to an eleventh embodiment of the present disclosure. As shown in FIG. 26A, the second winding 45 is wound around the middle legs of the magnetic device 40e by means of two-strand windings connected in parallel or two-layer planar windings connected in parallel. For winding the second winding 45 of the magnetic device 40e, the second winding 45 of the magnetic device 40e is firstly fed into the first channel 47a of the first magnetic element 41. Then, the second winding 45 is transported to the fourth side 42d of the fourth magnetic element 42 through the first channel 47a of the first magnetic element 41, the first channel 47a of the second magnetic element 42, the first channel 47a of the third magnetic element 41, the second external inductor 45a (forming as portion of the second winding 45), the first channel 47a of the fourth magnetic element 42 sequentially. Then, the second winding 45 is transported to the third side 41c of the first magnetic element 41 through the second channel 47b of the fourth magnetic element 42, the second channel 47b of the third magnetic element 41, the second channel 47b of the second magnetic element 42, the first external inductor 45a (forming as portion of the second winding 45), the second channel 47b of the first magnetic element 41 sequentially. In this way, the second winding 45 is wound around the middle leg 412 of the first magnetic element 41, the middle leg 412 of the second magnetic element 42, the middle leg 412 of the third magnetic element 41 and the middle leg 412 of the fourth magnetic element 42.

In an embodiment, the second winding 45 is wound around the middle leg 412 of the first magnetic element 41 for one turn, the second winding 45 is wound around the middle leg 412 of the second magnetic element 42 for one turn, the second winding 45 is wound around the middle leg 412 of the third magnetic element 41 for one turn, and the second winding 45 is wound around the middle leg 412 of the fourth magnetic element 42 for one turn. Certainly, the above-mentioned winding method can also be used to continue winding multiple turns. In some embodiments, the second winding 45 includes a single-layer PCB winding or a single-strand wire. Alternatively, the second winding 45 includes a multi-layer PCB with windings connected in parallel or multi-strand wires connected in parallel.

FIG. 26B is a schematic structure view illustrating a magnetic device of a power conversion module according to a twelfth embodiment of the present disclosure. As shown in FIG. 26B, the second winding 45 is wound around the middle legs of the magnetic device 40f by means of two-strand windings connected in parallel or two-layer planar windings connected in parallel. For winding the second winding 45 of the magnetic device 40f, the second winding 45 of the magnetic device 40f is firstly fed into the first channel 47a of the first magnetic element 41. Then, the second winding 45 is transported to the fourth side 42d of the fourth magnetic element 42 through the first channel 47a of the first magnetic element 41, the first channel 47a of the second magnetic element 42, the first external inductor 45a (forming as portion of the second winding 45), the first channel 47a of the third magnetic element 41, the first channel 47a of the fourth magnetic element 42 sequentially. Then, the second winding 45 is transported to the third side 41c of the first magnetic element 41 through the second channel 47b of the fourth magnetic element 42, the second channel 47b of the third magnetic element 41, the second external inductor 45a (forming as portion of the second winding 45), the second channel 47b of the second magnetic element 42, the second channel 47b of the first magnetic element 41 sequentially. In this way, the second winding 45 is wound around the middle leg 412 of the first magnetic element 41, the middle leg 412 of the second magnetic element 42, the middle leg 412 of the third magnetic element 41 and the middle leg 412 of the fourth magnetic element 42.

In an embodiment, the second winding 45 is wound around the middle leg 412 of the first magnetic element 41 for one turn, the second winding 45 is wound around the middle leg 412 of the second magnetic element 42 for one turn, the second winding 45 is wound around the middle leg 412 of the third magnetic element 41 for one turn, and the second winding 45 is wound around the middle leg 412 of the fourth magnetic element 42 for one turn. Certainly, the above-mentioned winding method can also be used to continue winding multiple turns. In some embodiments, the second winding 45 includes a single-layer PCB winding or a single-strand wire. Alternatively, the second winding 45 includes a multi-layer PCB with windings connected in parallel or multi-strand wires connected in parallel.

Certainly, the disposing positions of the first external inductor 45a and the second external inductor 45a are not limited to the above disposing positions, and the number of the external inductor 45a is not limited to two. For example, the power conversion module includes fourth external inductors. Two of the four external inductors are disposed between the first magnetic element 41 and the second magnetic element 42, and the other two of the four external inductors are disposed between the third magnetic element 41 and the fourth magnetic element 42. The disposing positions and the number of the external inductors can be varied according to the practice requirements, and are not redundantly described hereinafter.

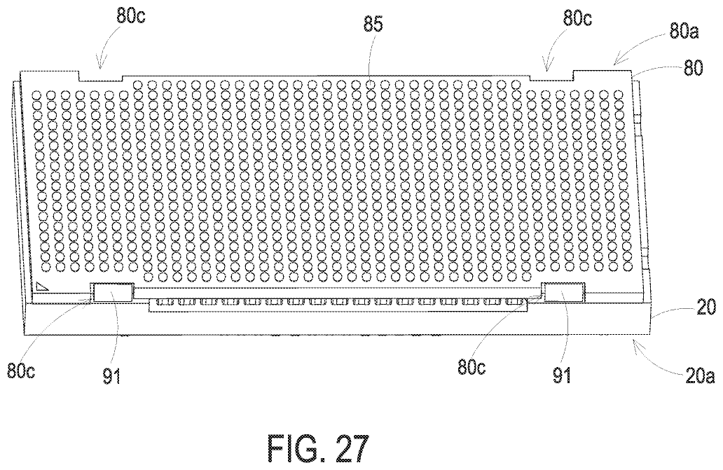

Please refer to FIG. 23 again. The adapter board 80 of the power conversion module 2f further includes a plurality of recesses 80c. For example, the power conversion module 2f includes four recesses 80c. Two of the four recesses 80c are disposed on a first sidewall of the adapter board 80, and the other two of the four recesses 80c are disposed on a second sidewall of the adapter board 80. The first sidewall and the second sidewall of the adapter board 80 are opposed to each other. Each recess 80c is concavely formed from the corresponding sidewall of the adapter board 80. Certainly, the disposing positions and the number of the recesses 80c are not limited to that as shown in FIG. 23 and can be varied according to the practical requirements. When the adapter board 80 and the circuit board 20 are assembled, portion of the second surface 20b of the circuit board 20 and the positive output terminal pin 82 or the negative output terminal pin 83 disposed on the second surface 20b of the circuit board 20 are exposed through the plurality of recesses 80c. In some embodiments, the first epoxy glue 91 of the power conversion module 2f is disposed in the recess 80c to be connected with the adapter board 80 upwardly, to be connected with the circuit board 20 downwardly and to be connected with the positive output terminal pin 82 or the negative output terminal pin 83 disposed on the second surface 20b laterally, as shown in FIG. 27. Consequently, the first epoxy glue 91 is connected with the circuit board 20, the adapter board 80 and the positive output terminal pin 82 or the negative output terminal pin 83 disposed on the second surface 20b of the circuit board 20 at the same time. The circuit board 20, the adapter board 80 and the positive output terminal pin 82 or the negative output terminal pin 83 disposed on the second surface 20b of the circuit board 20 are fixed together through the high temperature curing. While the central processing unit on the system board is subjected a reflow soldering, the cured first epoxy glue 91 may not soften at high temperature. Consequently, the solder joints between the circuit board 20 and the adapter board 80 are prevented from being remelted at high temperature, detached or displaced, and the product yield in production is further improved.

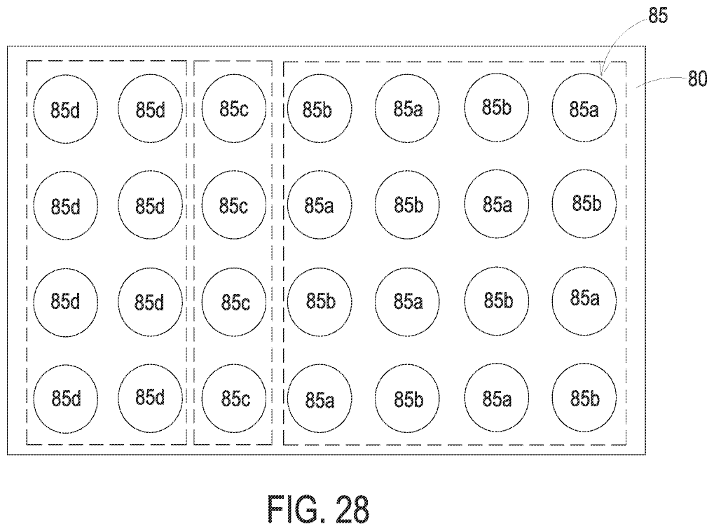

Please refer to FIGS. 22 and 23 again. The power conversion module 2f of this embodiment includes a plurality of positive input terminal pins 81, a plurality of positive output terminal pins 82, a plurality of negative output terminal pins 83, a plurality of signal pins 84 and a plurality of adapter conductors 85. The plurality of positive input terminal pins 81, the plurality of positive output terminal pins 82, the plurality of negative output terminal pins 83 and the plurality of signal pins 84 are disposed on the first surface 80a of the adapter board 80. The plurality of adapter conductors 85 are disposed on the second surface 80b of the adapter board 80. The second surface 80b of the adapter board 80 is disposed on the system board through the plurality of adapter conductors 85. The plurality of adapter conductors 85 are connected with the central processing unit by means of passing through the perforations of the system board. The disposing positions of the adapter conductors 85 will be further described below. Please refer to FIGS. 22, 23 and 28. FIG. 28 is a schematic perspective view illustrating the disposing positions of a plurality of adapter conductors of the power conversion module. In FIG. 28, only portion of the adapter conductors 85 are schematically shown, and the number of the adapter conductor 85 is not limited to that as shown in FIG. 28 and can be varied according to the practical requirements. The plurality of adapter conductors 85 are further divided into the output adapter conductors 85a, the grounding adapter conductors 85b, the input adapter conductors 85c and the signal adapter conductors 85d according to their functions. The output adapter conductor 85a is connected with the positive output terminal Spin 2 as shown in FIG. 22 through the electric traces within the adapter board 80. The grounding adapter conductor 85b is connected with the negative output terminal pin 83 as shown in FIG. 22 through the electric traces within the adapter board 80. The input adapter conductor 85c is connected with the positive input terminal pin 81 as shown in FIG. 22 through the electric traces within the adapter board 80. The signal adapter conductor 85d is connected with the signal pin 84 as shown in FIG. 22 through the electric traces within the adapter board 80. As shown in FIG. 28, the signal adapter conductors 85d are disposed on one side of the adapter board 80 (e.g., inside the dotted line on the left shown in FIG. 28), so that the redundant design of the signal adapter conductors is realized. The output adapter conductors 85a and the grounding adapter conductors 85b are disposed on the other side of the adapter board 80 (e.g., inside the dotted line on the right shown in FIG. 28) in staggered arrangement. The output adapter conductors 85a and the grounding adapter conductors 85b are corresponding to the pins of the central processing unit disposed on the system board, so that the number and area of short-circuit between the output adapter conductors 85a and the grounding adapter conductors 85b and the pins of the central processing unit respectively. Consequently, the parasitic resistance and the parasitic inductance of the short circuit are reduced so as to reduce the connection loss caused by the working current, and improve the output voltage response performance of the power conversion module 2f when the load is subjected to the dynamic conversion. The input adapter conductors 85c are disposed between the signal adapter conductors 85d and the output adapter conductors 85a and between the signal adapter conductors 85d and grounding adapter conductors 85b so as to reduce parasitic inductance between the input adapter conductor 85c and the grounding adapter conductor 85b. In addition, the parasitic inductance is suppressed from resonating with the input capacitance in the power conversion module 2f.

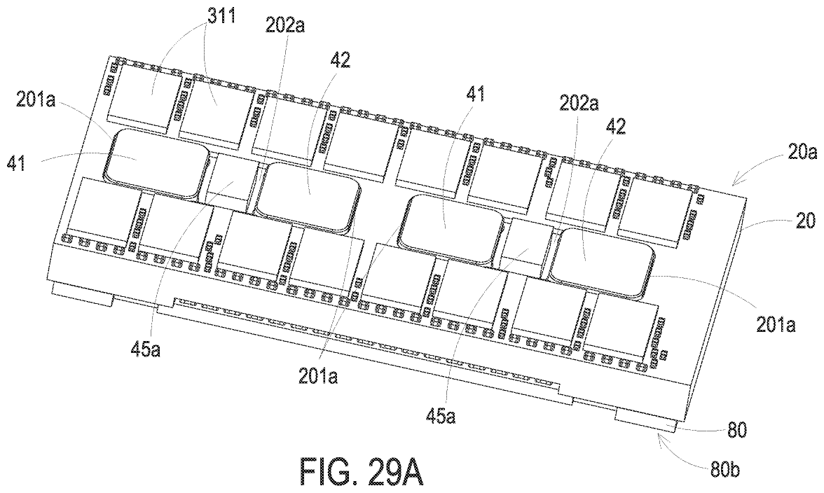

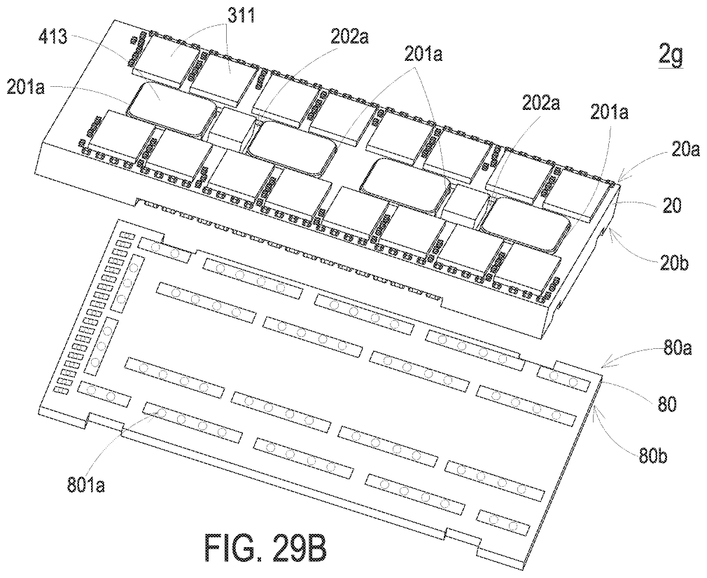

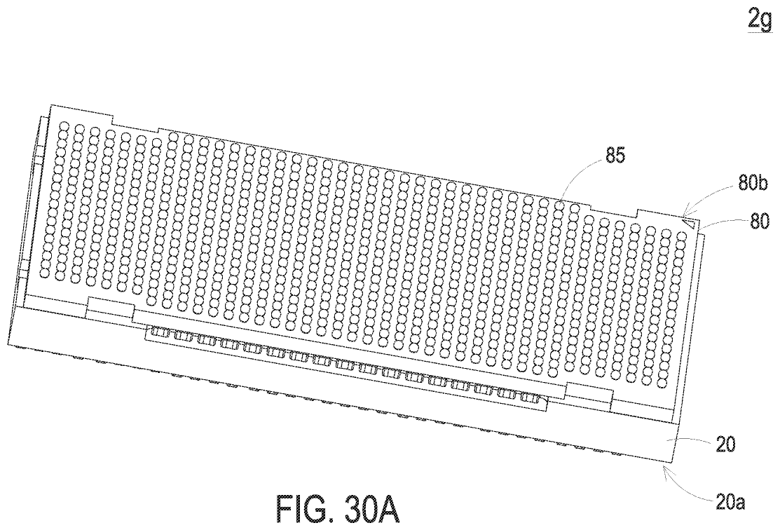

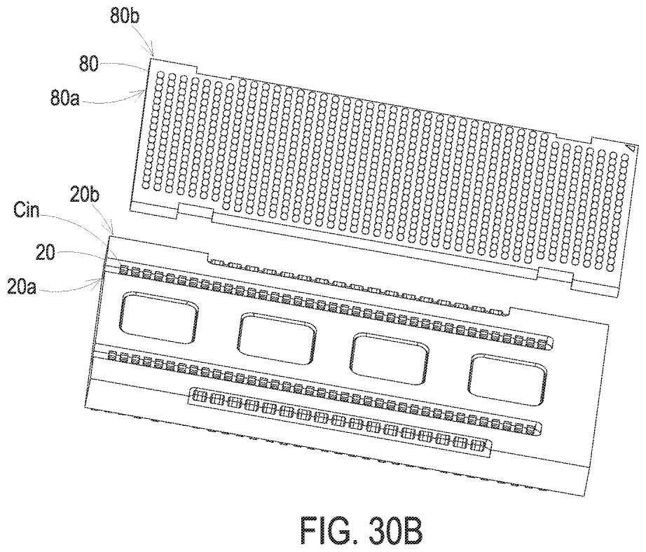

FIG. 29A is a schematic structure view illustrating a magnetic device of a power conversion module according to a thirteenth embodiment of the present disclosure. FIG. 29B is a schematic exploded view illustrating the power conversion module as shown in FIG. 29A. FIG. 30A is a schematic structure view illustrating the power conversion module as shown in FIG. 29A from another perspective. FIG. 30B is a schematic exploded view illustrating the power conversion module as shown in FIG. 30A. The power conversion module 2g of this embodiment is similar to the power conversion module 2f as shown in FIG. 23. In comparison with the power conversion module 2f as shown in FIGS. 22 and 23 having the first external inductor 45a and the second external inductor 45a disposed in the corresponding third concave regions 201b on the second surface 20b of the circuit board 20 respectively, the power conversion module 2g of this embodiment includes a first external inductor 45a and a second external inductor 45a disposed on the first surface 20a of the circuit board 20. In this embodiment, the first surface 20a of the circuit board 20 includes a plurality of fourth concave regions 201a and a plurality of fifth concave regions 202a. Each of the plurality of fourth concave regions 201a is concavely formed from the first surface 20a of the circuit board 20, and the plurality of fourth concave regions 201a are arranged in sequence for accommodating the corresponding magnetic element, respectively. Consequently, the first magnetic element 41, the second magnetic element 42, the third magnetic element 41 and the fourth magnetic element 42 are arranged in sequence. Each of the plurality of fifth concave regions 202a is concavely formed from the first surface 20a of the circuit board 20. Each of the plurality of fifth concave regions 202a is disposed between and in communication with the adjacent two fourth concave regions 201a for accommodating the corresponding external inductor 45a. In this embodiment, the first surface 20a of the circuit board 20 includes four fourth concave regions 201a and two fifth concave regions 202a. One of the two fifth concave regions 202a is disposed between two adjacent fourth concave regions 201a of the four fourth concave regions 201a, and the other of the two fifth concave regions 202a is disposed between the other two adjacent fourth concave regions 201a of the four fourth concave regions 201a. Consequently, the first external inductor 45a disposed in one of the two fifth concave regions 202a is disposed between the first magnetic element 41 and the second magnetic element 42, and the second external inductor 45a disposed in the other of the two fifth concave regions 202a is disposed between the third magnetic element 41 and the fourth magnetic element 42. In this embodiment, the external inductor 45a is exposed to the first surface 20a of the circuit board 20. Portion of the external inductor 45a is embedded in the fifth concave regions 202a, and the other portion of the external inductor 45a is protruded from the first surface 20a of the circuit board 20. The height of the external inductor 45a protruding from the first surface 20a of the circuit board 20 is less than or equal to the height of the corresponding magnetic elements 41, 42 protruding from the first surface 20a of the circuit board 20. The advantage is that the external inductor 45a can dissipate heat to the external metal substrate through the externally added thermally conductive material. Consequently, the operating temperature of the external inductor 45a is reduced.

In this embodiment, each magnetic element 41, 42 includes five magnetic legs, and the second winding 45 and the external inductor 45a form a closed loop. Therefore, while the magnetic element is equivalent to the load dynamics, the output inductance of each phase buck power circuit including the magnetic elements is low. Therefore, the first surface 80a of the adapter board 80 of the power conversion module 2g of this embodiment may not have any components thereon (e.g., output capacitor Cout or a plurality of pins as shown in FIG. 22, wherein the plurality of pins include a plurality of positive input terminal pins 81, a plurality of positive output terminal pins 82, a plurality of negative output terminal pins 83 and a plurality of signal pins 84). As shown in FIG. 29B, the power conversion module 2g continue to maintain a small output voltage fluctuation range when the load is subjected to the dynamic conversion. The advantages of having no components on the first surface 80a of the adapter board 80 is that the height of the power conversion module 2g is greatly reduced, the thinning of the power conversion module 2g is achieved, and the application scenarios of the power conversion module 2g are greatly expanded. In this embodiment, since the first surface 80a of the adapter board 80 of the power conversion module 2g of this embodiment has no components thereon, the following two ways can be used to fix and electrically connect the adapter board 80 and the circuit board 20. The first method is to directly solder the second surface 20b of the circuit board 20 to the first surface 80a of the adapter board 80. The second method is to fix and electrically connect the circuit board 20 and the adapter board 80 by means of PCB pressing, drilling, and electroplating. The second method is described in detail as below.

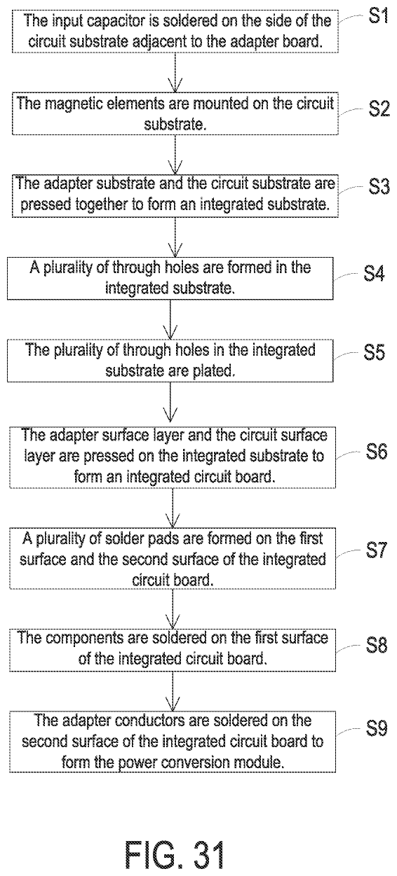

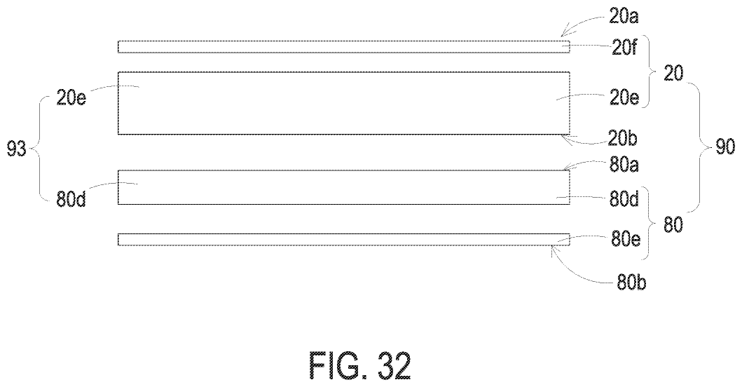

Please refer to FIGS. 31 and 32 in conjunction with FIGS. 29A, 29B, 30A and 30B. FIG. 31 is a flow chart illustrating the process of manufacturing the power conversion module as shown in FIG. 29A. FIG. 32 is a schematic side view illustrating the power conversion module as shown in FIG. 29A before the circuit board and the adapter board are soldered. As shown in FIG. 32, the circuit board 20 and the adapter board 80 corporately form an integrated circuit board 90. The adapter board 80 includes an adapter substrate 80d and an adapter surface layer 80e. One side of the adapter substrate 80d adjacent to one side of the circuit board 20 forms the first surface 80a of the adapter board 80. One side of the adapter surface layer 80e far from the side of the circuit board 20 forms the second surface 80b of the adapter board 80 (i.e., the second surface of the integrated circuit board). The circuit board 20 includes a circuit substrate 20e and a circuit surface layer 20f. One side of circuit substrate 20e adjacent to one side of the adapter board 80 forms the second surface 20b of the circuit board 20. One side of the circuit surface layer 20f far from the side of the circuit board 20 forms the first surface 20a of the circuit board 20 (i.e., the first surface of the integrated circuit board).

Please refer to FIG. 31. Firstly, in the step S1, the input capacitor Cin is soldered on the side of the circuit substrate 20e adjacent to the adapter board 80 (i.e., the second surface 20b of the circuit board 20). Then, in the step S2, the magnetic elements 41, 42 are mounted on the circuit substrate 20e. Then, in the step S3, the adapter substrate 80d and the circuit substrate 20e are pressed together. For example, the adapter board 80d and the circuit substrate 20e are pressed together through prepreg, so that the mechanical connection between the adapter substate 80d and the circuit substrate 20e is achieved to form an integrated substrate 93. Then, in the step S4, a plurality of through holes 801a are formed in the integrated substrate 93. The plurality of through holes 801a are formed in the integrated substrate 93 by means of drilling. Then, in the step S5, the plurality of through holes 801a in the integrated substrate 93 are plated, so that the electrical connection between the adapter substrate 80d and the circuit substrate 20e is achieved. The specific features are shown in FIG. 29B. The first surface 80a of the adapter board 80 of the power conversion module 2g has a plurality of through hole 801a. The disposing positions of the plurality of through holes 801a are corresponding to the positions of the plurality of pins as shown in FIG. 22, wherein the plurality of pins include a plurality of positive input terminal pins 81, a plurality of positive output terminal pins 82, a plurality of negative output terminal pins 83 and a plurality of signal pins 84. FIG. 29B only schematically shows the positions, diameters and quality of the plurality of through holes 801a, and the actual positions, diameters and quantity of the plurality of through hole 801a are not limited to those as shown in FIG. 29B and may be varied according to the practical requirements. In some other embodiments, the disposing positions of the plurality of through holes 801a are varied according to the positions of the plurality of pins. Then, in the step S6, the adapter surface layer 80e and the circuit surface layer 20f are pressed on the integrated substrate 93 to form an integrated circuit board 90. The integrated substrate 93 is disposed between the adapter surface layer 80e and the circuit surface layer 20f. Then, in the step S7, a plurality of solder pads are formed on the first surface and the second surface of the integrated circuit board 90. Then, in the step S8, the components are soldered on the first surface of the integrated circuit board 90. Then, in the step S9, the adapter conductors 85 are soldered on the second surface of the integrated circuit board 90 to form the power conversion module 2g as shown in FIG. 29A. By using this packaging connection method of the power conversion module 2g, the integration of the integrated circuit board 90 is achieved, and the twice-welding electrical connection method between the adapter board 80 and the circuit board 20 is eliminated. The twice-welding electrical connection method has some issues as below. When the new solder joints are electrically connected through reflow soldering, the welded solder joints are remelted, which may result in potential hidden dangers of failure of the welded solder joints. The integrated circuit board 90 greatly improves the reliability of the electrical connection of the package of the power conversion module 2g, and further improves the reliability of the product when the power conversion module 2g is reflow soldered on the system board.

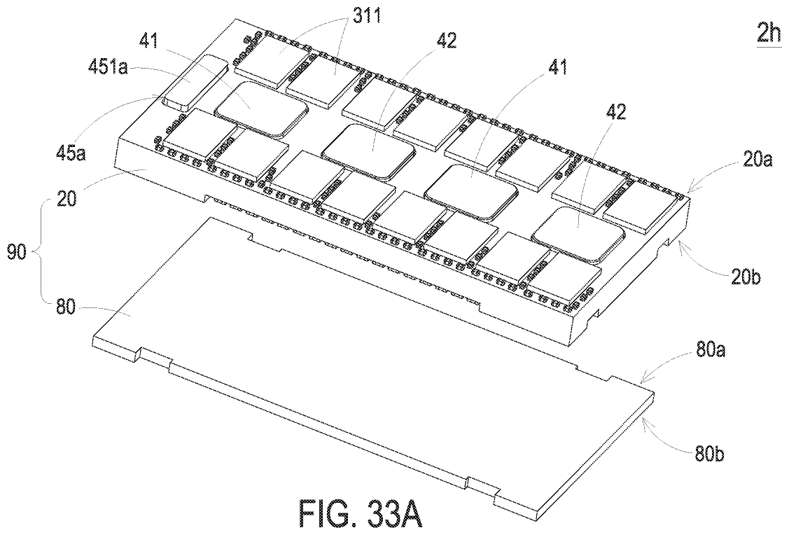

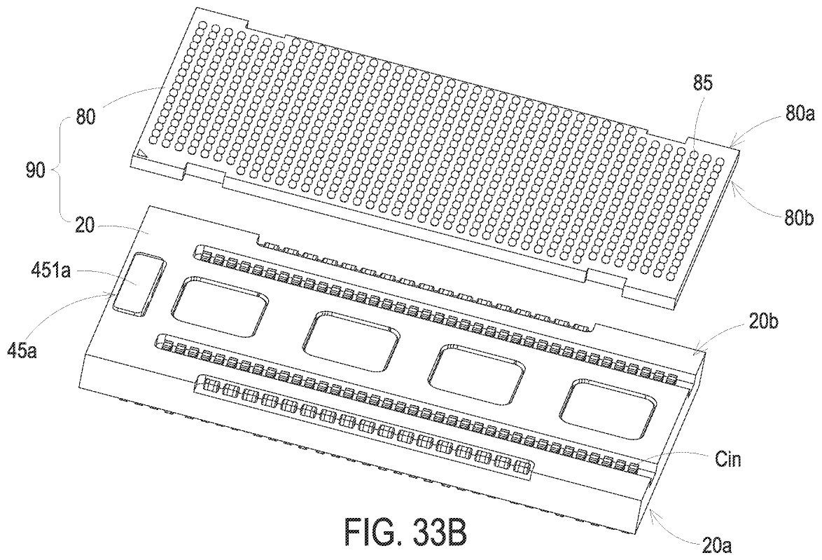

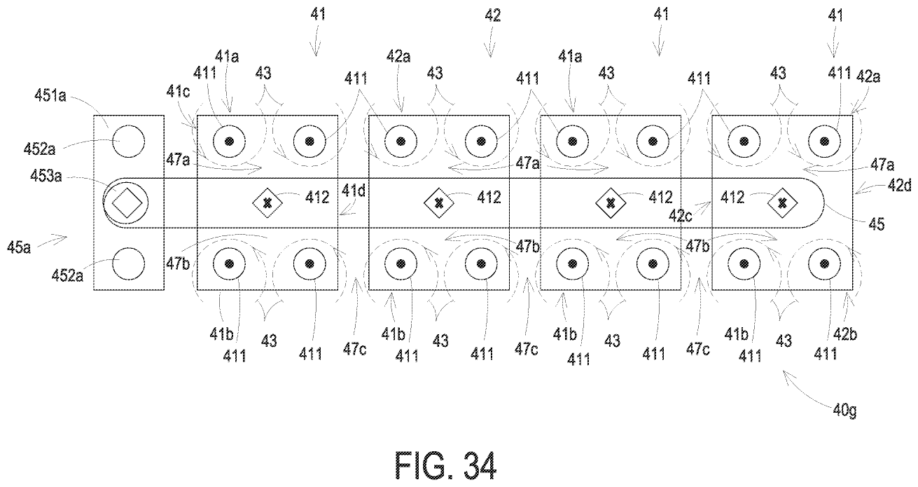

Please refer to FIGS. 33A, 33B and 34. FIG. 33A is a schematic exploded view illustrating a power conversion module according to a fourteenth embodiment of the present disclosure. FIG. 33B is a schematic exploded view illustrating the power conversion module as shown in FIG. 33A from another perspective. FIG. 34 is a schematic structure view illustrating the magnetic device of the power conversion module as shown in FIG. 33A. The power conversion module 2h of this embodiment is similar to the power conversion module 2g as shown in FIG. 29A. In comparison with the power conversion module 2g as shown in FIG. 29A including two external inductors, the power conversion module 2h of this embodiment includes single external inductor 45a disposed on one side of the first magnetic element 41 far away from the second magnetic element 42. The external inductor 45a of this embodiment includes two external inductor magnetic covers 451a, two external inductor lateral legs 452a, an external inductor middle leg 453a and portion of the second winding 45. As shown in FIGS. 33A and 33B, two external inductor magnetic covers 451a are disposed on the first surface 20a and the second surface 20b of the circuit board 20, respectively. The two external inductor lateral legs 452a run through the circuit board 20 and are connected between the two external inductor magnetic covers 451a, respectively. The external inductor middle leg 453a runs through the circuit board 20, and is connected between the two external inductor magnetic covers 451a and disposed between the two external inductor lateral legs 452a. As shown in FIG. 34, the second winding 45 is wound around the external inductor middle leg 453a for at least one turn, e.g., two turns. The winding method of the second winding 45 is similar to the above-mentioned various winding methods, and is not redundantly described hereinafter. In this embodiment, the external inductor 45a is exposed to the first surface 20a of the circuit board 20. The heat can be dissipated to the external metal substrate through the additionally thermally conductive medium material, so that the operating temperature of the external inductor 45a is reduced. In addition, the winding of the external inductor 45a is a portion of the second winding 45. The solder joint connection between the external inductor 45a and the second winding 45 is eliminated, so that the conduction loss of the solder joint is eliminated. Consequently, it not only greatly improves the efficiency performance of the power conversion module 2h, but also greatly reduces the complexity of the assembly process of the power conversion module 2h.

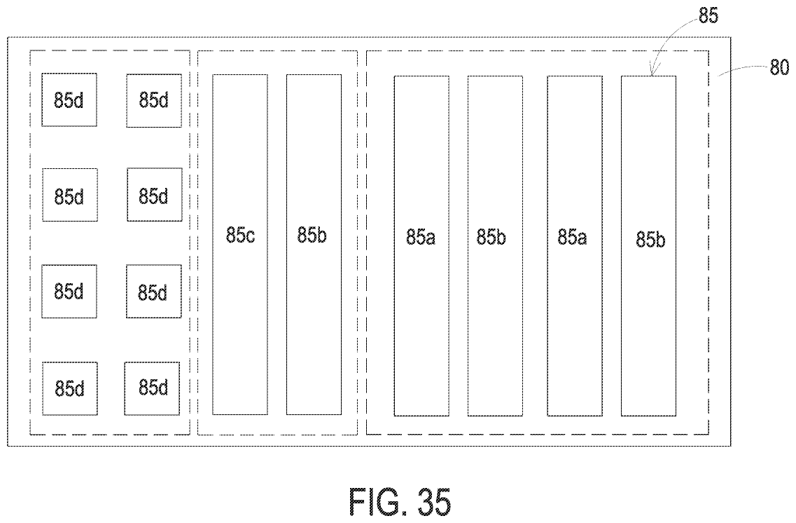

The adapter conductors 85 in all above embodiments are pins of other array package (Grid Array) structure, and are not limited to the pins of Ball Grid Array (BGA) package structure. In the embodiment shown in FIG. 35, all adapter conductors 85 are pins of land grid array (LGA) package structure. By using the LGA package structure to replace the BGA package structure, the height of the BGA package structure is reduced, so that the overall height of the power conversion module is further reduced to facilitate further thinning of the power conversion module.

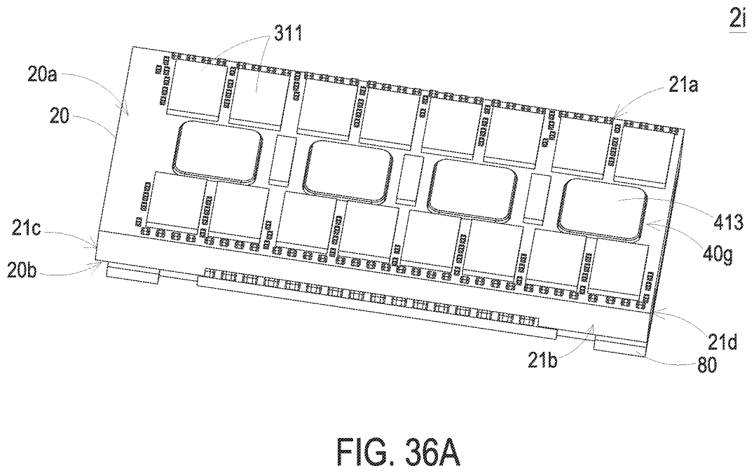

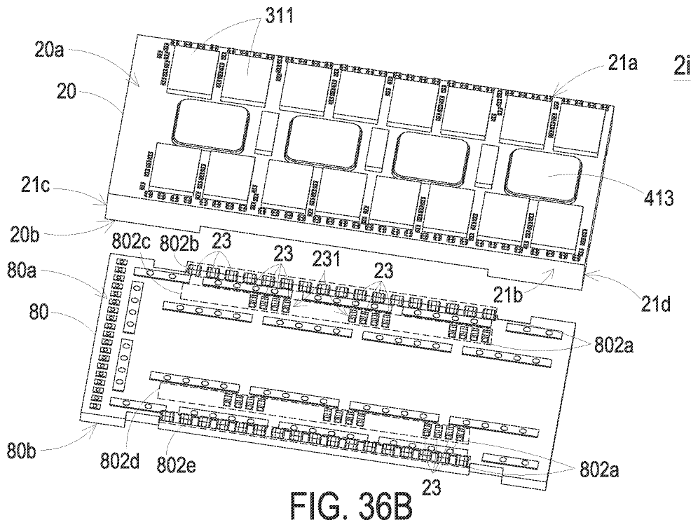

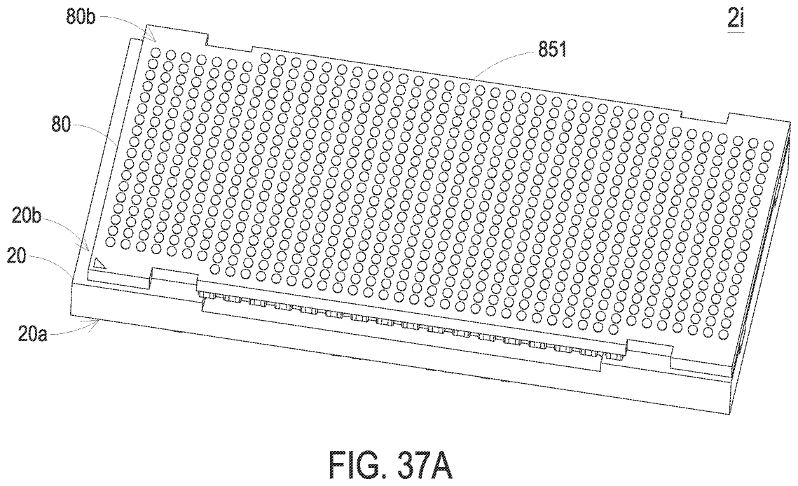

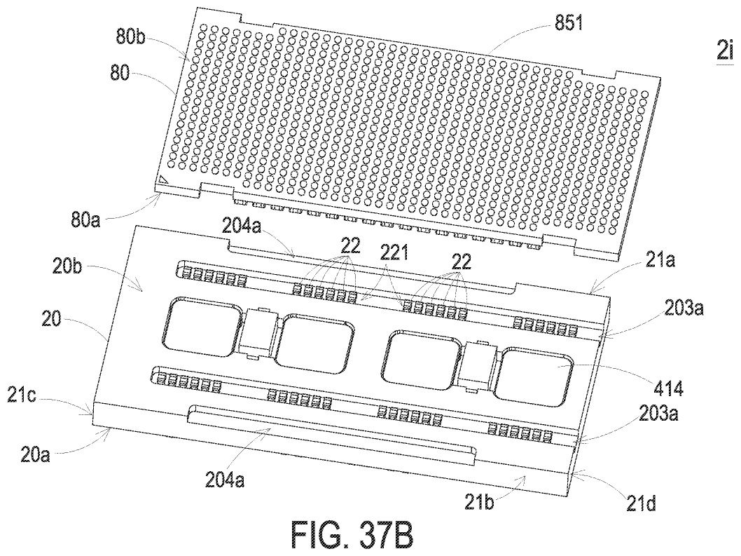

Please refer to FIGS. 36A, 36B, 37A and 37B. FIG. 36A is a schematic structure view illustrating a power conversion module according to a fifteenth embodiment of the present disclosure. FIG. 36B is a schematic exploded view illustrating the power conversion module as shown in FIG. 36A. FIG. 37A is a schematic structure view illustrating the power conversion module as shown in FIG. 36A from another perspective. FIG. 37B is a schematic exploded view illustrating the power conversion module as shown in FIG. 37A. As shown in FIGS. 36A, 36B, 37A and 37B, the power conversion module 2i includes a circuit board 20, an adapter board 80, at least one first component 22 and at least one second component 23. The circuit board 20 has a first surface 20a, a second surface 20b, a first sidewall 21a, a second sidewall 21b, a third sidewall 21c and a fourth sidewall 21d. The first surface 20a and the second surface 20b of the circuit board 20 are opposed to each other. The first sidewall 21a, the second sidewall 21b, the third sidewall 21c and the fourth sidewall 20d are disposed between the first surface 20a and the second surface 20b. The first sidewall 21a and the second sidewall 21b are opposed to each other, and the third sidewall 21c and the fourth sidewall 21d are opposed to each other and disposed between the first sidewall 21a and the second sidewall 21b. The second surface 20b of the circuit board 20 includes at least one concave region. The number of the concave region is one or more than one. As shown in FIG. 37B, the circuit board 20 includes a plurality of sixth concave regions 203a (e.g., two sixth concave regions) and a plurality of seventh concave regions 204a (e.g., two seventh concave regions). The plurality of sixth concave regions 203a are concavely formed from the second surface 20b of the circuit board 20. Each of the plurality of sixth concave regions 203a is partially exposed to the fourth sidewall 21d of the circuit board 20. Each of the plurality of sixth concave regions 203a is extended along a direction as same as a direction from the third sidewall 21c to the fourth sidewall 21d of the circuit board 20. In some other embodiments, the plurality of sixth concave regions 203a are concavely formed from the second surface 20b of the circuit board 20. Each of the plurality of sixth concave regions 203a is not exposed to the any sidewall of the circuit board 20. Portion of the plurality of seventh concave regions 204a are disposed on an intersection between the second surface 20b and the first sidewall 21a of the circuit board 20, and each of the plurality of seventh concave regions 204a is concavely formed from the second surface 20b and the first sidewall 21a of the circuit board 20. As shown in FIG. 37B, one of the plurality of seventh concave regions 204a is disposed on an intersection between the second surface 20b and the first sidewall 21a of the circuit board 20, and each of the plurality of seventh concave regions 204a is concavely formed from the second surface 20b and the first sidewall 21a of the circuit board 20. The other portion of the plurality of seventh concave regions 204a are disposed on an intersection between the second surface 20b and the second sidewall 21b of the circuit board 20, and each of the plurality of seventh concave regions 204a is concavely formed from the second surface 20b and the second sidewall 21b of the circuit board 20. As shown in FIG. 37B, the other of the plurality of seventh concave regions 204a is disposed on an intersection between the second surface 20b and the second sidewall 21b of the circuit board 20, and each of the plurality of seventh concave regions 204a is concavely formed from the second surface 20b and the second sidewall 21b of the circuit board 20. Each of the plurality of seventh concave regions 204a is extended along a direction as same as the direction from the third sidewall 21c to the fourth sidewall of the circuit board 20.

The adapter board 80 includes the first surface 80a and the second surface 80b. The first surface 80a and the second surface 80b of the adapter board 80 are opposed to each other. The first surface 80a of the adapter board 80 is attached to the second surface 20b of the circuit board 20. The first surface 80a of the adapter board 80 includes at least one component disposing region 802a having a conductive function. Each component disposing region 802a is electrically connected to the electric trace in the adapter board 80. As shown in FIG. 36B, the first surface 80a of the adapter board 80 includes a plurality of component disposing regions 802a. The plurality of component disposing regions 802a are arranged in sequence in a manner of a plurality of arrangement rows, e.g., four arrangements rows including a first arrangement row 802b, a second arrangement row 802c, a third arrangement row 802d and a fourth arrangement row 802e as shown in FIG. 36B. The arrangement direction of the first arrangement row 802b, the second arrangement row 802c, the third arrangement row 802d and the fourth arrangement row 802e is as same as the direction from the first sidewall 21a to the second sidewall 21b of the circuit board 20. The plurality of component disposing regions 802a of each of the arrangement rows are extended along a direction as same as the direction form the third sidewall 21c to the fourth sidewall 21d of the circuit board 20. While the first surface 80a of the adapter board 80 is attached to the second surface 20b of the circuit board 20, the disposing positions of the plurality of component disposing regions 802a in the first arrangement row 802b are corresponding to the disposing position of one of the two seventh concave regions 204a, and the disposing positions of the plurality of component disposing regions 802a in the fourth arrangement row 802e are corresponding to the disposing position of the other of the two seventh concave regions 204a. The disposing positions of the plurality of component disposing regions 802a in the second arrangement row 802c are corresponding to the disposing position of one of the two sixth concave regions 203a, and the disposing positions of the plurality of component disposing regions 802a in the third arrangement row 802d are corresponding to the disposing position of the other of the two sixth concave regions 203a.

The at least one first component 22 includes but not limited to an input capacitor disposed in the sixth concave region 203a of the circuit board 20. In some embodiments, the bottom of the sixth concave region 203a further includes a plurality of solder pads (not shown). Each of the at least one first component 22 is electrically connected to the electric trace in the circuit board 20 through the solder pads. The height of each of the at least one first component 22 is less than or equal to the depth of the sixth concave region 203a, so that each of the at least one first component 22 is not protruded from the second surface 20b of the circuit board 20.

The at least one second component 23 includes but not limited to an input capacitor disposed in the corresponding component disposing region 802a of the adapter board 80. Each of the at least one second component 23 is electrically connected to the electric trace in the adapter board 80 through the corresponding component disposing region 802a. While the first surface 80a of the adapter board 80 is attached to the second surface 20b of the circuit board 20, the second components 23 disposed in the component disposing regions 802a in the first arrangement row and the fourth arrangement row are accommodated in the corresponding seventh concave regions 204a. The second components 23 disposed in the component disposing regions 802a in the second arrangement row and the third arrangement row are accommodated in the corresponding sixth concave regions 203a. The height of each of the second components 23 accommodated in the sixth concave region 203a is less than or equal to the depth of the sixth concave region 203a. The height of each of the second components 23 accommodated in the seventh concave region 204a is less than or equal to the depth of the seventh concave region 204a. In some embodiments, the first component 22 and the second component 23 include switch or magnetic device, respectively.

In this embodiment, the power conversion module includes a plurality of first components 22 for example X first components 22. The X first components 22 are divided into P first component integrations 221 according to the disposing positions. Each of the first component integrations 221 includes portion of the plurality of first components 22. As shown in FIG. 37B, each of the first component integrations 221 includes six first components 22. The power conversion module includes a plurality of second components 23 for example Y second components 23. The Y second components 23 are divided into Q second component integrations 231 according to the disposing positions. Each of the second component integrations 231 includes portion of the plurality of second components 23. As shown in FIG. 36B, each of the second component integrations 231 includes four second components 23. The P first component integrations 221 and the Q second component integrations 231 are disposed in the sixth concave regions 203a in a staggered arrangement. X, Y, P and Q are all positive integer, respectively, and X, Y are greater than 1. In addition, when there are a plurality of first component integrations 221 (i.e., P is a positive integer greater than 1), the plurality of first component integrations 221 are spaced apart from each other. The six first components 22 of each of the first component integrations 221 are arranged in sequence. The six first components 22 of each of the first component integrations 221 are disposed along a direction as same as the direction form the third sidewall 21c to the fourth sidewall 21d of the circuit board 20. When there are a plurality of second component integrations 231 (i.e., Q is a positive integer greater than 1), the plurality of second component integrations 231 are spaced apart from each other. The four second components 23 of each of the second component integrations 231 are arranged in sequence. The four first components 23 of each of the second component integrations 231 are disposed along a direction as same as a direction form the third sidewall 21c to the fourth sidewall 21d of the circuit board 20.

Furthermore, each of the first component integrations 221 only includes a single first component 22, and each of the second component integrations 231 only includes a single second component 23. Under this circumstance, the plurality of first components 22 and the plurality of second components 23 are disposed in the sixth concave region 203a in a staggered arrangement. Since the plurality of first components 22 and the plurality of second components 23 are disposed in the sixth concave region 203a in a staggered arrangement by means of an integrated approach or a stand-along form, the depth of the sixth concave regions 203a is greater than the height of one of the first component 22 and the second component 23. Consequently, the height of the power conversion module 2i is low, and the size of the overall power conversion module 2i is reduced.

In this embodiment, the power conversion module 2i further includes a plurality of magnetic devices 40g. Each of the plurality of magnetic device 40g includes a first magnetic cover 413, a second magnetic cover 414, a middle leg and four lateral legs. The first magnetic cover 413 and the second magnetic cover 414 are disposed on the first surface 20a and the second surface 20b of the circuit board 20. The middle leg and the corresponding four lateral legs are disposed between the corresponding first magnetic cover 413 and the corresponding second magnetic cover 414. The middle leg and the corresponding four lateral legs run through the circuit board 20. One side of the second magnetic cover 414 of each of the magnetic device 40g adjacent to the first sidewall 21a is adjacent to the corresponding first component integration 221. The other side of the second magnetic cover 414 of each of the magnetic device 40g adjacent to the second sidewall 21b is adjacent to the other first component integration 221. The magnetic device 40g of this embodiment is similar to the magnetic device of the above embodiments. The disposing positions of the middle leg and the four lateral legs of the magnetic device 40g are similar to those of the above embodiments (e.g., the disposing positions of the middle leg and the four lateral legs of the magnetic device as shown in FIG. 3B.). Although it is not shown in FIGS. 36A, 36B, 37A and 37B, it is obvious that the disposing positions of the middle leg and the four lateral legs of the magnetic device 40g of this embodiment is clearly understood.

The power conversion module 2i further includes a plurality of switch units 311 disposed on the first surface 20a of the circuit board 20. One side of the first magnetic cover 413 of each magnetic device 40g adjacent to the first sidewall 21a is adjacent to the corresponding switch unit 311. One side of the first magnetic cover 413 of each magnetic device 40g adjacent to the second sidewall 21b is adjacent to another corresponding switch unit 311. The disposing position of the switch unit 311 adjacent to the first magnetic cover 413 of the magnetic device 40g and the disposing position of the corresponding first component integration 221 are disposed on two opposed surfaces of the circuit board 20, and the switch unit 311 adjacent to the first magnetic cover 413 of the magnetic device 40g and the corresponding first component integration 211 are electrically connected through the electric trace in the circuit board 20. Therefore, the connection path between the first component integrations 221 constituting the input capacitor Cin and the switch unit 311 is shorter, and the loop inductance between the first component integration 221 constituting the input capacitor Cin and the switch unit 311 is reduced. Consequently, the switching loss of the switch unit 311 is reduced and the efficiency of the overall power conversion module 2i is improved.

Please refer to FIGS. 37A and 37B. The power conversion module 2i of this embodiment further includes at least one first adapter conductor 851 disposed on the second surface 80b of the adapter board 80. While the second surface 80b of the adapter board 80 is disposed on the system board (not shown), the at least one first adapter conductor 851 is connected between the second surface 80b of the adapter board 80 and the system board. The at least one first adapter conductor 851 is electrically connected with the central processing unit of the system board by means of passing through the perforation of the system board. In some embodiments, the at least one first adapter conductor 851 is pin of ball grid array (BGA) package structure. Since the power conversion module 2i is connected to the central processing unit by using the first adapter conductor 851 of the adapter board 80, it is very simple, the parasitic impedance on the system board is low, and the conduction loss is small. Consequently, the power conversion module 2i of this embodiment has a higher power supply efficiency for the central processing unit. In addition, the at least one second component 23 is disposed in the corresponding component disposing region 802a disposed on the first surface 80a of the adapter board 80. Each of the at least one second component 23 is electrically connected with the first adapter conductor 851 through the corresponding component disposing region 802a and the electric trace in the adapter board 80. Consequently, the connection path between the at least one second component 23 and the at least one first adapter conductor 851 is shorter, and the loop inductance between the at least one second component 23 and the at least one first adapter conductor 851 is reduced. The dynamic performance of the overall power conversion module 2i is improved. Certainly, the component arrangement in the power conversion module 2i of this embodiment can also be applied to the aforementioned various embodiments, and are not redundantly described thereinafter.

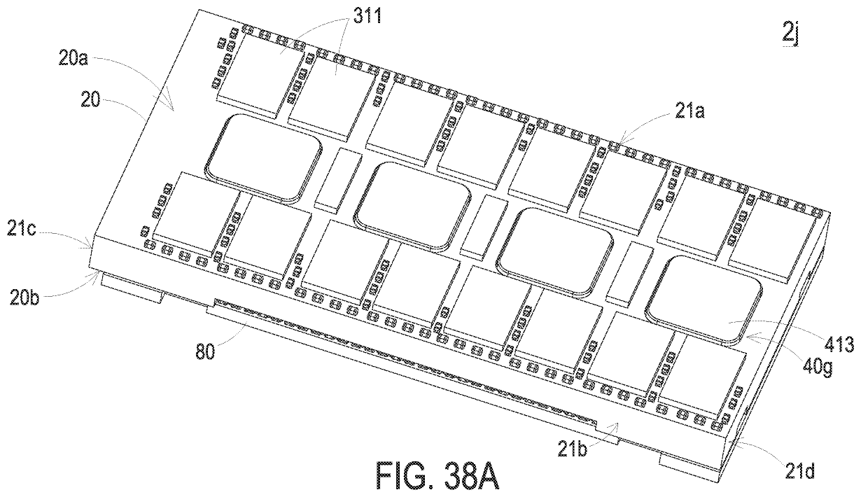

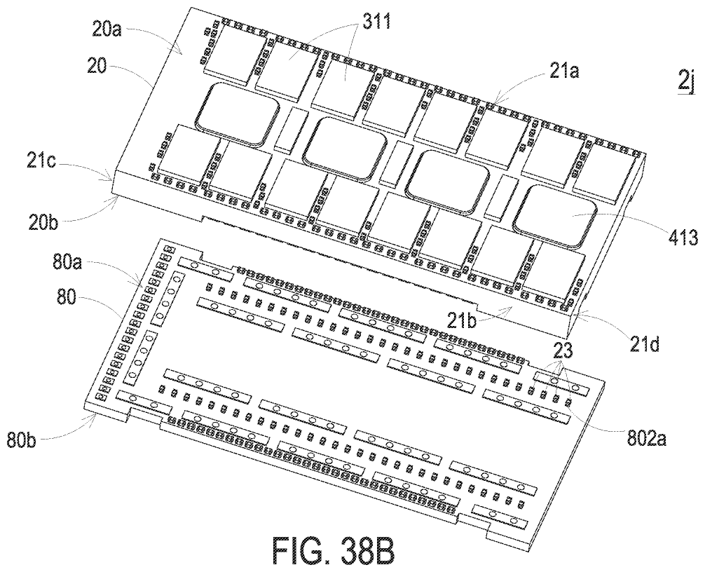

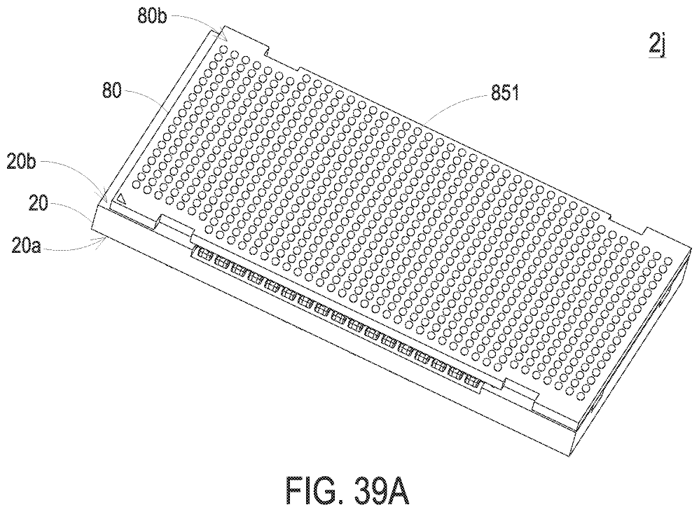

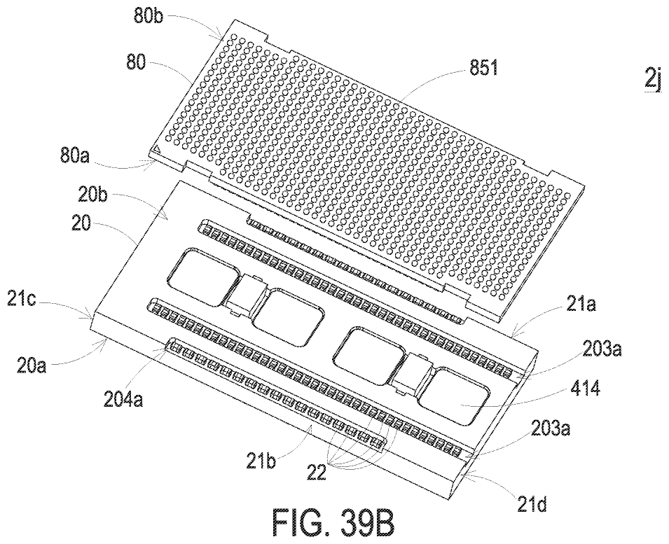

Please refer to FIGS. 38A, 38B, 39A and 39B. FIG. 38A is a schematic structure view illustrating a power conversion module according to a sixteenth embodiment of the present disclosure. FIG. 38B is a schematic exploded view illustrating the power conversion module as shown in FIG. 38A. FIG. 39A is a schematic structure view illustrating the power conversion module as shown in FIG. 38A from another perspective. FIG. 39B is a schematic exploded view illustrating the power conversion module as shown in FIG. 39A. The power conversion module 2j of this embodiment is similar to the power conversion module 2i as shown in FIGS. 37A and 37B. In comparison with the power conversion module 2i as shown in FIGS. 37A and 37B including a plurality of first components 22 and a plurality of second components 23 divided into component integrations to be disposed, the power conversion module 2j of this embodiment includes a plurality of first components 22 and a plurality of second components 23. The plurality of first components 22 are disposed in the sixth concave region 203 of the circuit board 20 and spaced apart from each other, and the plurality of second components 23 are disposed in the component disposing region 802a of the adapter board 80 and spaced apart from each other. While the second surface 20b of the circuit board 20 is attached to the first surface 80a of the adapter board 80, each of the at least one first component 22 is stacked with the corresponding second component 23, and each of the at least one first component 22 and the corresponding second component 23 are accommodated in the corresponding sixth concave region 203a or the corresponding seventh concave region 204a of the circuit board 20. The sum of the height of each first component 22 and the height of the corresponding second component 23 that are accommodated in the sixth concave region 203a of the circuit board 20 and stacked on each other is less than or equal to the depth of the sixth concave region 203a. The sum of the height of each first component 22 and the height of the corresponding second component 23 that are accommodated in the seventh concave region 204a of the circuit board 20 and stacked on each other is less than or equal to the depth of the seventh concave region 204a. Certainly, the component arrangement in the power conversion module 2i of this embodiment can also be applied to the aforementioned various embodiments, and are not redundantly described hereinafter. In some other embodiments, the shapes and disposing positions of the sixth concave regions 203a and the seventh concave regions 204a of the circuit board 20 and the component disposing regions 802a of the adapter board 80 are varied according to the practical requirements.

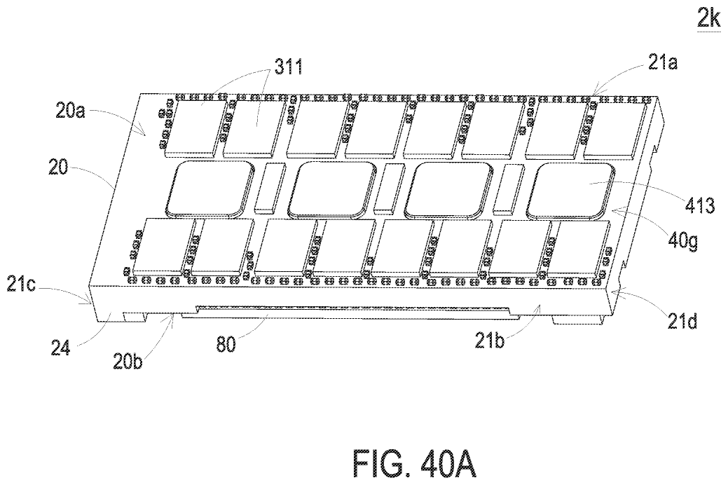

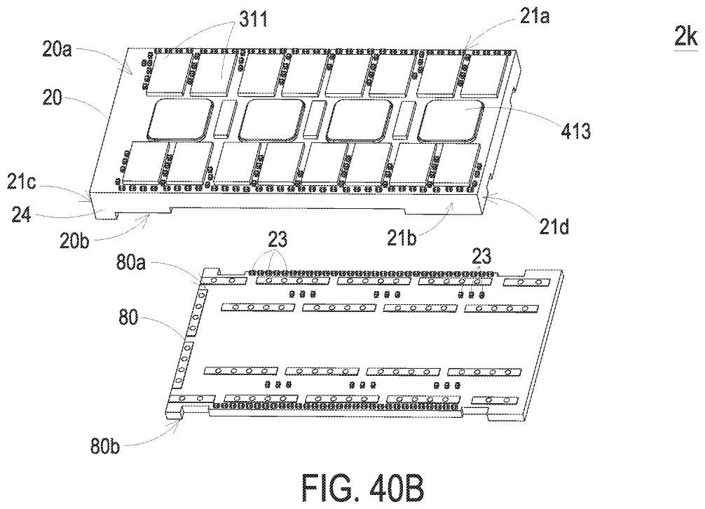

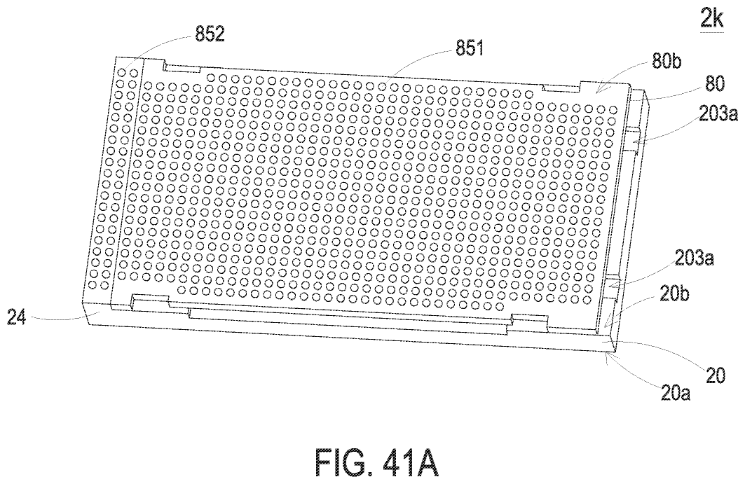

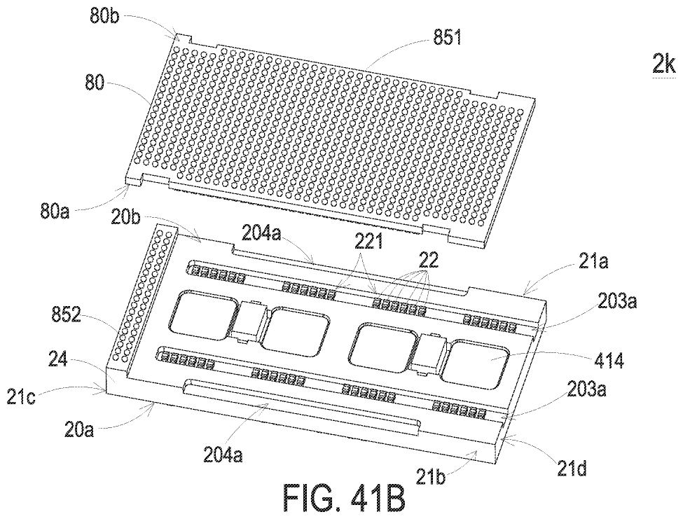

Please refer to FIGS. 40A, 40B, 41A and 41B. FIG. 40A is a schematic structure view illustrating a power conversion module according to a seventeenth embodiment of the present disclosure. FIG. 40B is a schematic exploded view illustrating the power conversion module as shown in FIG. 40A. FIG. 41A is a schematic structure view illustrating the power conversion module as shown in FIG. 40A and from another perspective. FIG. 41B is a schematic exploded view illustrating the power conversion module as shown in FIG. 41A. The power conversion module 2k is similar to the power conversion module 2i as shown in FIGS. 37A and 37B. The power conversion module 2k of this embodiment further includes a protrusion part 24 and at least one second adapter conductor 852. The protrusion part 24 is protruded from the second surface 20b of the circuit board 20 along the third sidewall 21c of the circuit board 20. The height of the protrusion part 24 is equal to the thickness of the adapter board 80. While the first surface 80a of the adapter board 80 is disposed on the second surface 20b of the circuit board 20, the top surface of the protrusion part 24 and the second surface 80b of the adapter board 80 are coplanar.

In this embodiment, the at least one second adapter conductor 852 of the power conversion module 2k is disposed on the top surface of the protrusion part 24. For example, in this embodiment, the at least one second adapter conductor 852 is corresponding to the signal adapter conductor 85d as shown in FIG. 35 and is electrically connected to the signal adapter conductor 85d through the electric trace in the adapter board 80. The at least one second adapter conductor 852 enables the second surface 20b of the circuit board 20 to be disposed on the system board (not shown) through the at least one second adapter conductor 852. The circuit board 20 and the adapter board 80 of the power conversion module 2k of this embodiment only need a small number of pins to be welded, so that the connection between the circuit board 20 and the adapter board 80 can be achieved. Consequently, the problems of soldering failure caused by the possible bending of the connection between the circuit board 20 and the adapter board 80 are avoided. The production yield and reliability of the power conversion module 2k are improved greatly. Certainly, the arrangement of the protrusion part 24 in this embodiment can also be applied to the aforementioned various embodiments, and is not redundantly described hereinafter.

From the above descriptions, the present disclosure provides the magnetic device and the power conversion module. The first winding is wound around a corresponding one of the 2N lateral legs, and the second windings is wound around all of the M middle legs to form a closed loop. When the load driven by the electronic device with the power conversion module is subjected to the dynamic conversion and switched from the heavy load condition to the light load condition, the output voltage from the power conversion module possibly overshoots. For solving the overshoot problem, the response of the control unit of the power conversion module allows the duty cycles of all PWM control signals to be zero. The lower switch of each switch unit is turned on. Consequently, the inductor which is defined by the first winding and the corresponding lateral leg withstands the output voltage. Moreover, a high voltage is coupled by the second winding and applied to the wiring structure of the second winding. Consequently, the magnitude of the current flowing through the second winding is largely increased, and the magnitude of the current flowing through the first winding is largely reduced. Consequently, the overshoot of the output voltage is largely suppressed. In other words, the overshoot of the output voltage during the dynamic conversion of the load can be effectively reduced. The power conversion module is capable of reducing the fluctuation range of the output voltage without the need of increasing the number of the output capacitors. Consequently, the cost and the volume of the power conversion module are reduced. In addition, the second surface of the circuit board includes a concave region for accommodating the first component, and the first surface of the adapter board includes a component disposing region for accommodating the second component. While the first surface of the adapter board is attached to the second surface of the circuit board, the second component is accommodated in the corresponding concave region, so that the loop inductance in the power conversion module is reduced and the thickness of the power conversion module is reduced. Consequently, the performance of the power conversion module is enhanced, and the volume of the power conversion module is reduced,

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A magnetic device, comprising:
M middle legs;
2N lateral legs arranged around the M middle legs, wherein M and N are integers greater than 1;
2N first windings wound around the 2N lateral legs, respectively, wherein each of the 2N first windings is wound around the corresponding lateral leg for at least one turn; and
a second winding wound around the M middle legs, and formed as a closed loop, wherein the second winding is wound around each of the M middle legs for at least one turn.

2. The magnetic device according to claim 1, wherein the second winding is electrically connected with an external inductor or a parasitic inductor.

3. The magnetic device according to claim 1, wherein at least portions of the second winding wound around the M middle legs are connected in serial.

4. The magnetic device according to claim 1, wherein at least portions of the second winding wound around the M middle legs are connected in parallel.

5. The magnetic device according to claim 1, wherein directions of DC currents flowing through the 2N first windings are identical.

6. The magnetic device according to claim 1, wherein at least two lateral legs of the 2N lateral legs and at least two first windings of the 2N first windings wound around the at least two lateral legs are located on a first side of the M middle legs, and the other lateral legs of the 2N lateral legs and the other first windings of the 2N first windings wound around the other lateral legs are located on a second side of the M middle legs.

7. The magnetic device according to claim 6, wherein the magnetic device further comprises W magnetic cover pairs, and each pair of the W magnetic cover pairs, at least one middle leg of the M middle legs and at least two lateral legs of the 2N lateral legs are collaboratively formed as one magnetic element, wherein a phase different between a voltage signal of the first winding wound around the lateral legs on the first side of the M middle legs and a voltage signal of the first winding wound around the lateral legs on the second side of the M middle legs is equal to a first angle, wherein the first angle is a function of N and W.

8. The magnetic device according to claim 7, wherein the first angle is equal to 360/(2N/W) degree.

9. The magnetic device according to claim 6, wherein a phase different between voltage signals of the first windings wound around every two adjacent lateral legs on the first side of the M middle legs is equal to a second angle, and a phase different between voltage signals of the first windings wound around every two adjacent lateral legs on the second side of the M middle legs is equal to the second angle, wherein the second angle is a function of N and W.

10. The magnetic device according to claim 9, wherein the second angle is equal to 360/(N/W) degree.

11. The magnetic device according to claim 1, wherein the magnetic device further comprises W magnetic cover pairs, and each pair of the W magnetic cover pairs, at least one middle leg of the M middle legs and at least two lateral legs of the 2N lateral legs are collaboratively formed as one magnetic element, wherein a difference between a total phase of voltage signals of the first windings wound around the at least two lateral legs of each magnetic element and a total phase of voltage signals of the first windings wound around the at least two lateral legs of an adjacent magnetic element is 0 degree or 180 degrees.

12. The magnetic device according to claim 1, wherein the magnetic device further comprises W magnetic cover pairs, and each pair of the W magnetic cover pairs, one middle leg of the M middle legs and four lateral legs of the 2N lateral legs are collaboratively formed as one magnetic element, wherein each magnetic element comprises a first side, a second side, a third side and a fourth side, the first side and the second side are opposed to each other, the third side and the fourth side are opposed to each other, and the third side and the fourth side are arranged between the first side and the second side, wherein the middle leg of each magnetic element is located at center of the magnetic element, and the four lateral legs of each magnetic element comprises a first lateral leg, a second lateral leg, a third lateral leg and a fourth lateral leg, wherein the first lateral leg is adjacent to the first side and the third side of the magnetic element, the second lateral leg is adjacent to the first side and the fourth side of the magnetic element, the third lateral leg is adjacent to the second side and the third side of the magnetic element, and the fourth lateral leg is adjacent to the second side and the fourth side of the magnetic element, wherein the fourth side of each magnetic element is corresponding to the third side of an adjacent magnetic element.

13. The magnetic device according to claim 12, wherein in each magnetic element, a phase difference between a voltage signal of the first winding wound around the first lateral leg and a voltage signal of the first winding wound around the second lateral leg is 180 degrees, a phase difference between the voltage signal of the first winding wound around the first lateral leg and a voltage signal of the first winding wound around the third lateral leg is 90 degrees, and a phase difference between the voltage signal of the first winding wound around the third lateral leg and a voltage signal of the first winding wound around the fourth lateral leg is 180 degrees.

14. The magnetic device according to claim 12, wherein a first channel is formed between the first and second lateral legs and the middle leg of each magnetic element, a second channel is formed between the third and fourth lateral legs and the middle leg of each magnetic element, and a third channel is formed between the middle leg of each magnetic element and the middle leg of an adjacent magnetic element.

15. The magnetic device according to claim 14, wherein the W magnetic cover pairs, the M middle legs and the 2N lateral legs are collaboratively formed as a first magnetic element, a second magnetic element, a third magnetic element and a fourth magnetic element, and the first magnetic element, the second magnetic element, the third magnetic element and the fourth magnetic element are arranged sequentially, wherein the second winding is wound around the four middle legs of the first magnetic element, the second magnetic element, the third magnetic element and the fourth magnetic element by passing through the first channel of the first magnetic element, the first channel of the second magnetic element, the first channel of the third magnetic element, the first channel of the fourth magnetic element, the fourth side of the fourth magnetic element, the second channel of the fourth magnetic element, the second channel of the third magnetic element, the second channel of the second magnetic element, the second channel of the first magnetic element and the third side of the first magnetic element, wherein the second winding is wound around the middle leg of the first magnetic element for one turn, the second winding is wound around the middle leg of the second magnetic element for one turn, the second winding is wound around the middle leg of the third magnetic element for one turn, and the second winding is wound around the middle leg of the fourth magnetic element for one turn.

16. The magnetic device according to claim 14, wherein the W magnetic cover pairs, the M middle legs and the 2N lateral legs are collaboratively formed as a first magnetic element, a second magnetic element, a third magnetic element and a fourth magnetic element, and the first magnetic element, the second magnetic element, the third magnetic element and the fourth magnetic element are arranged sequentially, wherein the second winding is wound around the four middle legs of the first magnetic element, the second magnetic element, the third magnetic element and the fourth magnetic element by passing through the first channel of the first magnetic element, the first channel of the second magnetic element, the first channel of the third magnetic element, the first channel of the fourth magnetic element, the fourth side of the fourth magnetic element, the second channel of the fourth magnetic element, the second channel of the third magnetic element, the second channel of the second magnetic element, the second channel of the first magnetic element, the third side of the first magnetic element, the first channel of the first magnetic element, the first channel of the second magnetic element, the first channel of the third magnetic element, the first channel of the fourth magnetic element, the fourth side of the fourth magnetic element, the second channel of the fourth magnetic element, the second channel of the third magnetic element, the second channel of the second magnetic element, the second channel of the first magnetic element and the third side of the first magnetic element, wherein the second winding is wound around the middle leg of the first magnetic element for two turns, the second winding is wound around the middle leg of the second magnetic element for two turns, the second winding is wound around the middle leg of the third magnetic element for two turns, and the second winding is wound around the middle leg of the fourth magnetic element for two turns.

17. The magnetic device according to claim 14, wherein the W magnetic cover pairs, the M middle legs and the 2N lateral legs are collaboratively formed as a first magnetic element, a second magnetic element, a third magnetic element, a fourth magnetic element and a fifth magnetic element, and the first magnetic element, the second magnetic element, the third magnetic element, the fourth magnetic element and the fifth magnetic element are arranged sequentially, wherein the second winding is wound around the five middle legs of the first magnetic element, the second magnetic element, the third magnetic element, the fourth magnetic element and the fifth magnetic element by passing through the first channel of the first magnetic element, the first channel of the second magnetic element, the first channel of the third magnetic element, the first channel of the fourth magnetic element, the first channel of the fifth magnetic element, the fourth side of the fifth magnetic element, the second channel of the fifth magnetic element, the second channel of the fourth magnetic element, the second channel of the third magnetic element, the second channel of the second magnetic element, the second channel of the first magnetic element, the third side of the first magnetic element, the first channel of the first magnetic element, the first channel of the second channel element, the third channel between the second magnetic element and the third magnetic element, the second channel of the second magnetic element, the third channel between the first magnetic element and the second magnetic element, the first channel of the second magnetic element, the first channel of the third magnetic element, the first channel of the fourth magnetic element, the third channel between the fourth magnetic element and the fifth magnetic element, the second channel of the fourth magnetic element, the third channel between the third magnetic element and the fourth magnetic element, the first channel of the fourth magnetic element, the first channel of the fifth magnetic element, the fourth side of the fifth magnetic element, the second channel of the fifth magnetic element, the second channel of the fourth magnetic element, the second channel of the third magnetic element, the second channel of the second magnetic element and the second channel of the first magnetic element, and the third side of the first magnetic element, wherein the second winding is wound around the middle leg of the first magnetic element for two turns, the second winding is wound around the middle leg of the second magnetic element for three turns, the second winding is wound around the middle leg of the third magnetic element for two turns, the second winding is wound around the middle leg of the fourth magnetic element for three turns, and the second winding is wound around the middle leg of the fifth magnetic element for two turns.

18. The magnetic device according to claim 1, wherein directions of DC magnetic fluxes on the 2N lateral legs are identical, and the direction of the DC magnetic fluxes on the 2N lateral legs are opposite to directions of DC magnetic flux on the M middle leg.

19. The magnetic device according to claim 1, wherein the M middle legs and the 2N lateral legs are made of a single magnetic material, respectively, wherein the M middle legs are made of ferrite, and the 2N lateral legs are made of ferrite.

20. The magnetic device according to claim 1, wherein the M middle legs and the 2N lateral legs are made of a plurality of magnetic materials, respectively, wherein the M middle legs are made of iron powder, and the 2N lateral legs are made of ferrite.

21. The magnetic device according to claim 1, wherein a magnetic resistance of one of the N middle legs is greater than or equal to two times a magnetic resistance of one of the N lateral legs.

22. A power conversion module, comprising:
a circuit board having a first surface and a second surface opposed to each other, wherein the second surface of the circuit board comprises at least one concave region, and the circuit board has a first sidewall, a second sidewall, a third sidewall and a fourth sidewall, wherein the first sidewall, the second sidewall, the third sidewall and the fourth sidewall are disposed between the first surface and the second surface of the circuit board, the first sidewall and the second sidewall are opposed to each other, and the third sidewall and the fourth sidewall are opposed to each other and disposed between the first sidewall and the second sidewall;
an adapter board having a first surface and a second surface opposed to each other, wherein the first surface of the adapter board is attached to the second surface of the circuit board, the first surface of the adapter board comprises at least one component disposing region having a conductive function, and the at least one component disposing region is corresponding to the at least one concave region;
at least one first component disposed in the at least one concave region, wherein a height of the at least one first component is less than or equal to a depth of the at least one concave region; and
at least one second component disposed in the at least one component disposing region and accommodated in the corresponding at least one concave region, wherein a height of the at least one second component is less than or equal to the depth of the at least one concave region.

23. The power conversion module according to claim 22, wherein each of the at least one first component and the corresponding one of the at least one second component are disposed in the corresponding one of the at least one concave and stacked with each other, wherein a sum of the height of the at least one first component and the height of the at least one second component which are stacked with each other is less than or equal to the depth of the corresponding one of the at least one concave.

24. The power conversion module according to claim 23, further comprising a plurality of magnetic elements, wherein each of the plurality of magnetic elements comprises a first magnetic cover, a second magnetic cover, a middle leg and four lateral legs, wherein the first magnetic cover and the second magnetic cover are disposed on the first surface and the second surface of the circuit board, wherein the middle leg and the four lateral legs are disposed between the first magnetic cover and the second magnetic cover, and the middle leg and the four lateral legs run through the circuit board, wherein one side of the second magnetic cover of each of the plurality of magnetic elements adjacent to the first sidewall is adjacent to the at least one first component and the at least one second component which are stacked with each other, and the other side of the second magnetic cover of each of the plurality of magnetic elements adjacent to the second sidewall is adjacent to the other of the at least one first component and the other of the at least one second component which are stacked with each other.

25. The power conversion module according to claim 24, further comprising a plurality of switch units disposed on the first surface of the circuit board, wherein one side of the first magnetic cover of each of the plurality of magnetic elements adjacent to the first sidewall is adjacent to the corresponding one of the at least one switch unit, and one side of the first magnetic cover of each of the plurality of magnetic elements adjacent to the second sidewall is adjacent to the other of the at least one switch unit.

26. The power conversion module according to claim 22, wherein the at least one first component includes X first components, wherein the X first components are divided into P first component integrations according to the disposing positions thereof, each of the plurality of P first component integrations comprises portions of the X first components, wherein the at least one second component includes Y second components, wherein the Y second components are divided into Q second component integrations according to the disposing positions thereof, each of the plurality of Y second component integrations comprises portions of the Y second components, wherein the P first component integrations and the Q second component integrations are disposed in the at least one concave region in a staggered arrangement, wherein X, Y, P and Q are positive integer, respectively, and the X, Y are greater than 1.

27. The power conversion module according to claim 26, wherein the P first component integrations are spaced apart from each other, wherein portion of the plurality of first components in each of the plurality of first component integrations are arranged in sequence, the plurality of first components are arranged along a direction as same as a direction from the third sidewall to the fourth sidewall of the circuit board, wherein the Q second component integrations are spaced apart from each other, wherein portion of the plurality of second components in each of the plurality of second component integrations are arranged in sequence, the plurality of second components are arranged along a direction as same as the direction from the third sidewall to the fourth sidewall of the circuit board.

28. The power conversion module according to claim 26, further comprising a plurality of magnetic elements, wherein each of the plurality of magnetic elements comprises a first magnetic cover, a second magnetic cover, a middle leg and four lateral legs, wherein the first magnetic cover and the second magnetic cover are disposed on the first surface and the second surface of the circuit board, wherein the middle leg and the four lateral legs are disposed between the first magnetic cover and the second magnetic cover, and the middle leg and the four lateral legs run through the circuit board, wherein one side of the second magnetic cover of each of the plurality of magnetic elements adjacent to the first sidewall is adjacent to the corresponding first component integration, and the other side of the second magnetic cover of each of the plurality of magnetic elements adjacent to the second sidewall is adjacent to another first component integration.

29. The power conversion module according to claim 28, further comprising a plurality of switch units disposed on the first surface of the circuit board, wherein one side of the first magnetic cover of each of the plurality of magnetic elements adjacent to the first sidewall is adjacent to the corresponding one of the at least one switch unit, and the other side of the first magnetic cover of each of the plurality of magnetic elements adjacent to the second sidewall is adjacent to the other of the at least one switch unit.

30. The power conversion module according to claim 22, wherein the at least one concave region is disposed on an intersection between the second surface and the first sidewall of the circuit board, and is formed concavely from the second surface and the first sidewall of the circuit board, and/or the at least one concave region is disposed on an intersection between the second surface and the second sidewall of the circuit board, and is formed concavely from the second surface and the second sidewall of the circuit board, wherein the at least one concave region is extended along a direction as same as a direction from the third sidewall to the fourth sidewall of the circuit board.

31. The power conversion module according to claim 22, wherein the at least one concave region is formed concavely from the second surface of the circuit board, and the at least one concave region is extended along a direction as same as a direction from the third sidewall to the fourth sidewall of the circuit board.

32. The power conversion module according to claim 22, wherein portion of the at least one concave region is exposed to the fourth sidewall of the circuit board.

33. The power conversion module according to claim 22, further comprising at least one first adapter conductor soldered between the second surface of the adapter board and a system board.

34. The power conversion module according to claim 33, further comprising a protrusion part and at least one second adapter conductor, wherein the protrusion part is protruded from the second surface of the circuit board along the third sidewall, wherein a height of the protrusion part protruding from the second surface of the circuit board is equal to a thickness of the adapter board, wherein while the first surface of the adapter board is disposed on the second surface of the circuit board, a top surface of the protrusion part and the second surface of the adapter board are coplanar, wherein the at least one second adapter conductor is disposed on the top surface of the protrusion part and soldered between the top surface of the protrusion part and the system board.

35. The power conversion module according to claim 22, further comprising at least one solder pad disposed on a bottom of the at least one concave region of the circuit board, wherein the at least one first component is electrically connected with the circuit board through the at least one solder pad.

36. The power conversion module according to claim 22, wherein the at least one first component comprises an input capacitor, and the at least one second component comprises an output capacitor.
